(19) United States
(12) Patent Application Publication
(10) Pub. No.: US 2010/0135566 A1
(43) Pub. Date: Jun. 3, 2010

(54) ANALYSIS AND CLASSIFICATION, IN PARTICULAR OF BIOLOGICAL OR BIOCHEMICAL OBJECTS, ON THE BASIS OF TIME-LAPSE IMAGES, APPLICABLE IN CYTOMETRIC TIME-LAPSE CELL ANALYSIS IN IMAGE-BASED CYTOMETRY

(75) Inventors: Konstantin JOANIDOPOULOS, Gauting (DE); Daniel Kruger, Munchen (DE); Daniel Martens, Munchen (DE)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Soft Imaging Solutions GmbH, Munster (DE)

(21) Appl. No.: 12/627,994

(22) Filed: Nov. 30, 2009

Related U.S. Application Data
(60) Provisional application No. 61/122,418, filed on Dec. 15, 2008.

(30) Foreign Application Priority Data
Dec. 1, 2008 (DE) 10 2008 059 788.0

(51) Int. Cl. G06K 9/00

(52) U.S. Cl. 382/133; 382/224

(57) ABSTRACT

Among the proposals provided is a method for the analysis and classification of objects of interest, for example biological or biochemical objects, on the basis of time-lapse images, for example for use in time-lapse analysis in image-base cytometry. Images of the objects of interest, for example cells, are recorded at different moments in time and these images are subjected to a segmentation process to identify image elements as object representations or sub-object representations of objects or sub-objects of interest of objects of interest. Identified object representations or sub-object representations are then associated with one another in images of the time series and are identified as representations of the same object or sub-object or as the result of an object or sub-object. First features manifesting themselves in individual images are detected and second features manifesting themselves in a plurality of images recorded at different times are detected. The individual objects or sub-objects identified in the digital images of the series are classified on the basis of at least one classifier relating to at least one second feature, and this classification process is used as the basis for or as part of a further analysis process in relation to at least one query of interest.

The invention relates to a method for analysing and classifying objects of interest on the basis of time-lapse images of at least one group of objects of interest. It is intended to apply primarily, but not exclusively, to biological or biochemical objects, in particular biological cells or cell structures. The method provided by the invention may be applied universally, but can be used particularly expediently for cytometric cell analysis, specifically time-lapse or time-series analysis, in image-based cytometry.

Data evaluation methods suitable for large volumes of data are known and established in the field of cytometry. Conventionally, data on parameters and features obtained from single objects are plotted in one-dimensional or two-dimensional histograms. It is then possible to select sub-populations of the detected objects with particular properties in histograms of this type. Using other parameters or features, it is then also possible to display the selected sub-populations of this type in histograms, from which sub-populations may again optionally be selected. In this way, it is possible to produce complex classification schemes, this complexity being restricted, however, in conventional cytometry methods based on flow cytometry by the fact that there are only a small number of parameters or features available, typically colour (or wavelength), intensity and light scatter signal. On this subject, reference is made to the relevant literature in the field of conventional flow cytometry, and to U.S. Pat. No. 4,021,117, U.S. Pat. No. 4,661,913 and U.S. Pat. No. 4,845,653.

This analysis concept has been successfully transferred by the applicant, Olympus Soft Imaging Solutions GmbH, to image-based applications, known as “image-based cytometry”, in which a larger number of parameters or features is available, since object size (in particular cell size) and other morphological parameters are obtained, in addition to the parameters known from conventional cytometry, from the particular image recorded by microscope, optionally by fluorescence microscope. However, cytometric analysis methods for the image-based analysis of for example fluorescent dyed cells are not widely used. The Compucyte Corporation offers a corresponding, automated “imaging cytometer” under the name “iCyte®” (cf. http://www.compucyte.com). The Amnis Corporation also offers a flow-based system for image-based cytometry under the name “ImageStream®” (cf. www.amnis.com).

Data describing dynamic behaviour or behaviour over time are frequently collected and analysed in the field of general science. For this purpose, measurements are generally taken at time intervals. It is then possible to produce curves from series of this type of measurement data and, using different conventional methods (keywords: “curve fitting”, “curve sketching”), to derive from these curves values which characterise the respective dynamic process or processes. Examples are variables such as decay constants, frequency in the case of cyclical or periodic signals, rise time constants, times of maximum or minimum intensity, extension of a curve, half-width or another typical time interval of a curve, speed, etc. In kinetic analyses of this type, single values are typically derived from measurement curves which are formed from many measured values and originate from individual, dynamically changing objects.

In the field of biology, methods of this type have hitherto been used only in some specialist fields (for example neurophysiology, enzymology) but not for image-based screening applications. It is therefore not possible to carry out dynamic assays using conventional cytometry for preparative reasons. Mathematical analysis methods for curves generated from individual measurements, such as curve fitting and the like for kinetic or dynamic data originating from image-based experiments, are generally used very rarely in the fields of biology and biochemistry and were hitherto only known for individual experiments in which an individual curve or a few individual curves are analysed and characterised in this way. For example, reference is made to U.S. Pat. No. 5,332,905, in which the change in the intensity ratio of two fluorescent signals over time was measured and evaluated in order to correlate the intensity ratio with concentrations of respective species in the sample.

“Live-cell high-content screening systems and methods” have since gained a great degree of importance in biology and biochemistry. Fully automated, microscope-based imaging systems are used which are capable of carrying out time-lapse measurements on live cells typically present in large quantities. A corresponding system also provided to automatically calculate changes in the intensity and/or distribution of fluorescent signals from fluorescing reporter molecules on or in cells is known for example from EP 0 983 408 B1.

Known by the term “tracking” are methods with which it is possible to identify objects in chronologically successive images and to associate, using the images, a series of respective object representations with one another in such a way that changes in these objects over time can be detected or measured automatically. One example of this is the tracking method known from EP 1 348 124 B1 for identifying cells during series of kinetic tests (assays).

Automated tracking methods of this type have already been used in live-cell high-content screening systems to obtain kinetic data on a single-cell level. These kinetic data are displayed in the form of curves so that it is possible, in principle, to differentiate between groups of curves with different curve shapes via the representations thereof on a screen or a printout. Quantitative options for measuring these differences and for selecting curve groups on the basis of objectifiable, quantitative criteria are only possible for data sets which can be differentiated from one another by simple thresholds. There is a lack of methods for analysing complex data sets. Analysis using simple thresholds is ultimately not possible when there is a very high number of curves or when the curve shapes differ greatly, causing them to be superimposed in an unclear manner.

Conventional analysis of kinetic parameters, for example in the field of biology (including medicine) is limited for example to classifying particular biological objects into different groups on the basis of a kinetic parameter. For example, in the paper “Biological effects of recombinant human zona pellucida proteins on sperm function”, authors Pedro Caballero-Campo et al., in Biology of Reproduction 74, 760-768 (2006), analysis is basically limited to the classification of the sperm tested into groups of different motility by using a computer-based sperm analyser (IVOS sperm analyser from Hamilton Thorne BioSciences, cf. www.hamiltonthorne.com/products/casa/ivos.htm).

The object of the invention is to provide a method for analysing and classifying objects of interest on the basis of time-lapse images of at least one group of objects of interest (for example biological or biochemical objects such as cells), which is in principle universally applicable and enables kinetic or dynamic data, which can be represented in curves and are taken directly or indirectly from time-lapse images, to be analysed, specifically also for the case in which kinetic data of this type are available simultaneously for a large number of individual objects and are to be evaluated as a group.

In particular, it is an objective of the invention to enable populations which differ in relation to kinetic or dynamic parameters to be classified on the basis of kinetic data taken from the images of a time series of images, specifically in the case of a group of objects which contains a large number of individual objects and results in a correspondingly large volume of data relating to different individual objects.

It is further an objective of the invention to provide a corresponding method which is in principle suitable for use with data which are generated in time-lapse high-content screening systems known per se by known tracking methods and could be evaluated conventionally, but at best qualitatively, on the basis of very simple criteria.

In order to achieve at least one of these objectives, the invention provides a method for analysing and classifying objects of interest, for example biological or biochemical objects, on the basis of time-lapse images of at least one group of objects of interest, for example for use for cytometric cell analysis (specifically time-lapse or time-series analysis) in image-based cytometry, comprising:
A) optically and electronically recording and electronically storing a plurality of digital images of the group of objects of interest located in an object region of an optical object examination device, the plurality of digital images comprising at least one series of digital images of the group of objects of interest recorded at different moments in time;
B) subjecting at least the series of digital images, recorded at different moments in time, of the plurality of digital images to a digital image processing process for the purposes of segmentation comprising at least one of i) identifying image elements as object representations of individual objects of interest of the group of objects of interest and ii) identifying image elements as sub-object representations of individual sub-objects of the particular objects of interest of the group of objects of interest, and electronically storing segmentation data representing these segmentation and identification processes;
C) at least on the basis of the segmentation data:
   associating identified object representations or sub-object representations in digital images of the series recorded at chronologically successive moments for identifying, as a representation, the same object or sub-object or for identifying, as representations, objects or sub-objects in a source-result relationship, and electronically storing these association data representing this association process and thus the identification process;
D) at least on the basis of the segmentation data or the segmentation data and the association data and/or image content data, identified via the segmentation data or the segmentation data and the association data, from the digital images of the series:
   detecting first features, manifesting themselves directly or indirectly in an individual digital image of the series, of individual objects or sub-objects identified in the digital images of the series by segmentation or by segmentation and association, at least for a plurality of digital images of the series recorded at different moments in time, and electronically storing at least one first feature data set representing these features;
E) at least on the basis of the association data or the association data and segmentation data and/or image content data, identified via the association data or the association data and the segmentation data, of the digital images of the series and/or first feature data of the first feature data set:
   detecting second features, manifesting themselves directly or indirectly as differences between a plurality of the digital images of the series, of individual objects or sub-objects identified in the digital images of the series by segmentation and association, at least for a plurality of digital images of the series recorded at different moments in time, and electronically storing at least one second feature data set representing these second features;
F) defining at least one second classifier which relates to at least one second feature and can be applied to second feature data of the second feature data set in such a way that an individual object or sub-object, identified in the digital images of the series by association, belongs to a second class associated with the classifier if the second feature data, associated with said object or sub-object, of the second data set satisfy at least one second classification condition representing classification in relation to the at least one second feature, and electronically storing second classifier data representing the second classifier with the second classification condition;
G) classification by applying at least one defined second classifier to the second feature data set for determining individual objects or sub-objects which are identified in the digital images of the series by association and which belong to the second class associated with the second classifier applied or belong to a plurality of second classes each associated with one of the second classifiers applied; and
H) analysing the data, associated with the objects or sub-objects belonging to the second class or classes after said classification process, from at least one of i) the association data, ii) the segmentation data, iii) the image content data, identified via at least one of the association data and segmentation data, of the digital images of the series, iv) first feature data of the first feature data set and v) second feature data of the second feature data set in relation to at least one query of interest.

In accordance with the proposed invention, time-lapse images of the examined objects are recorded and segmented to identify therein image elements as object representations or sub-object representations and to save corresponding segmentation data for further processing. It is then possible to carry out a “tracking” process which is conventional per se to associate identified object representations or sub-object representations in images of the time series with one another in such a way that they are identified as representations of the same object or sub-object. In short, object representations or sub-object representations from a plurality of chronologically successive digital images are assigned to object tracks or sub-object tracks, each object track exclusively comprising object representations or sub-object representations associated with the same object or sub-object of the examined group of objects.

Also part of the method is the identification or detection of temporary and/or static features of the objects, the static or temporary features of an object or sub-object being determined, optionally calculated, from the image data of an individual digital image on the basis of the object representation or sub-object representation associated with the object or sub-object and/or from the segmentation data and, if desired, also from the association data if said data have already been determined. Static or dynamic features of this type are stored as first features of the first feature data set. First features may therefore be any parameters, values, features, etc. which can be taken or derived from a single image.

Also part of the method is the identification or detection of dynamic or kinetic features of examined objects which can be taken directly or indirectly from a plurality of images, recorded at different moments in time, of the time series. The basis for this identification or detection is the association, described by the association data, of objects or sub-objects between the images of the time series. In short, the dynamic or kinetic features are determined (optionally calculated) on the basis of the object track associated with the particular object or sub-object identified, typically also the object representations or sub-object representations associated with said object track. Corresponding dynamic or kinetic features are stored as second feature data of the second feature data set. Second features may therefore be any parameters, values, features, etc. which can be taken or derived from a plurality of images of the time series. Parameters, values, features, etc. which can be taken or derived from a single image alone expediently do not belong to the group of second features.

Therefore also part of the method is the assignment of objects, contained in the images as object representations or sub-object representations, to object classes, an object being assigned to a particular object class or belonging to said class if the temporary or static features and the dynamic or kinetic features of the object lie within a feature space region, corresponding to the object class, of a multidimensional feature space spanned by the first and second features. The classification process is achieved by using at least one classifier (referred to as the “second classifier”) relating at least to at least one second feature, a plurality of classifiers generally being applied. It is intended primarily that a plurality of second classifiers be used, but the use of at least one classifier (referred to as a “first classifier”) relating to at least one first feature of the first feature data set is not excluded. The different classifiers may classify features in relation to different sub-spaces of the multidimensional feature space spanned by the temporary or static and the dynamic or kinetic features.

In the case of a first feature which changes over time, i.e. is not static and is therefore a temporary feature which can be taken or derived from a particular image, classification of a first feature of this type can take place in relation to the value at a particular moment in time or in a particular image of the time series, for example, the temporary value at the beginning of the track or the value at the time the curve showing the chronological development of this feature reaches its maximum point or the temporary value after an event has occurred. It should be noted that it is not necessary for the saved first feature data to reproduce directly the first features taken or derived from the individual images, and instead data, produced from the aforementioned data and describing the chronological development in summarised form after the association process according to step C), can be stored as first feature data or the first feature data set. Instead of a series of values reproducing the chronological development of any variable, it would also be possible to store a function describing said chronological development in the form of a polygon or a spline function specifying the value for the respective first feature for a particular moment in time or a particular image of the time series.

After the classification process using at least one second classifier, a further analysis then takes place of the objects or sub-objects belonging to the respective second class or respective second classes, it being possible for the analysis to be represented primarily as a further, multi-stage process of classification and application, primarily of classifiers relating to different sub-spaces of the spanned feature space, it being possible to apply both first classifiers and second classifiers. It is primarily intended that a chain of different second classifiers be applied simultaneously or successively.

It is primarily intended that different first and/or second classifiers, but primarily different second classifiers, which generally relate to different sub-spaces of the feature space, be applied simultaneously or successively, optionally successively in accordance with the interaction of a user with a user interface. In this case, a classifier can be defined in a graphical diagram, in particular a two-dimensional projection of the feature space in a user interface of the software implementing the method, it very expediently being possible to define classifiers relating to different sub-spaces in graphical diagrams of the sub-space in question, for example by inputting region boundaries or by marking a particular sub-population using a display device (for example a graphics tablet or a computer mouse) on a screen.

In preferred embodiments, primarily one-dimensional, two-dimensional or three-dimensional sub-spaces which are formed from two features or by the transformation of two features are considered to be suitable sub-spaces. This transformation may for example be a principal component analysis process which determines the eigenvectors of a covariant matrix. At least one classifier is then defined in at least one of these sub-spaces in order to derive sub-populations from the entire population of (second class) objects. It is then possible to define at least one further classifier in at least one further sub-space by using said sub-population and, by using said further classifier, it is then possible to form a further sub-population from the previously derived sub-population. It is also possible to classify and thus analyse objects of interest in particular by logically linking the different classifiers thus obtained.

Reference is expressly also made to the following for the above definition of the method according to the invention:

The description “second” for the terms “second classifier”, “second class”, “second classification condition” or “second classifier data” refers to the classification of at least one “second feature” determined in step E) to differentiate from the classification of at least one “first feature” determined in step D), the classification of this “first feature” also being included within the scope of the invention and, in principle, also being of practical relevance. The terms “first classifier”, “first class”, “first classification condition” and “first classifier data” are used in the discussion of possible appropriate developments and the description “first” refers to the classification of at least one “first feature” determined in step D).

“First features” are temporary features which can be taken from a single image (and may change over time) and static features which do not change over time. If, in the “first classification” process, the static, unchanging features are of interest, it would be possible and appropriate to use the terms “static features”, “static classifier”, “static class”, “static classification condition” and “static classifier data” instead of the terms “first features”, “first classifier”, “first class”, “first classification condition” and “first classifier data”. If, in contrast, temporary features which change over time are of primary interest for the “first classification” process, it would be possible to use the terms “temporary features”, “temporary classifier”, “temporary class”, “temporary classification conditions” and “temporary classifier data” instead of the terms “first features”, “first classifier”, “first class”, “first classification condition” and “first classifier data”, the classification condition for a first feature of this type relating to the temporary value at a particular moment in time or the temporary value taken or derived from a particular image in the time series, it being possible for the time of interest or the image of interest of the time series to be derived from the chronological development of the temporary value in question and/or for said time of interest or image of interest of the time series to be obtained from an associated second feature or a plurality of associated second features.

“Second features” are features which can be taken from a plurality of images recorded at different moments in time or features which are derived from “second features” of this type and relate to changes in the images which manifest themselves over time, i.e. they therefore relate to dynamic or kinetic processes or generally to the dynamics or kinetics of the objects examined or the sub-objects thereof. It would therefore be possible and appropriate to use the terms “kinetic features”, “kinetic classifier, “kinetic class”, “kinetic classification condition” and “kinetic classifier data” or “dynamic features”, “dynamic classifier, “dynamic class”, “dynamic classification condition” and “dynamic classifier data” instead of the terms “second features”, “second classifier”, “second class”, “second classification condition” and “second classifier data”. Further below the term “object kinetics features” is used for “second features”, a distinction being made between what are known as “primary object kinetics features” and “indirect object kinetics features” (which could also be referred as “secondary object kinetics features). The “indirect object kinetics features” characterise the “kinetics” or “dynamics” indirectly relative to a predetermined or predeterminable model development profile over time, whereas the “primary object kinetics features” characterise the “kinetics” or “dynamics” directly (or at least more directly).

It is also within the scope of the invention to obtain time-lapse curves describing the dynamics or kinetics of the objects examined from time-lapse images and, using mathematical methods known per se, to obtain from these curves single measurements or characteristic values which characterise a respective curve. Individual measured values or characteristic values of this type may then be classified and analysed by means of data evaluation methods established in the field of cytometry, optionally by using the cytometric interface known per se. The core idea of the invention is that changes, which can be taken indirectly or directly from time-lapse photographs, in respective objects or sub-objects over time can be described by “kinetic data” or “dynamic data” identifying characteristics of the change over time, and that these “kinetic data” or “dynamic data” then, optionally together with static or temporary object data or sub-object data, undergo cytometric analysis and classification.

From an ex-post perspective, this inventive idea appears relatively simple. However, it should be noted that in the sciences, specifically in biology but also in the fields of physics and chemistry, kinetic curve analyses are generally only used to determine one or very few values characterising the kinetic process since there is generally a model for the phenomena observed (decay time, frequency, etc.). Physicists and chemists are unfamiliar with cytometric methods and they generally also have no need to classify populations or sub-populations which differ in terms of kinetic or dynamic parameters in large volumes of data relating to a group of many individual cases.

Within the scope of the claims, the invention is universal and can be used for any type of kinetic experiments and data sets for classification purposes or for classification and analysis purposes. In contrast to the prior art, it is possible not only to perform a qualitative analysis and an analysis with simple criteria for a very limited number of queries and with a very limited number of experimental results, but it is also possible to investigate complex queries for, in principle, any experimental relationships. It is thus possible to evaluate highly complex time-lapse experiments without having to use obscure mathematical methods such as cluster analysis. The method according to the invention may advantageously be performed by using a piece of software with a graphical user interface, i.e. what is known as a graphical tool, which is simple, namely, interactive and intuitive, to use and enables step-wise classification for the analysis of data.

It is not possible at all to carry out dynamic assays in conventional cytometry for preparative reasons so there is no need for operators of cytometric systems to classify data on the basis of kinetic features. As mentioned above, in biology, the use of curve sketching methods such as curve fitting and the like for kinetic data is known only in individual experiments generally involving a few individual cases (cf. for example U.S. Pat. No. 5,332,905 discussed above). Even if kinetic data are present in high volumes in time-lapse high-content screening, it could not be expected that conventional cytometry, which uses only a small number of parameters, would provide an indication of how to improve evaluation of the kinetic data. In any case, classification has only been carried out on the basis of simple threshold classifications.

It has also not been possible for conventional cytometry to serve as a pointer in relation to the evaluation of kinetic data in time-lapse high-content screening processes since cytometric analysis does not involve curves or use families of curves. A requirement of conventional cytometric analysis is that curves are reduced to individual values. Families of curves have therefore only been able to be classified in a very limited number of experiments and data sets and only to a limited extent, for example by using simple threshold conditions. However, more complex data sets cannot be analysed in this way.

It should also be noted that, certainly in time-lapse high-content screening and also in live-cell high-content screening, curve characterisation for particular kinetic data is generally unknown. As a rule, there is no model which could be derived from basic principles. Even if such a model existed, it would not encourage attempts to characterise or describe the kinetics using single values derived from curves.

Irrespective of whether or not a model exists, the characterisation or analysis of single curves is not usually of primary interest, even in the method according to the invention. However, it has been recognised that data analysis using parameters derived from kinetics offers many advantages over conventional data analysis performed on the basis of primary data (kinetics) and, in particular, enables the identification of sub-populations in a group having many individual cases to be simplified considerably or even enables identification to take place for the first time. Typical curve types may be used in this process without there actually being a model from which a single curve type can be derived.

In this way, the invention enables a large number of parameters which characterise a particular curve to be determined and evaluated in a semi-automatic or fully automatic manner in order to identify populations or sub-populations of families of curves which may differ in terms of one or more parameters.

Particular fields of application of the invention are basic and applied research in the fields of biology and medicine, and toxicology and pharmacology, diagnostics, primarily but not exclusively, diagnostic research, drug screening, compound screening, small molecule screening and the like. However, it is possible that, in addition to the fields of application in the life sciences, there may be further possibilities for application in completely different scientific and technical fields.

The invention is primarily intended for applications in the field of microscopy, in particular light microscopy and/or fluorescence microscopy, as well as general applications in image-based tests (imaging), primarily but not exclusively, fluorescence imaging. The invention can be applied particularly advantageously in cell-based assays using live cells.

The provision of the method according to the invention, for example in the form of software for the cytometric analysis of kinetic data, extends the functionality of, for example, high-content screening systems considerably, provides new quantitative possibilities for data evaluation and thus enables results of greater depth to be obtained in research and development and in other fields as mentioned above. This will also have a positive effect on the commercial value and commercial success of promising evaluation software and corresponding screening systems and other analysis systems which implement the inventive ideas.

There is a wide variety of embodiments and developments of the method according to the invention for analysing and classifying objects of interest. It should be noted, with reference to the method steps A) to H) of the definition of the invention, that no particular chronological order of the individual method steps is implied by the series of letters A) to H). A particular sequence of individual method steps must only be followed if it is implied by the technical content of individual method steps, namely when a method step is performed on the basis of data which require that another method step be carried out. Even in this case, it is possible to carry out method steps which are dependent on one another or are interrelated simultaneously in the form of a common method step. It is thus possible for example to carry out method steps D) and E) in one go on the basis of all the images to be used of the time series. It is also possible for the method step C) to be incorporated therein; therefore it does not have to be carried out as an individual method step independently of or preceding method steps D) and E). The definition of the invention is therefore to be understood as a functional definition. It does not matter whether or to what extent the functions are fulfilled in a particular order or simultaneously. There are only dependent relationships, implied in the function specifications, when it is technically necessary for one function to be based on another. However, it is possible for the method steps implementing these functions to be carried out simultaneously. If the functions are not dependent on one another, they may be carried out in any desired sequence.

It is thus also readily possible for the detection process according to step D) to be carried out at least on the basis of the segmentation data and/or image content data, identified via the segmentation data, of the digital images of the series, before the association process according to step C) is carried out. Alternatively, it is also possible for the detection process according to step D) to be carried out at least on the basis of the segmentation data and/or image data, identified via the segmentation data, of the digital images of the series, after the association process according to step C) is carried out. It may advantageously be provided that the detection process according to step D) is carried out at least on the basis of the segmentation data and the association data and/or image content data, identified via the segmentation data and the association data, of the digital images of the series, after the association process according to step C) is carried out, first features being identified as first features of individual objects or sub-objects identified in the digital images of the series via the segmentation and association processes and corresponding identification data being stored electronically as at least one sub-data set of the first feature data set.

An advantageous embodiment comprises, prior to the association process according to step C):
D1) at least on the basis of the segmentation data and/or image content data, identified via the segmentation data, from the digital images of the series:
   detecting first features, manifesting themselves directly or indirectly in an individual digital image of the series, of individual objects or sub-objects identified in the digital images of the series by segmentation, at least for a plurality of digital images of the series recorded at different moments in time, and electronically storing at least one first feature data set representing these features.

In this case, it can expediently be provided that the detection process according to step D) comprises the detection process according to step D1) before the association process according to step C), and that, after the association process according to step C), step D) further comprises the identification, on the basis of the association data, of first features as first features of individual objects or sub-objects identified in the digital images of the series by segmentation and association, and the electronic storage of corresponding identification data as at least one sub-data set of the first feature data set.

In a preferred embodiment, the analysis and classification method further comprises the steps of:
F1) defining at least one first classifier which relates to at least one first feature and can be applied to first feature data of the first feature data set in such a way that an individual object or sub-object, identified in the digital images of the series by segmentation or by segmentation and association, belongs to a first class associated with the classifier if the first feature data, associated with said object or sub-object, of the first feature data set satisfy at least one first classification condition representing classification in relation to the at least one first feature, and electronically storing first classifier data representing the first classifier with the first classification condition;
G1) classification by applying at least one defined first classifier to the first feature data set for determining individual objects or sub-objects which are identified in the digital images of the series by segmentation or by segmentation and association and which belong to the first class associated with the first classifier applied or belong to a plurality of first classes, each associated with one of the first classifiers applied.

As mentioned, it is possible for the classification of at least one static feature and/or of at least one feature which changes over time to carried out in relation to a temporary value at a particular moment in time (or in a particular image of the time series or even in relation to a plurality of moments in time or images of the time series), it being possible for the time or image of interest to be determined from the development of the temporary value and/or at least one second feature.

It can be provided that the segmentation process according to step B), the or a detection process according to step D) or step D1) and at least one classification process according to step G1) be carried out simultaneously in a single segmentation, detection and classification step prior to the detection process according to step E) or prior to the association process according to step C). It may also be expedient for the or a detection process according to step D) or D1) and at least one classification process according to step G1) to be carried out prior to the association process according to step C), and for the association process according to step C) to be carried out only in relation to identified object representations or sub-object representations corresponding to an object or sub-object which belongs to the first class associated with the first classifier applied, or which belongs to a plurality of first classes, each associated with one of the first classifiers applied. In this case, it is also intended that the classification process according to step G) be carried out together with a classification process according to step G1) in order to identify objects or sub-objects belonging to classes which are each associated with one of the classifiers applied.

The analysis and classification method may advantageously further comprise:
H1) analysing the data, associated with the objects or sub-objects belonging to the first class or classes after at least one classification process according to step G1), from at least one of i) the association data, ii) the segmentation data, iii) the image content data, identified via at least one of the association data and segmentation data, of the digital images of the series, iv) first feature data of the first feature data set and v) second feature data of the second feature data set in relation to at least one query of interest.

The analysis or classification method may advantageously further comprise:
G2) classification by applying at least one defined first classifier to the first feature data set and at least one defined second classifier to the second feature data set for determining individual objects or sub-objects which are identified in the digital images of the series by association and which belong to the classes associated with the classifiers applied.

It is specifically also intended for the classification process according to step G2) to comprise the classification process according to step G) in the classification process according to G1).

The analysis and classification process may advantageously further comprise:
H2) analysing the data, associated with the objects or sub-objects belonging to the at least one first class and the at least one second class after at least one classification process according to step G2), from at least one of i) the association data, ii) the segmentation data, iii) the image content data, identified via at least one of the association data and segmentation data, of the digital images of the series, iv) first feature data of the first feature data set and v) second feature data of the second feature data set in relation to at least one query of interest.

In this case, it is possible for the analysis process according to step H2) to comprise the analysis process according to step H) or the analysis according to step H1), or both the analysis according to step H) and the analysis according to step H1).

It is intended in particular that the analysis according to step H) or step H1) or step H2) comprises in particular at least one further classification process according to step G) or step G1) or step G2). In this case, it may be provided that the classification process according to step G) and the at least one further classification process according to step G) or step G1) or step G2) performed in the analysis process according to step H) be carried out simultaneously as a multiple classification process. The analysis process according to step H), in conjunction with the classification process according to step G), may be carried out solely by applying a plurality of different classifiers.

In this context, it is specifically proposed as being particularly advantageous that, for the purposes of analysis or classification and analysis, a sequence of classification processes according to step G) and/or step G1) and/or step G2) are carried out simultaneously or in a chain in order to identify the objects or sub-objects which, according to the first or second feature data thereof which are detected in relation to the first and/or second features thereof and are understood to be coordinates in a multidimensional feature space spanned by the first and/or second features, lie in a particular feature space region selected by the first or second classifiers applied. In the case of first features which change over time, objects or sub-objects which pass through a particular feature space region, as indicated by the “track” of said objects or sub-objects through the feature space, may optionally be identified. In this case, first or second classifiers relating to different sub-spaces of the multidimensional feature space may be applied for the purposes of classification. In addition, first or second classifiers which relate to the same sub-space of the multidimensional feature space may also be used for classification.

It should be mentioned that the analysis process according to step H) or step H1) or step H2) may comprise at least one further process of defining at least one further classifier according to step F) or step F1) and at least one further classification process on the basis of the further classifier according to step G) or step G1) or step G2).

It should be noted that the classification process performed by applying at least one defined first or second classifier according to step G) or step G1) or step G2) may be carried out to identify individual objects or sub-objects which are identified in the digital images of the series and do not belong to the class associated with the classifier applied, or do not belong to a plurality of classes, each associated with one of the classifiers applied. It should be noted in this context that a classifier KA which identifies objects belonging to class A corresponds to a classifier KB=NOT-KA which identifies objects which do not belong to class A. These objects which do not belong to class A can be viewed as belonging to class B. In this respect, it is sufficient to mention specifically only the classifiers which select the objects belonging to the class associated with the classifier.

It is primarily also intended within the scope of the invention that at least one first or second classifier be defined in step F) or in step F1) or in the course of the analysis process according to step H) or step H1) or step H2) and be applied for the purposes of classification in step G) or in step G1) or in the course of the analysis process according to step H) or step H1) or step H2), said at least one first or second classifier relating to a plurality of first features and being able to be applied to first feature data of the first feature data set, or relating to a plurality of second features and being able to be applied to second feature data of the second feature data set. It may further be very expedient for a second classifier to be defined in step F) or in the course of the analysis process according to step H) or step H2) and be applied for the purposes of classification in step G) or in the course of the analysis process according to step H) or step H2), said at least one second classifier relating to at least one first feature and at least one second feature and being able to be applied to first feature data of the first feature data set and second feature data of the second feature data set or to feature data combined from first feature data and second feature data.

A classifier of this type which relates to a plurality of features may expediently have at least one classification condition linking these features in the manner of a function or relation of a plurality of variables. Classification carried out in this way is more complex than simply applying one or more threshold conditions in relation to the first or second features. The classification process may thus correspond to the selection or identification of a feature space region delimited by hyperplanes which extend, in principle, in any manner in the multidimensional feature space and are described by multidimensional equations of planes.

It should also be noted that it is possible to predefine at least one first classifier according to step F) prior to the image recording process according to step A) and/or that it is possible to predefine at least one second classifier according to step F1) prior to the image recording process according to step A). It is also intended that at least one first or second classifier predefined according to step F) or F1) be provided together with the method for use for the analysis process and a classification process.

Expediently, at least one first classifier can be defined interactively according to step F) and/or at least one second classifier can be defined interactively according to step F1) on the basis of user input. It is further possible for at least one first classifier to be applied interactively according to step G1) or in the course of the analysis process according to step H1) or step H2) and/or it is possible to apply at least one second classifier interactively according to step G) or in the course of the analysis process according to step H) or step H2) on the basis of user input.

The analysis and classification method can advantageously be carried out in a partly automated or fully automated manner. In this context, it is intended that the method be carried out without user input at least while at least one of, preferably while a plurality of, and particularly preferably while all of the steps B), C), D), or D1), E), G) or G1) and H) or H1) or H2) are performed.

It may be provided that changes in the images of the time series over the entire time series, i.e. the entire variation over time of the first features of interest, are taken into account during the detection and evaluation of chronological developments, specifically when detecting second features. Therefore the entire length of the curves resulting from the chronological development of, for example, cell features are used to some extent for analysis and feature extraction. This is particularly expedient when a corresponding chronological development or a corresponding curve is to be examined as a whole and the global characteristics thereof are to be determined and analysed and optionally used for classification.

However, the entire chronological development of a feature or an entire curve is not always of interest. There are frequently time intervals during which for example a process has been triggered externally, for example by pipetting, or during which the examined object displays specific behaviour, for example an object-specific event occurs. This type of chronological development of interest could be hidden or not sufficiently taken into account if the feature extraction process were carried out on the basis of the entire respective chronological development.

For this reason, it is further proposed that, in relation to at least one chronological development of at least one first feature, at least one time period of interest, corresponding to a sub-series of the series of images, is selected semi-automatically or fully automatically or interactively and at least one second feature is detected on the basis of the chronological development in the time period and/or images of interest in the sub-series and is stored as the second feature of the second feature data set. In this case, it is intended for example that at least one time period be determined or selected in such a way that the time period comprises a time interval following the moment in time an action was performed on the objects. In this context it is also intended that at least one time period be determined or selected in such a way that the time period comprises a time interval following the moment in time when an event occurs for a particular object or for the objects.

It may expediently be provided that at least one time period of interest is determined or selected in relation to a plurality or all of the individual objects or sub-objects identified in the digital images of the series by association on an absolute timescale associated with all of said objects. In this case, it is intended for example that an external event, such as pipetting, triggers a chronological development which is to be evaluated in the examined objects.

It is also, very expediently, possible for at least one time period of interest to be determined or selected in relation to at least one individual object or sub-object identified in the digital images of this series by association on a relative timescale associated with this individual object. It is also possible for an event of interest to occur or for a chronological development of interest to begin at different times for individual objects so time periods of interest are to be determined or selected at different times on an absolute timescale for different objects.

It is preferably provided that at least one second classifier which relates to at least one second feature detected on the basis of the chronological development in the time period of interest and/or the images of interest in the sub-series, is defined and applied for classification.

In an expedient embodiment of the analysis and classification method, it is provided that a group of objects of interest comprising a large number of objects of interest or a plurality of groups of objects of interest, each comprising a large number of objects of interest or one or more groups formed from a plurality, in each case a large number, of sub-groups of interest of objects of interest are arranged in the object region and that the digital images of this group or groups or sub-groups are recorded according to step A), in the case of a plurality of groups this recording taking place simultaneously or successively in groups for all objects of interest of these groups, or in the case of a plurality of sub-groups of a group, this recording taking place simultaneously or successively in sub-groups for all sub-groups. In this case, it is specifically proposed that successive groups of objects of interest or groups formed from a plurality of sub-groups of objects of interest are supplied manually or partly automatically or fully automatically to the object region and are conveyed away again after the plurality of digital images of the at least one respectively supplied group temporarily located in the object region have been recorded according to step A). It is further proposed that each object of the group is recorded in an individual object photograph of a specimen slide supplied to the object region and common to all the objects of the group or that the objects of each group or the objects of each sub-group are recorded together in an object photograph, associated with the group or sub-group, of a specimen slide supplied to the object region and common to all the groups or sub-groups. In this way, the object or objects can be recorded in the respective object photograph together with a medium surrounding or carrying the object or objects.

However, it is possible, within the scope of the invention, for the objects or group or groups or sub-groups to be supplied to the object region using a liquid medium conveying the objects and to be conveyed away again after the digital images have been recorded.

The preceding description should indicate at least implicitly that the second features may comprise kinetics or dynamic behaviour or a change between the recording times of the digital images in relation to direct (primary) object kinetics features which characterise a particular object or sub-object directly and are determined directly or indirectly from differences between the plurality of digital images of the series or from data reflecting these differences from the association data or from the segmentation data or from image content data, identified via at least one of the association data and segmentation data, of the digital images of the series or from the first feature data. At least one classifier relating to a direct (primary) object kinetics feature can be defined and applied for the purposes of classification. A plurality of classifiers of this type are generally defined and applied either simultaneously or successively.

Furthermore, the second features may comprise kinetics or dynamic behaviour or a change between the recording times of the digital images in relation to indirect (secondary) object kinetics features which characterise a particular object or sub-object indirectly and which can be determined indirectly on the basis of a predetermined or predeterminable model chronological development profile from differences between a plurality of the digital images of the series or from data reflecting these differences from the association data or from the segmentation data or from image content data, identified via at least one of the association data and the segmentation data, of the digital images of the series or from the first feature data. The indirect object kinetics features may comprise for example at least one matching parameter of at least one function describing the chronological development. It is further also intended that the indirect object kinetics features comprise at least one deviation variable or agreement variable quantifying the deviation or agreement between the kinetics or the dynamic behaviour or the change in the digital images between different recording times in relation to a particular object or sub-object on the one hand and the model chronological development profile on the other. It has been found that indirect object kinetics features of this type relating to a model chronological development profile enable the classification process to be highly effective and targeted at finding a sub-population of interest, it not being necessary for the model chronological development profile to be derivable from basic principles. Instead, typical model chronological development profiles which occur in a particular context can be used as a basis in order to see which of these model chronological development profiles best matches the situation and so to enable the classification process to be carried out on the basis of different model types. It is therefore highly advantageous for at least one classifier relating to an indirect (secondary) object kinetics feature, in particular a matching parameter or a deviation variable or agreement variable, to be defined and applied for the purposes of classification. It is expediently also possible for a plurality of classifiers of this type to be defined and applied, either simultaneously or successively.

It is noted that classification of this type on the basis of indirect object kinetics features is performed at a higher level of abstraction than the level of parameters derived from the kinetics (in particular the aforementioned primary object kinetics features), which themselves are only derived from the primary data (kinetics). In this respect, there is a twofold transition to the data of a higher degree of abstraction characterising the kinetics, and this surprisingly produces particularly good results in terms of classification and analysis.

It is to be noted that classification based on the second features, specifically the direct and indirect object kinetics features, is so effective that classification of the first features can be entirely dispensed with, at least in terms of the analysis process according to step H). In practical terms, however, classification on the basis of one or more first parameters is often expedient to “filter out” any objects which are not of interest, for example abnormal cells and the like, for example also for the purpose of excluding these objects from the segmentation and association processes in order to reduce the complexity of the data processing procedure. However, this is only one option and no longer plays an important role in data processing resources available nowadays.

It is evident from the above explanations that the method can expediently be carried out to find at least one population or sub-population of objects of interest which differs from other objects in terms of their reaction to at least one purposeful action, reflected in first and/or second features, and/or by at least one particular characteristic, reflected in first and/or second features, and/or by at least one particular behaviour, reflected in first and/or second features. In this way, the objects can be subjected to a chemical and/or biochemical and/or biological or physical action before being supplied to the object region and/or in the object region before the digital images are recorded and/or while the series of digital images are recorded. In this case, it is proposed for example that at least one reagent is added to induce the chemical and/or biochemical and/or biological action.

The digital images can be recorded on the basis of the physical, in particular optical, excitation of the objects or sub-objects or substances contained in the objects or sub-objects to cause them to emit the optical radiation to be recorded according to step A). Reference has already been made in this context to fluorescence-based imaging, specifically fluorescence microscopy.

The digital images can be recorded on the basis of the epi-illumination and/or transillumination of the objects as an alternative or in addition to fluorescence-based imaging.

The objects of interest subjected to the analysis and classification method may preferably comprise biological objects, for example live or dead cells or connected groups of cells or cell fragments or tissue samples or biochemical objects. It is primarily intended that the objects of interest comprise microscopic objects and the object examination device be configured as a microscopy object examination device or fluorescence microscopy object examination device.

The definition of the analysis and classification method also includes, without limiting the universal applicability thereof, a method for analysing and classifying cells or cell components, comprising:
providing a large number of cells to at least one location, a cell being capable of containing one or more fluorescing reporter molecules,
optically scanning or detecting a plurality of cells at the location or at each of the locations containing cells in order to obtain optical signals from cells and/or from the fluorescing reporter molecules on or in the cells,
converting the optical signals into digital data, and
using the digital data
a) to carry out measurements of the intensity and/or distribution of the fluorescing signals from the fluorescing reporter molecules on or in the cells, and/or
b) to carry out measurements of the contours or general topology or morphology of cells or cell components,
   the method included within the scope of the definition of the invention further comprising, without limiting the universal nature thereof:
using the measurements
a) to determine changes in the intensity and/or distribution of the fluorescing signals from the fluorescing reporter molecules on or in cells in order to derive therefrom one or more kinetic features and/or
b) to determine static and/or temporary features from the measurements of the contour or general topology or morphology of cells or cell components;
a multidimensional feature space being determined from or based on static and/or temporary and/or kinetic features, a clear position or track in said multidimensional feature space being given for each cell at each location or each of the locations via these features, and at least one classifier being determined in at least one sub-space of the multidimensional feature space and said classifier being combined with another classifier from the same sub-space or a different sub-space of the feature space to classify cells or cell components, at least one classifiers relating to at least one kinetic feature being used, it being possible for this classification process in relation to at least one kinematic feature to be used as the basis for an analysis process or for part of said analysis process which preferably comprises at least one further classification process and may represent, if desired, solely the application of a plurality of different classifiers.
For example, a classifier may relate to a minimum value for the duration of a measured signal in order to filter out cells with an insufficient lifespan. A classifier may also relate to at least one parameter of a model chronological development profile or the extent to which a model chronological development profile matches measured changes. Classifiers may be predetermined, automatically generated or manually selected or defined.

The invention also provides an analysis and classification system for carrying out the analysis and classification method according to the invention, comprising:
an optical object examination device having a recording device for recording digital images of objects of interest located in an object region of the object examination device and an electronic storage means for storing the digital data and further data,
a digital electronic processor device which is configured or programmed to carry out, from the analysis and classification method according to the invention, at least the segmentation process according to step B), the association process according to step C), the detection process according to step E) and the classification process according to step G) and optionally the analysis process according to step H) as well as optionally carrying out further steps of the method according to the developments of the method discussed above.

The analysis and classification system generally comprises a display device on which recorded images and illustrations representing the classification and analysis results can be displayed by the processor device.

The invention further provides a program for analysing and classifying objects of interest on the basis of time-lapse images, comprising program code which, when the analysis and classification method according to the invention is executed by a programmable processor device, carries out at least the segmentation process according to step B), the association process according to step C), the detection process according to process E) and the classification process according to step G) and optionally the analysis process according to step H) and optionally also carries out further steps of the method according to the developments of the method discussed above. The program may contain at least one second classifier predefined according to step F) and/or at least one first classifier predefined according to step F1) as program code and/or as data belonging to the program code.

The invention further provides a program product in the form of a data carrier carrying executable program code or in the form of executable program code which is held available on a network server, can be downloaded via a network and, when the analysis and classification process according to the invention is executed by a programmable processor device, carries out at least the segmentation process according to step B), the association process according to step C), the detection process according to step E) and the classification process according to step G) and optionally the analysis process according to step H) and optionally also carries out further steps of the method according to the developments of the method discussed above. The program product may contain at least one second classifier predefined according to step F) and/or at least one first classifier predefined according to step F1) as program code and/or as data belonging to the program code.

The invention is explained in greater detail below in accordance with a detailed description of the technical background and prior art, with reference to examples and embodiments of the invention.

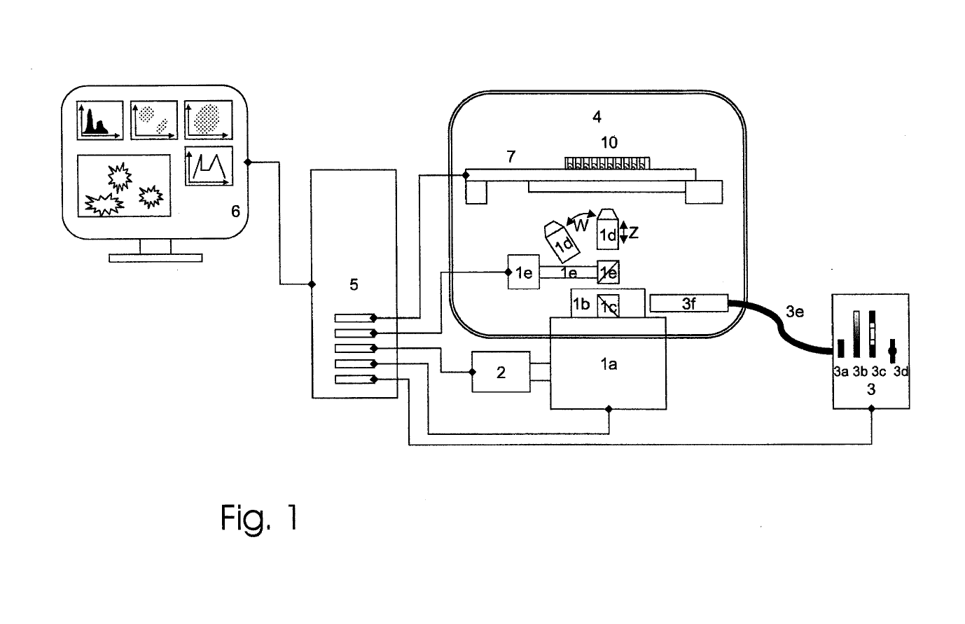

FIGS. 1 to 3 show examples of optical object examination devices, on the basis of which an analysis and classification system according to the invention can be provided.

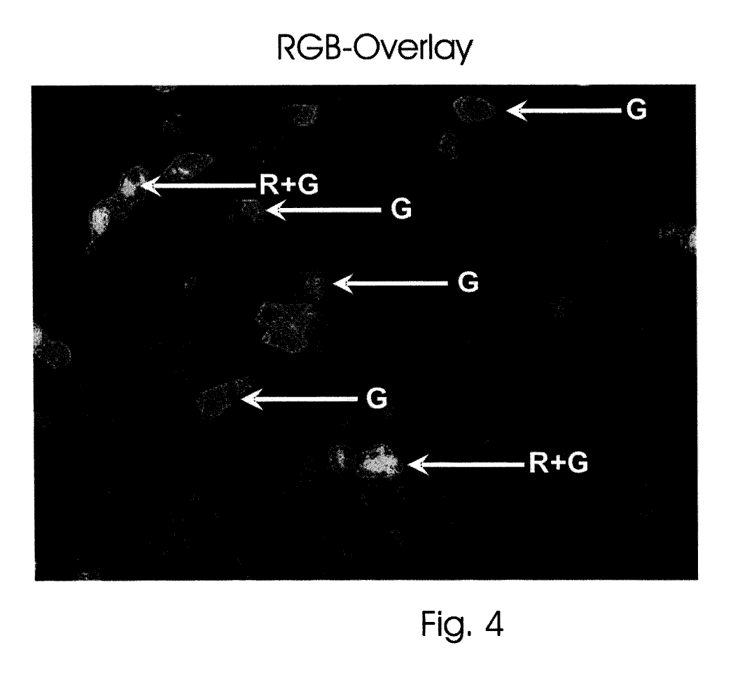

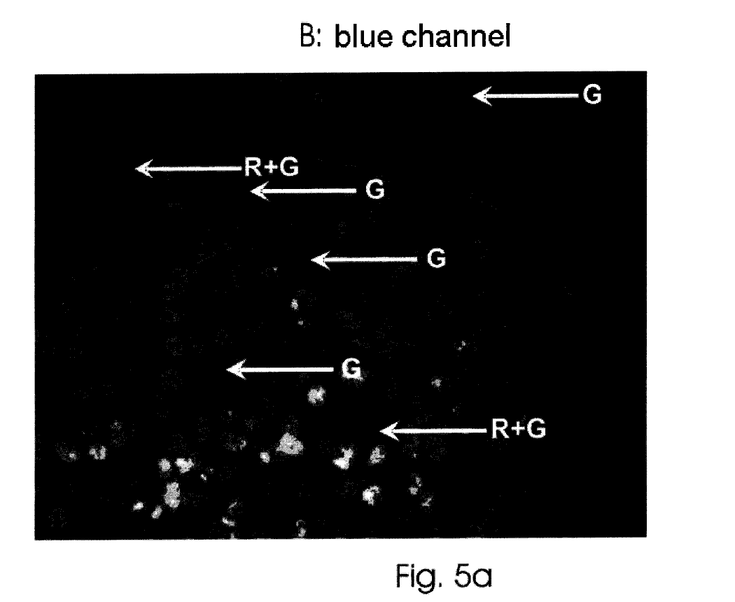

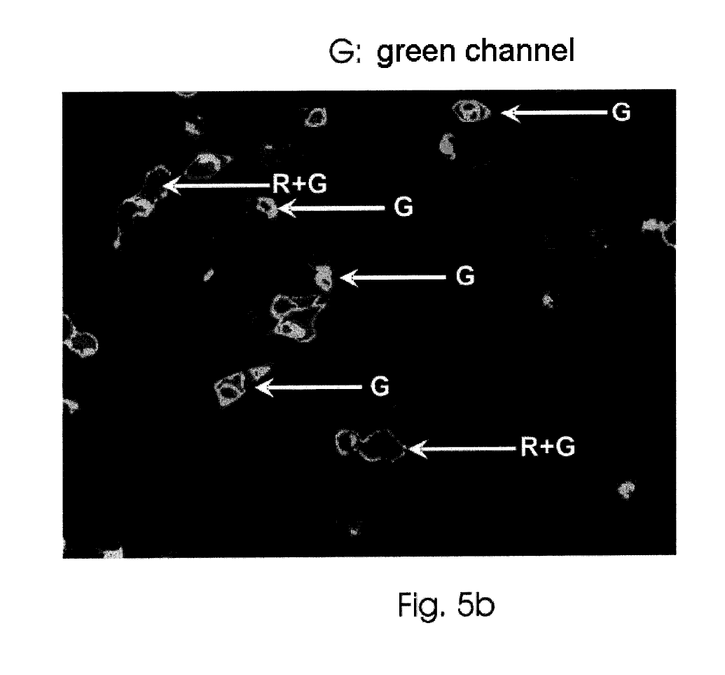

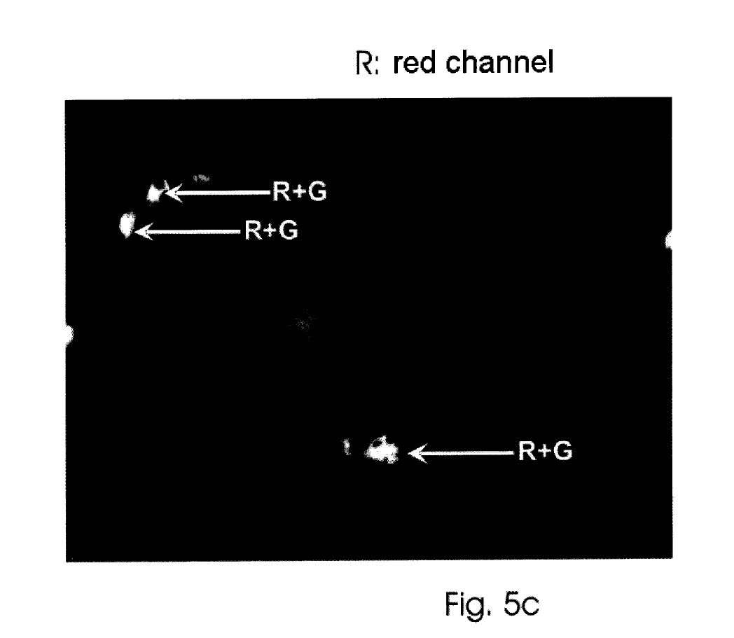

FIG. 4 is a grey-scale illustration of a three-channel image of cells, taken by fluorescence microscope, showing the colour separation images from FIGS. 5a, 5b and 5c for the blue, green and red channels.

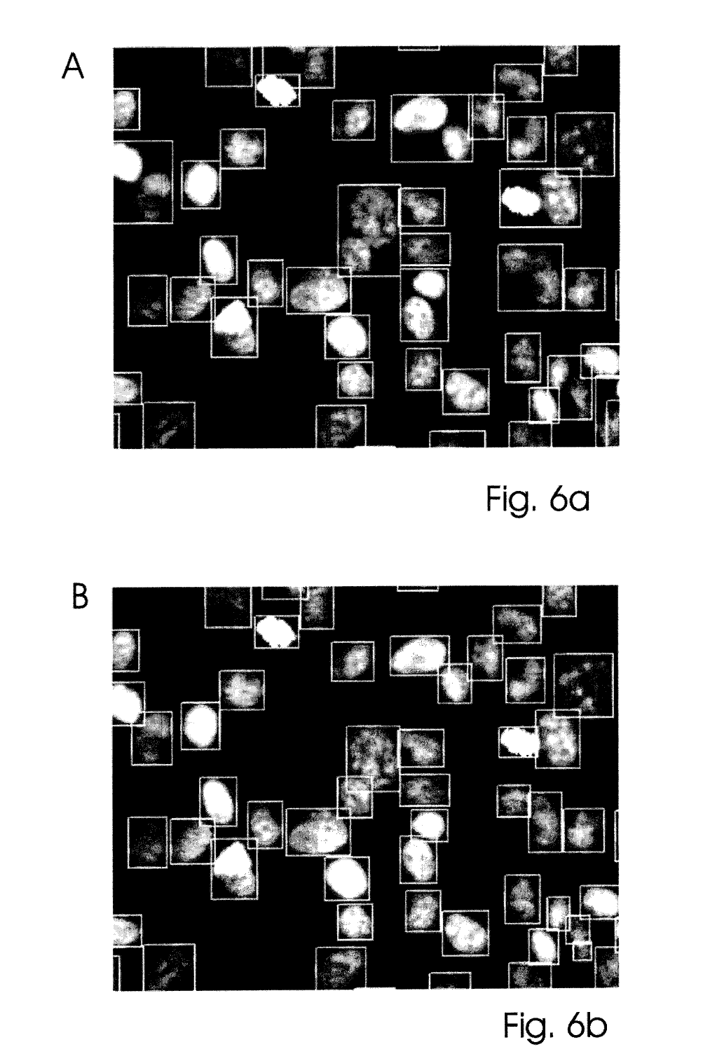

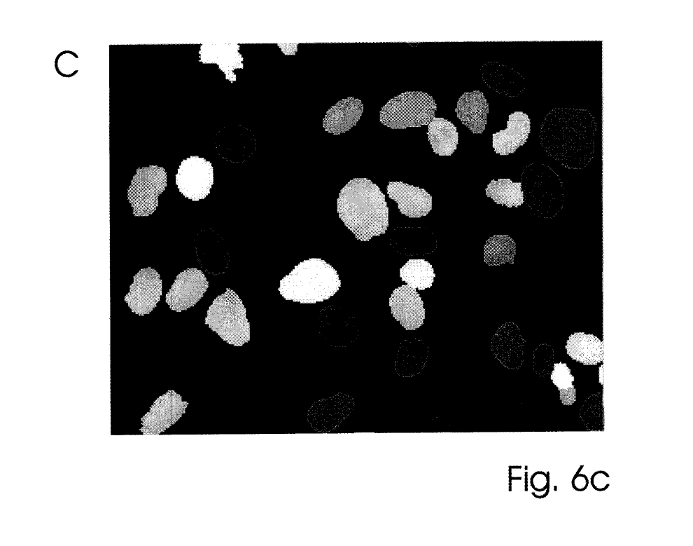

FIG. 6 shows an example of threshold segmentation in sub-FIG. 6a and an example of the separation of joined objects by applying a watershed algorithm in FIG. 6b and an example of a mask in sub-FIG. 6c produced by binarisation, for measurements in the original image used as a basis for said mask.

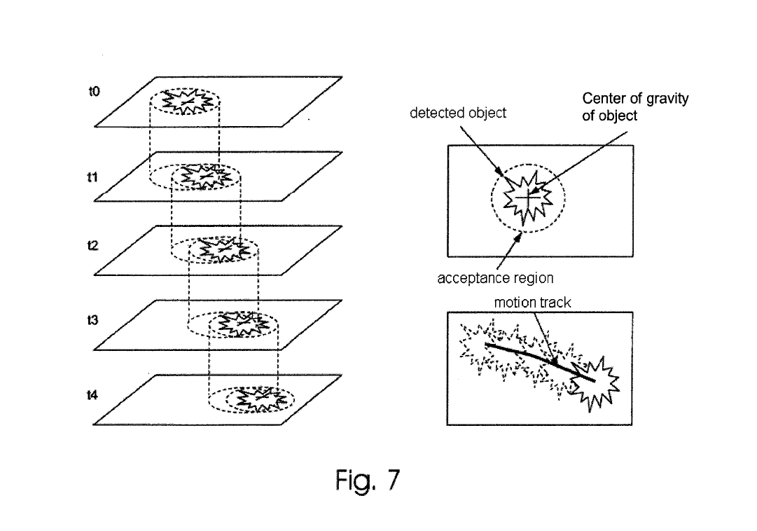

FIG. 7 illustrates an association of object representations in images of a time series as object representations of the same object (tracking).

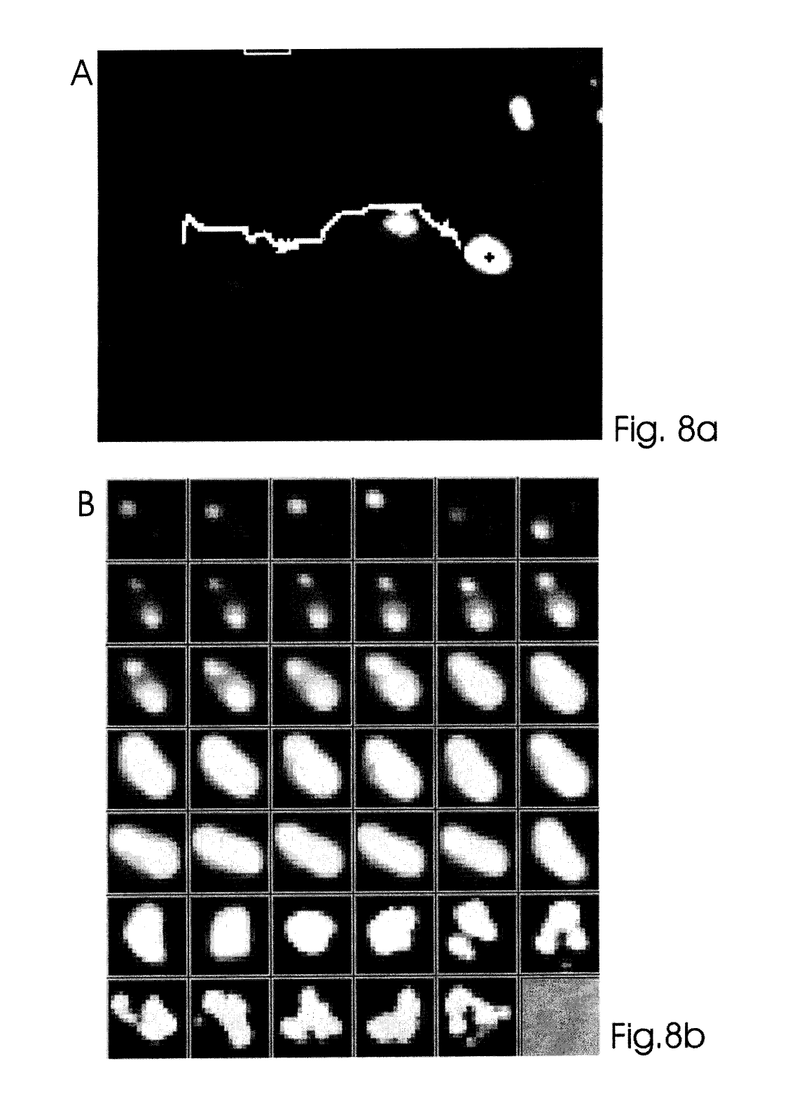

FIG. 8 shows an example of a motion track of a cell in sub-FIG. 8a and a gallery of associated individual images of the cell in FIG. 8b;

Cells: MIN6 cells (mouse insulinoma cells) lipofected with Dendra2-nuc (photoconvertible Dendra2 coupled to a nuclear import signal) Microscope: Olympus IX81, objective: 20×LUCPIanFLN, filter HC set GFP/DsRed sbx (AHF Analysentechnik), incubator (37° C., 5% CO₂, 60% atmospheric moisture)

Photograph: Dr. S. Baltrusch, Medizinische Hochschule Hannover.

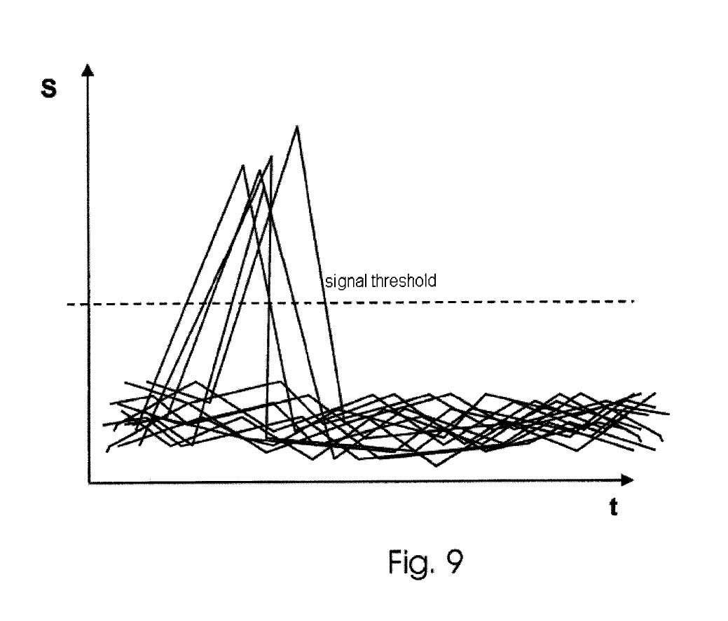

FIG. 9 shows an example of simple signal threshold classification for kinetic families of curves.

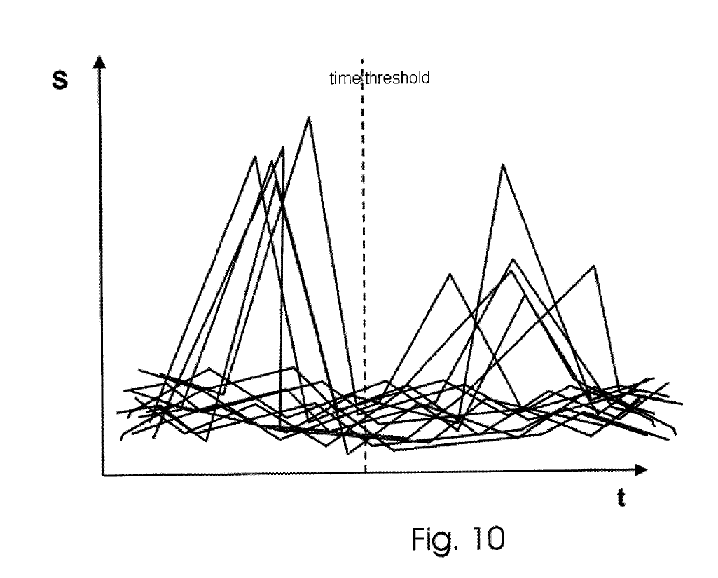

FIG. 10 shows an example of simple time threshold classification for kinetic families of curves.

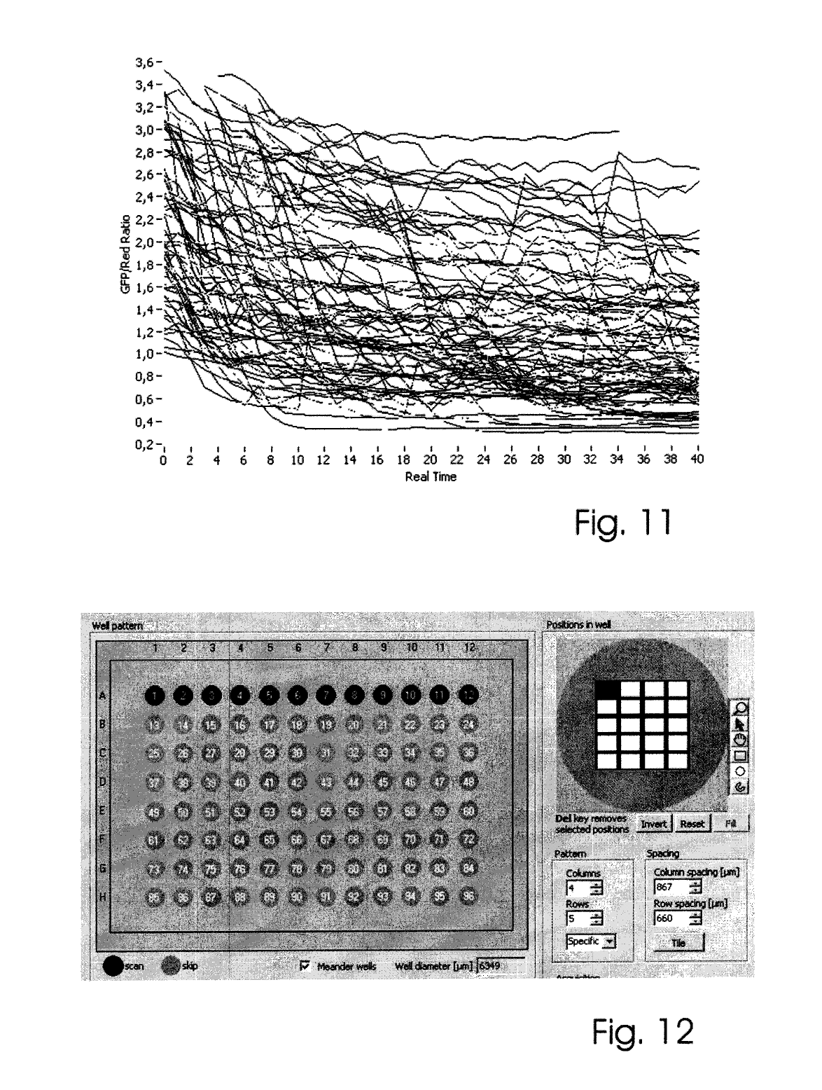

FIG. 11 shows an example of a family of curves which show the change in a fluorescence intensity ratio over time and with which it is not possible to carry out threshold classification or visual classification with a trained eye;

GFP/Red ratio: ratio from green fluorescing Dendra2 (GFP channel) and red fluorescing Dendra2 after photoconversion by UV light (red channel)

Cells: MIN6 cells (mouse insulinoma cells) lipofected with Dendra2-nuc (photoconvertible Dendra2 coupled to a nuclear import signal)

Microscope: Olympus IX81, objective: 20×LUCPIanFLN, filter HG set GFP/DsRed sbx (AHF Analysentechnik), incubator (37° C., 5% CO₂, 60% atmospheric moisture)

Photograph: Dr. S. Baltrusch, Medizinische Hochschule Hannover.

FIGS. 12 to 21 show screenshots of user interface windows and result output windows when carrying out cytometric image analysis on two-dimensional image data which do not contain any information on chronological changes.

FIG. 22 illustrates the generation of time-lapse image data either slowly (using a microtitre plate) or using a single sample or a single well in the microtitre plate, or rapidly in a single image position of a sample or a well.

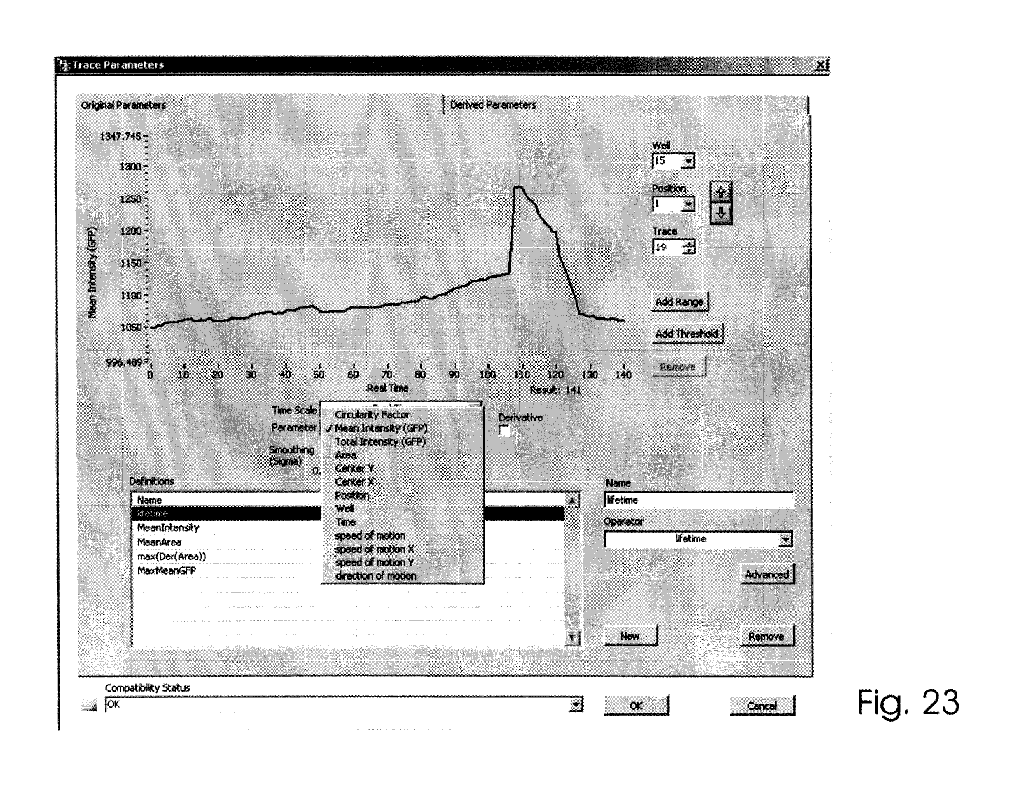

FIG. 23 shows an example of the process of defining curve features as kinetic features or parameters, on the basis of which classification can be carried out according to the invention, in a user interface window.

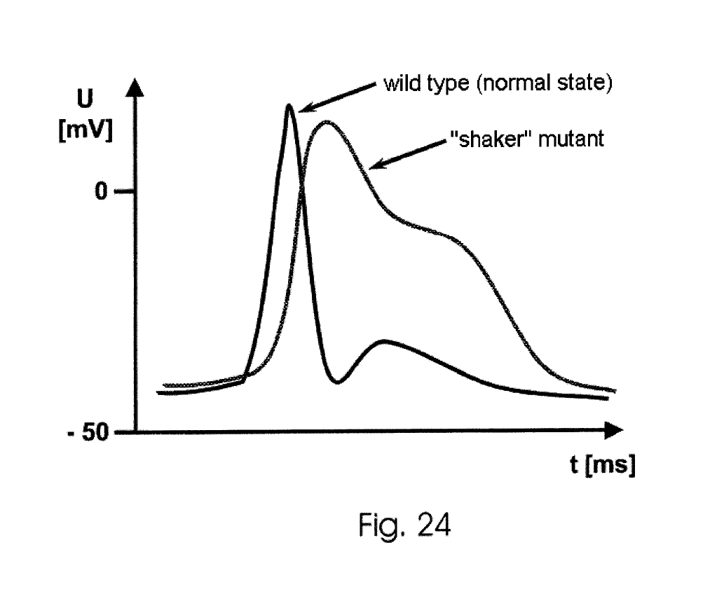

FIGS. 24 to 27 schematically show measurement results taken from standard works of literature in the field of biology to illustrate possible applications of the analysis and classification method according to the invention and to illustrate the advantages obtained by applying said invention.

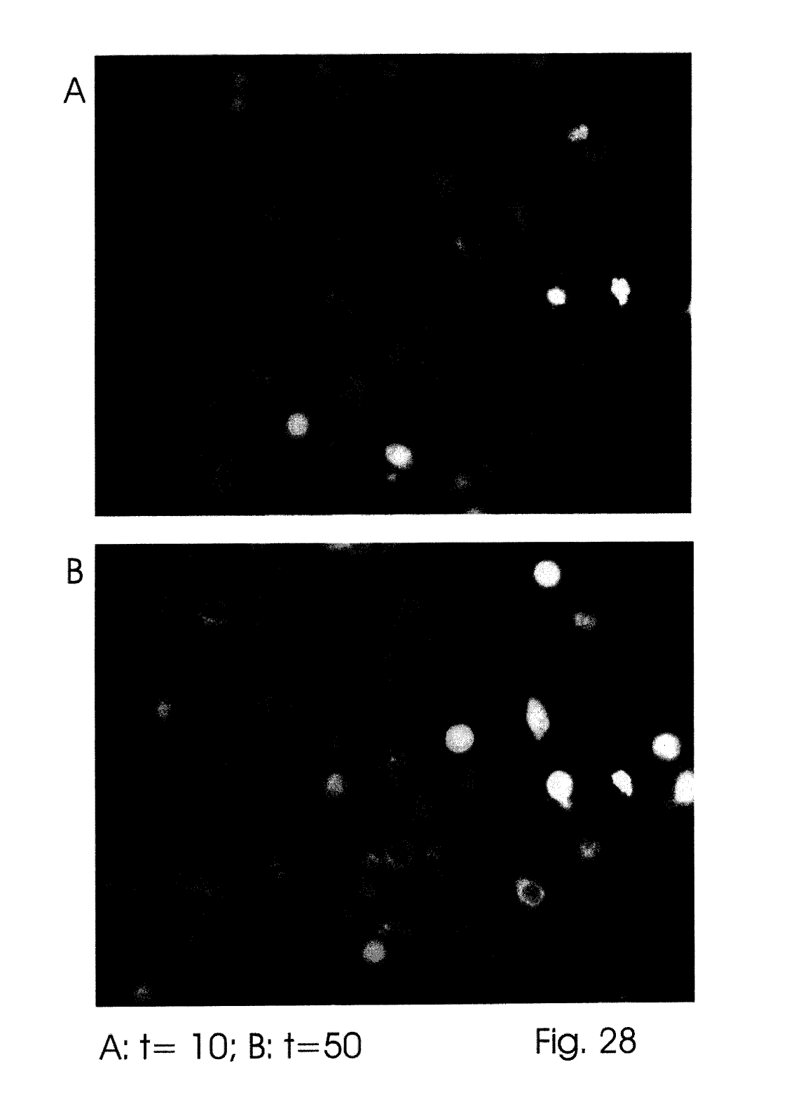

FIG. 28 shows photographs taken by fluorescence microscope of the division activity of cells at different times to illustrate a specific example application of the analysis and classification method according to the invention.

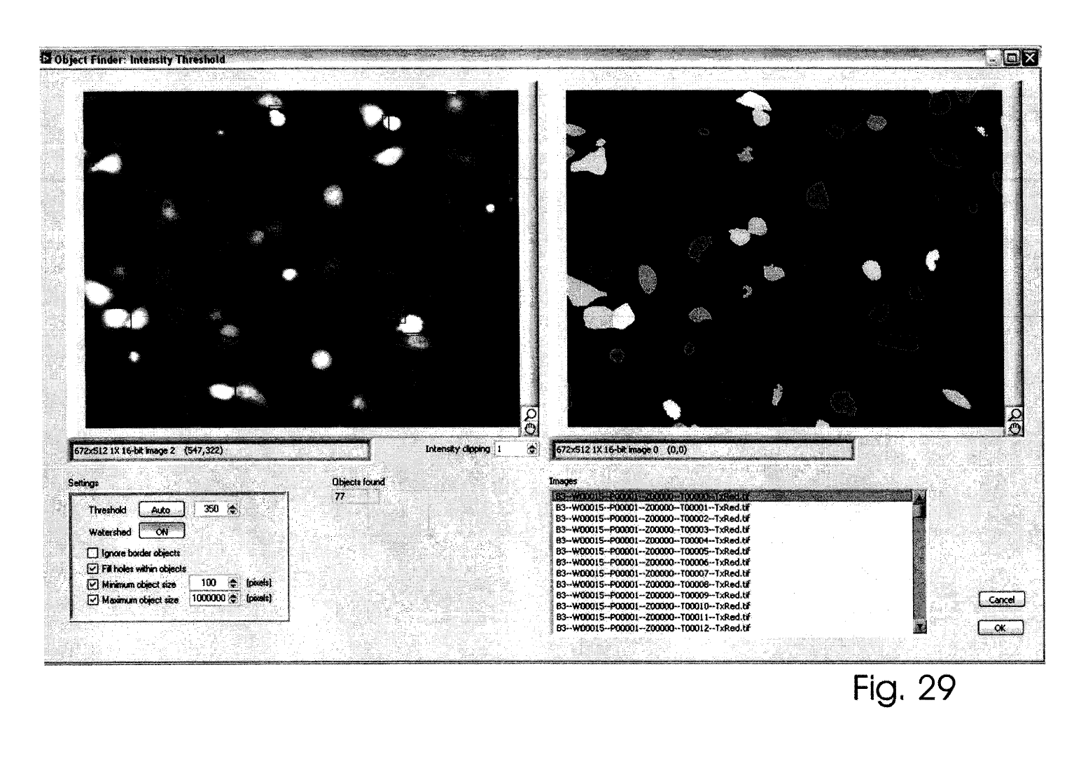

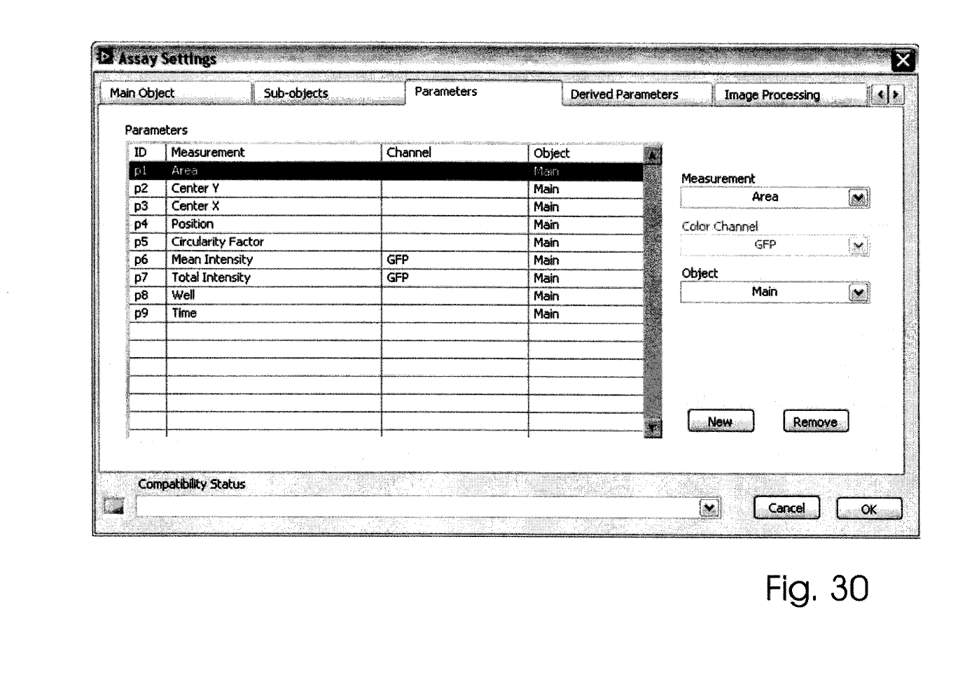

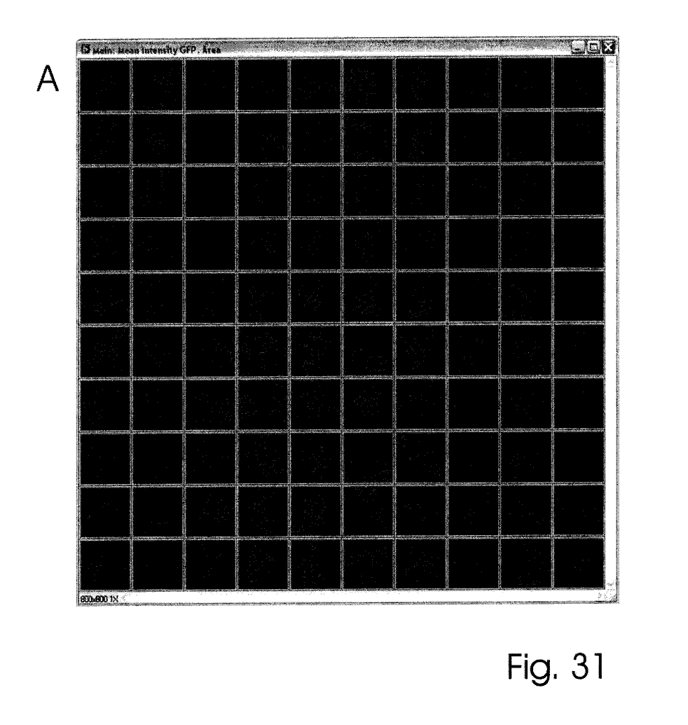

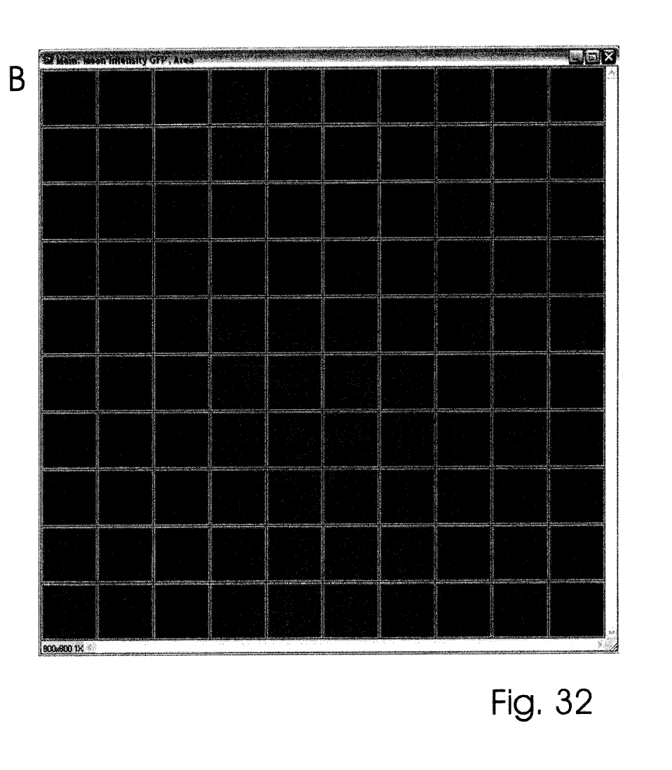

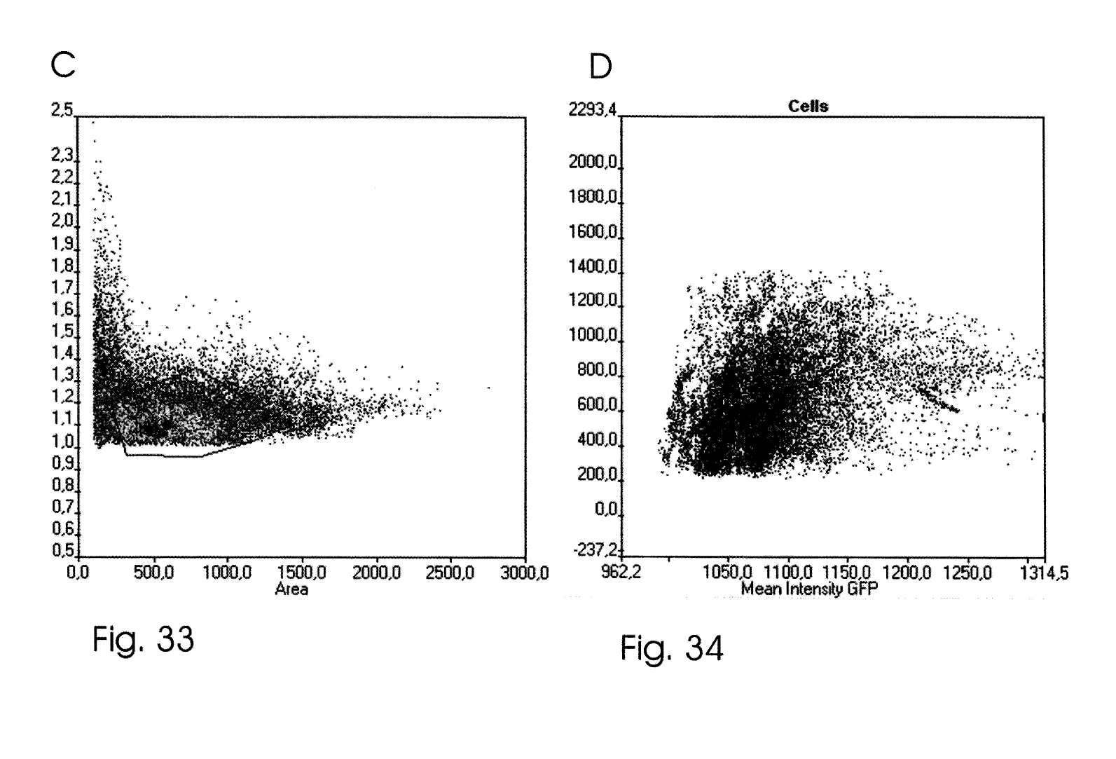

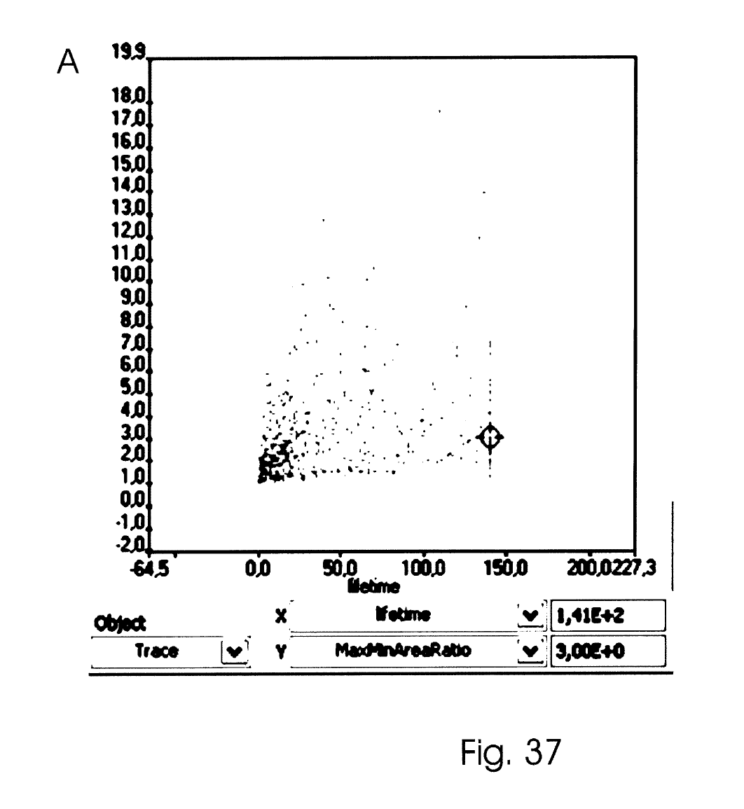

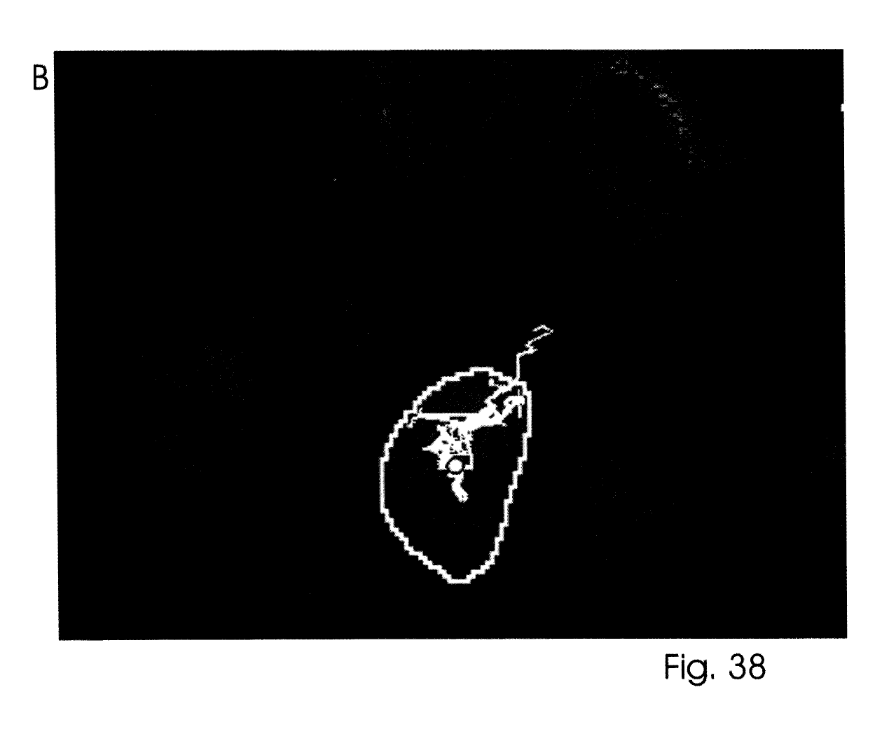

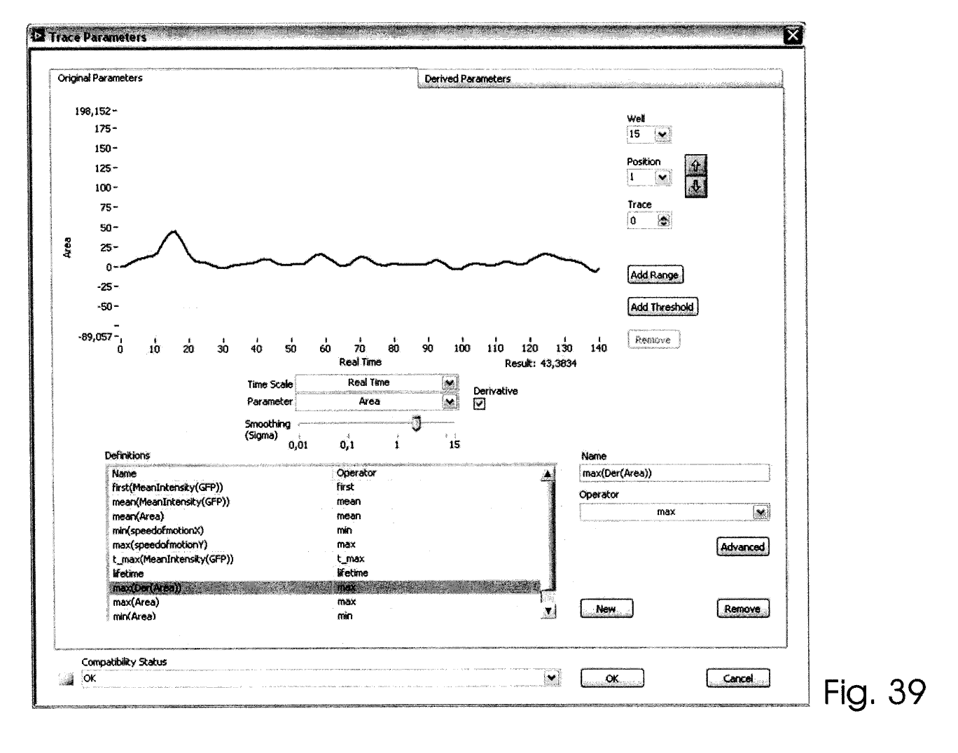

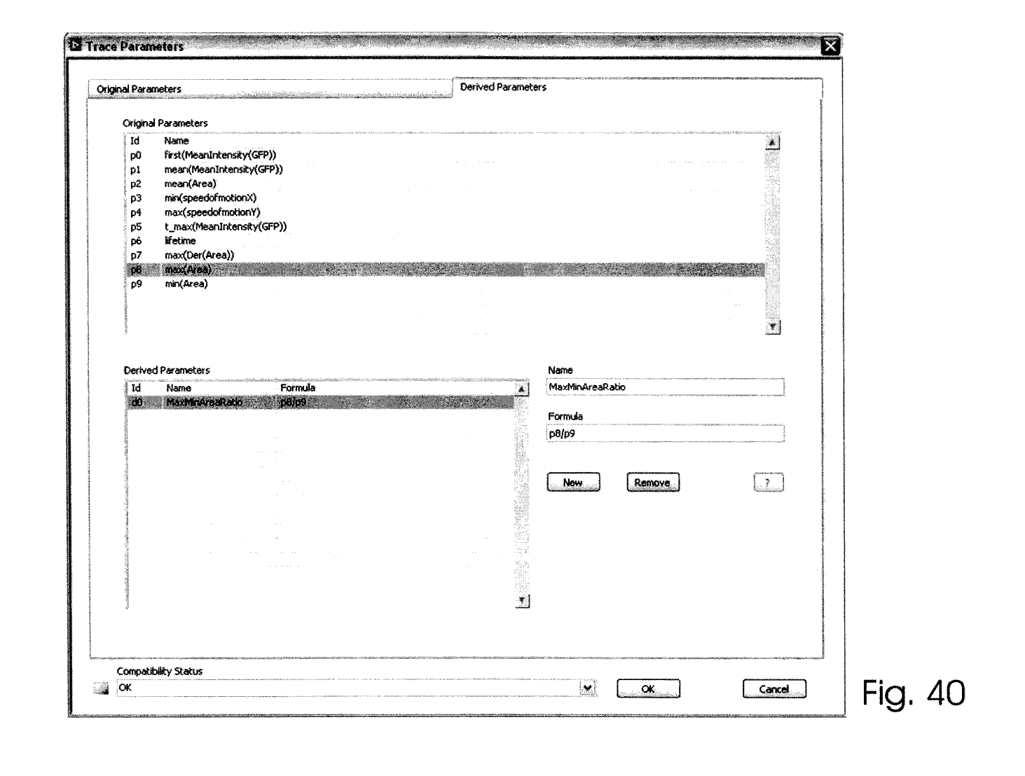

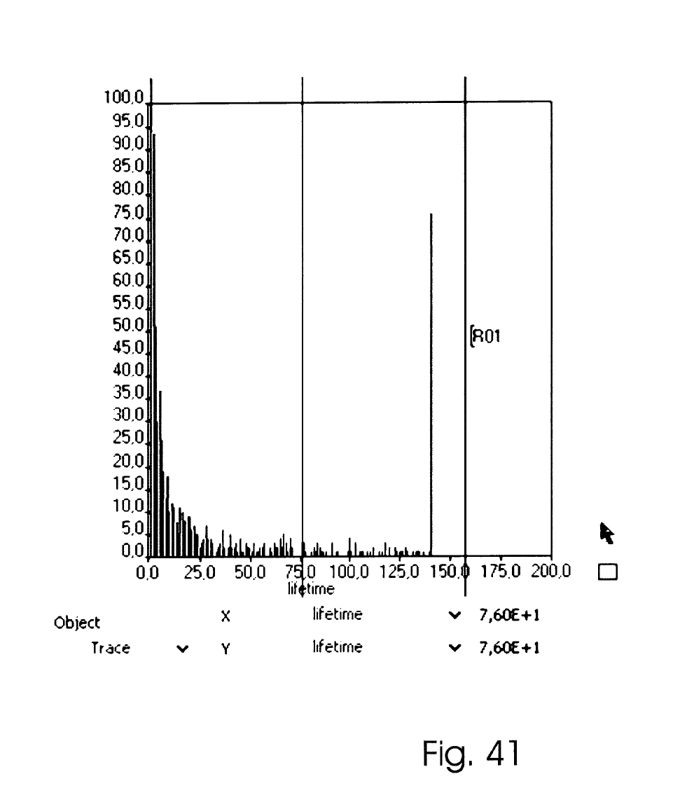

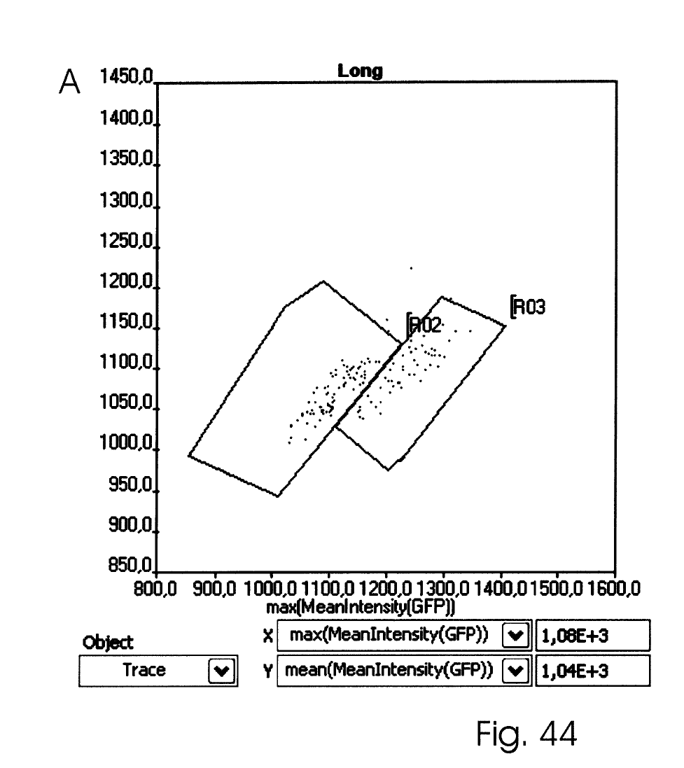

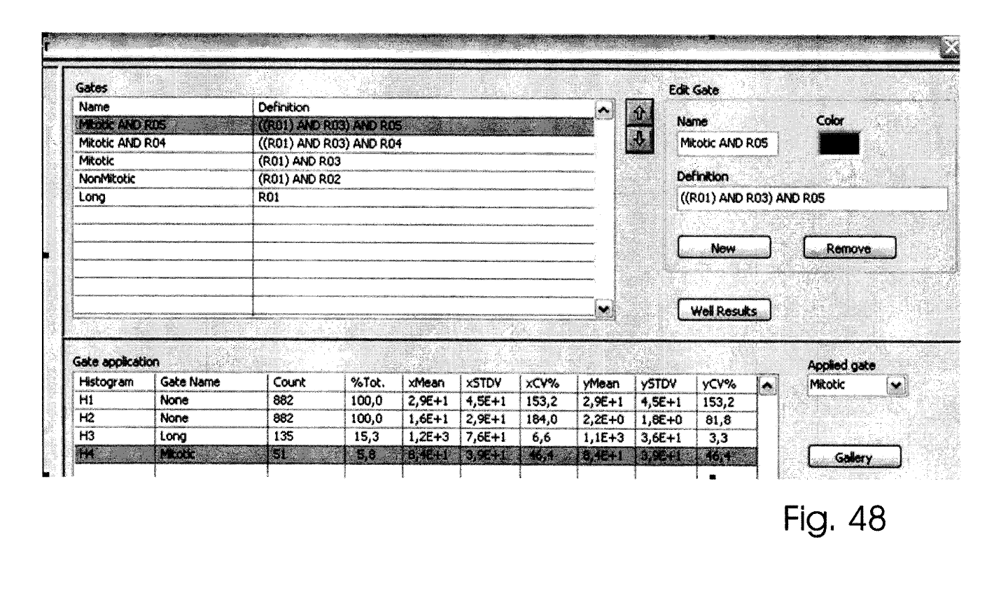

FIGS. 29 to 52 show screen shots of a user interface and display windows of evaluation software used in this example application for classification and analysis or of an analysis and classification system produced with this software, the sequence of these figures demonstrating different steps of the analysis and classification process, beginning with the segmentation process (FIG. 29) via the identification of stationary features to be analysed (FIG. 30), time-lapse images of a particular cell (FIGS. 31 and 32), cell histograms and cell clusters in different sub-spaces of a feature space (FIGS. 33 to 36), selection of a tracked cell with a track on the histogram (FIGS. 37 and 38) the definition of kinetic features and thus a corresponding kinetic feature space (FIG. 39) and the definition of kinetic features derived from kinetic features (FIG. 40), the definition of a class of particular cells and a family of kinetic curves and histograms for cells of this class (FIGS. 41 to 43) and the definition of sub-classes and corresponding classification results (FIGS. 44 to 47) as well as the definition of further sub-classes and corresponding classification results (FIGS. 48 to 52);

Cells: MIN6 cells (mouse insulinoma cells) lipofected with Dendra2-glucokinase (photoconvertible Dendra2 coupled to the enzyme glucokinase which phosphorylates glucose)

Microscope: Olympus IX81, objective: 20×LUCPlanFLN, filter HC set GFP/DsRed sbx (AHF Analysentechnik), incubator (37° C., 5% CO₂, 60% atmospheric moisture)

Photograph: Dr. S. Baltrusch, Medizinische Hochschule Hannover.

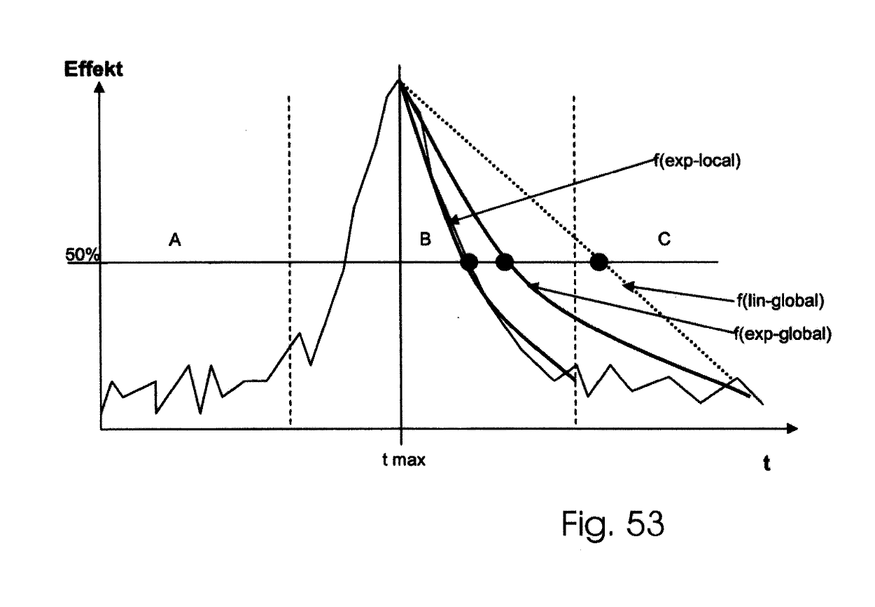

FIG. 53 shows an example of kinetic curves of a typical biological sample in which an effect is exhibited in only one particular time period.

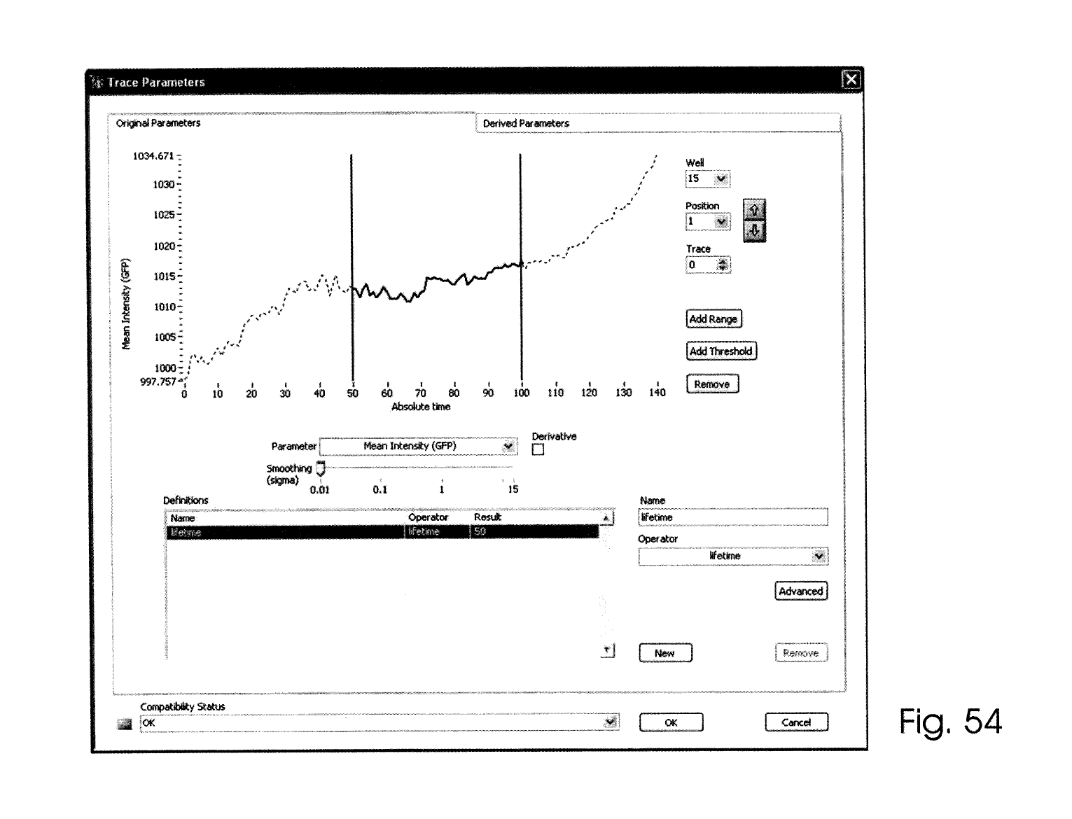

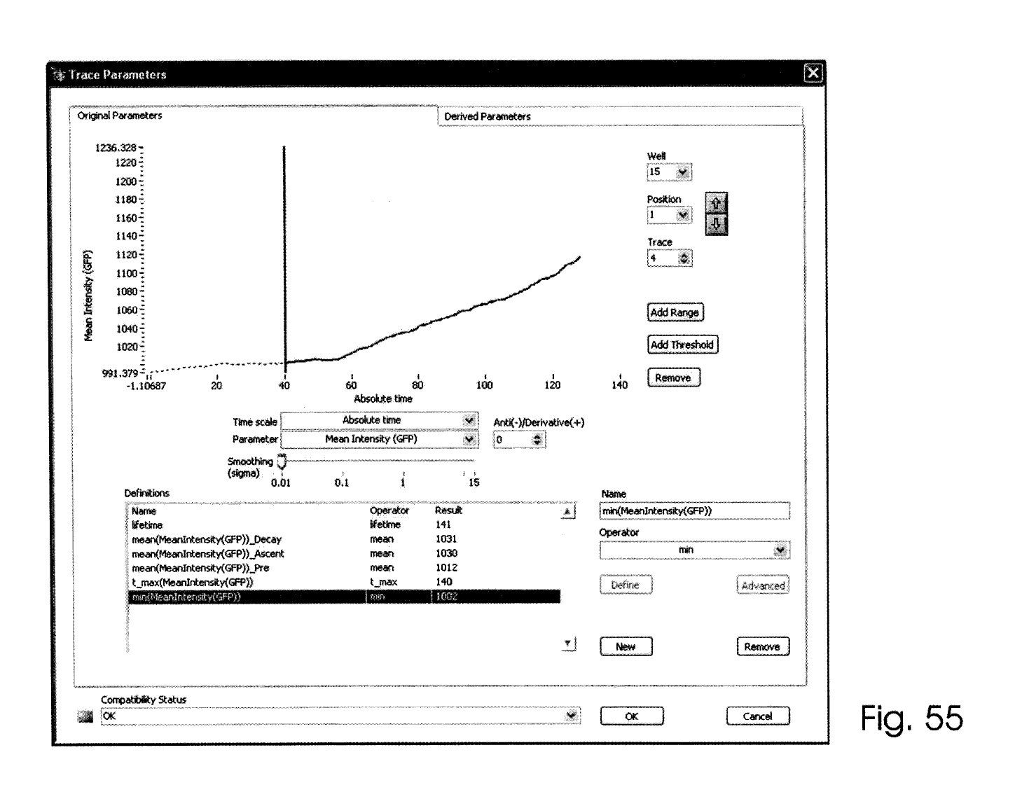

FIGS. 54 and 55 show examples of limiting an analysis of kinetic features to particular time regions of a curve course.

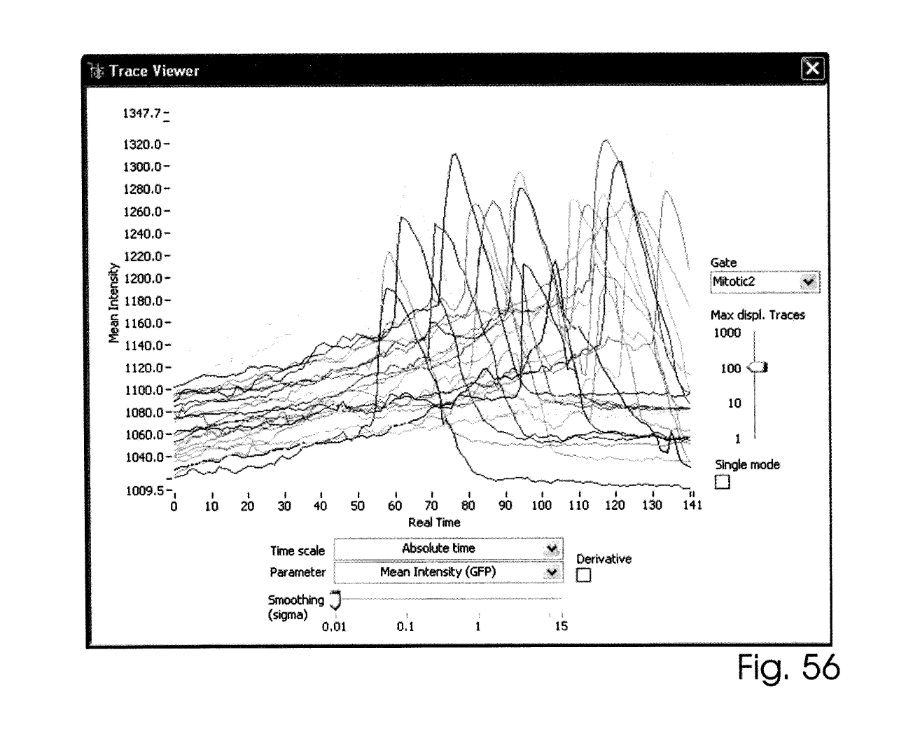

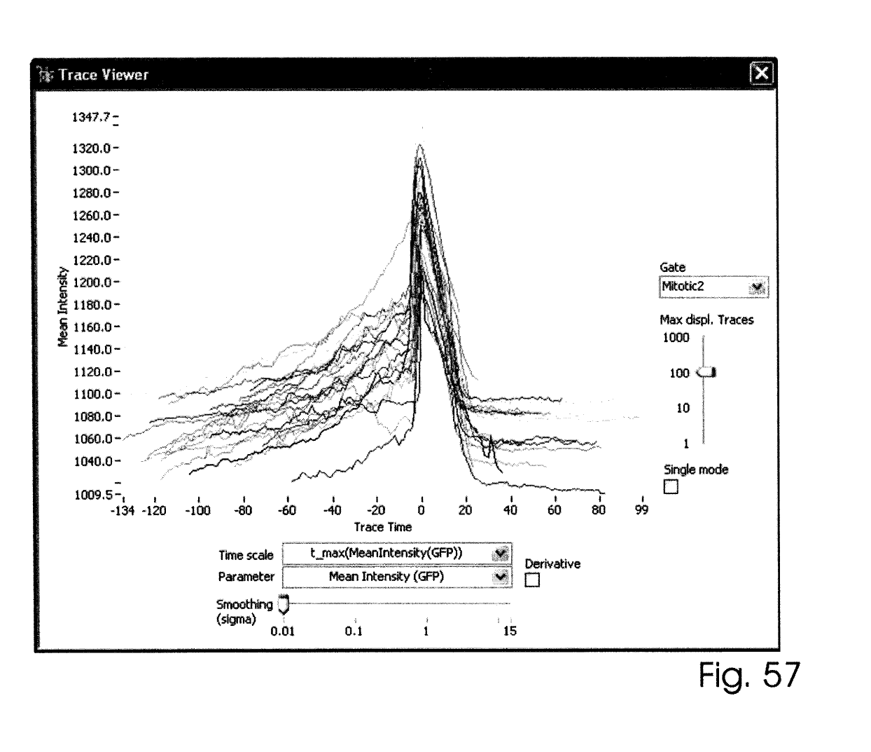

FIG. 56 shows curves, corresponding to these time periods of interest, for mitotic cells on an absolute timescale.

FIG. 57 shows curves, corresponding to these time periods of interest, for mitotic cells on a relative, cell-specific timescale.

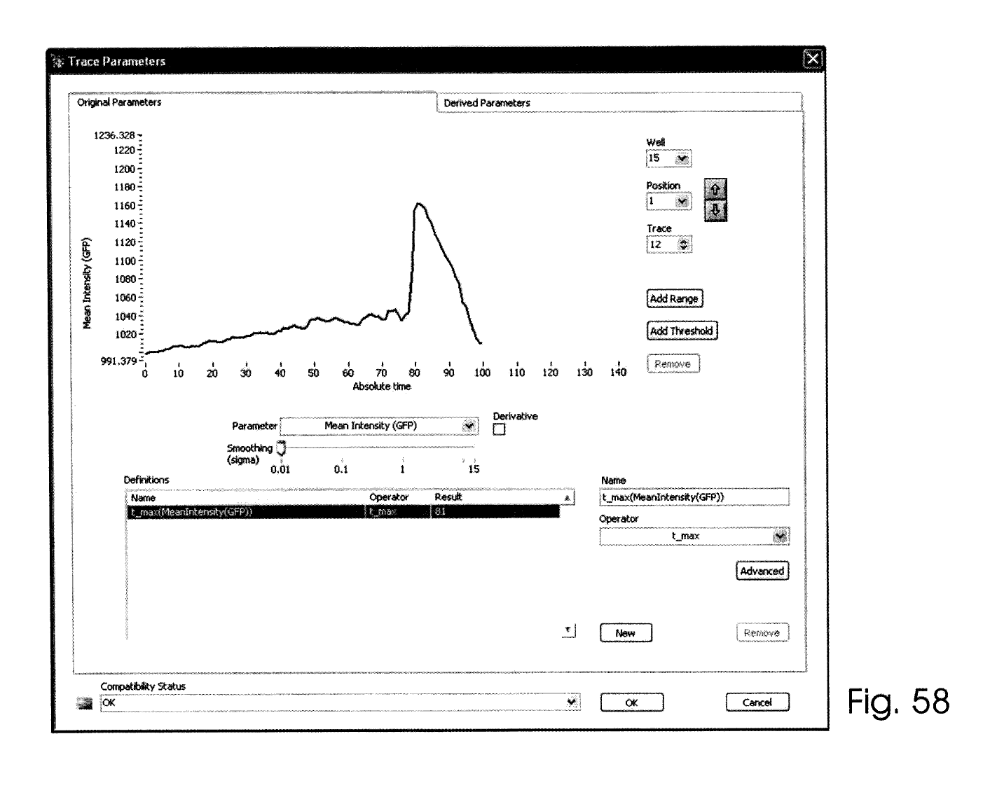

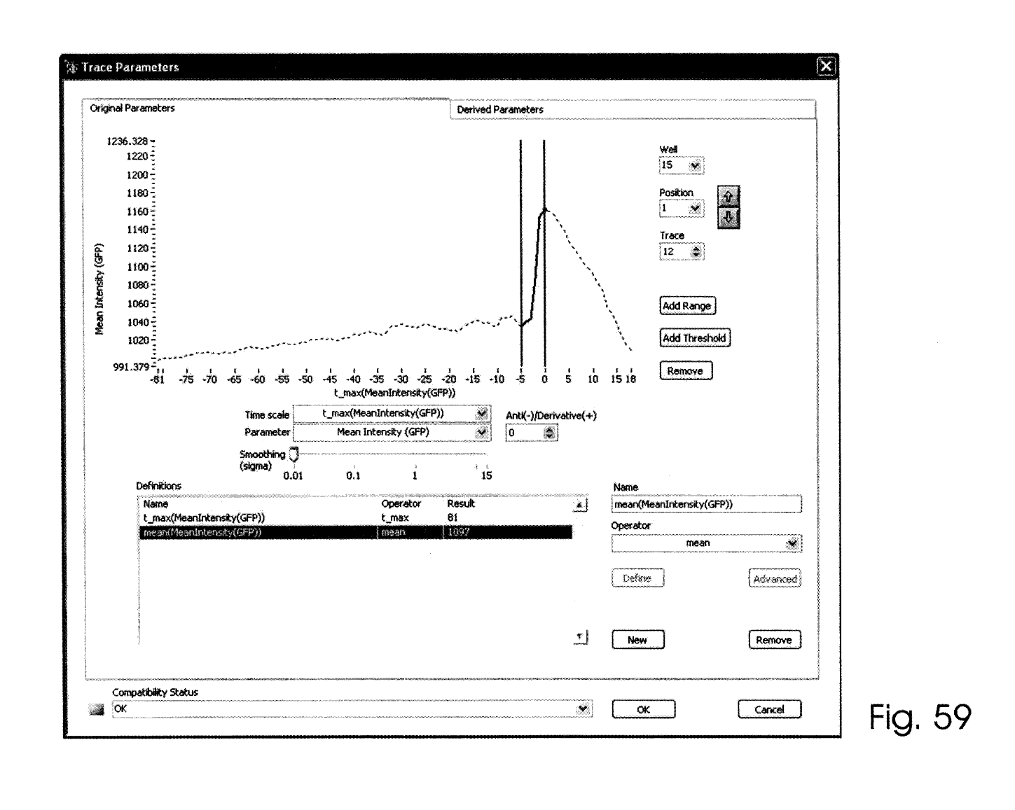

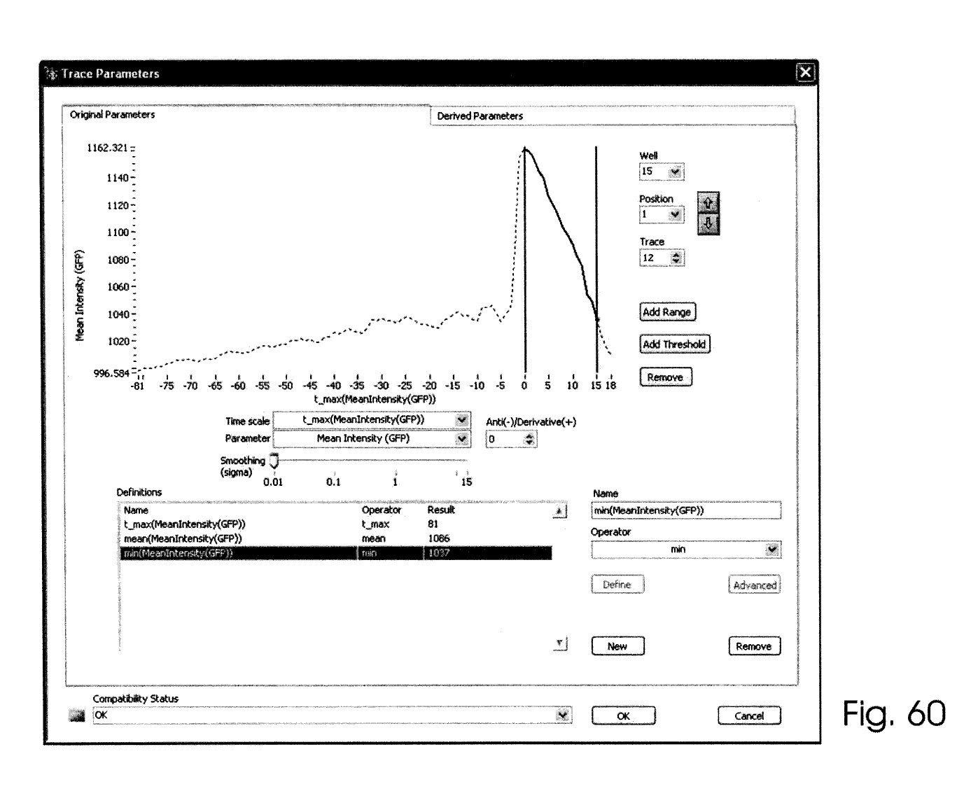

FIGS. 58 to 60 illustrate the definition of a relative curve-specific moment in time (FIG. 58) and the definition of relative time periods of interest in relation to a particular curve-specific reference time (FIGS. 59 and 60).

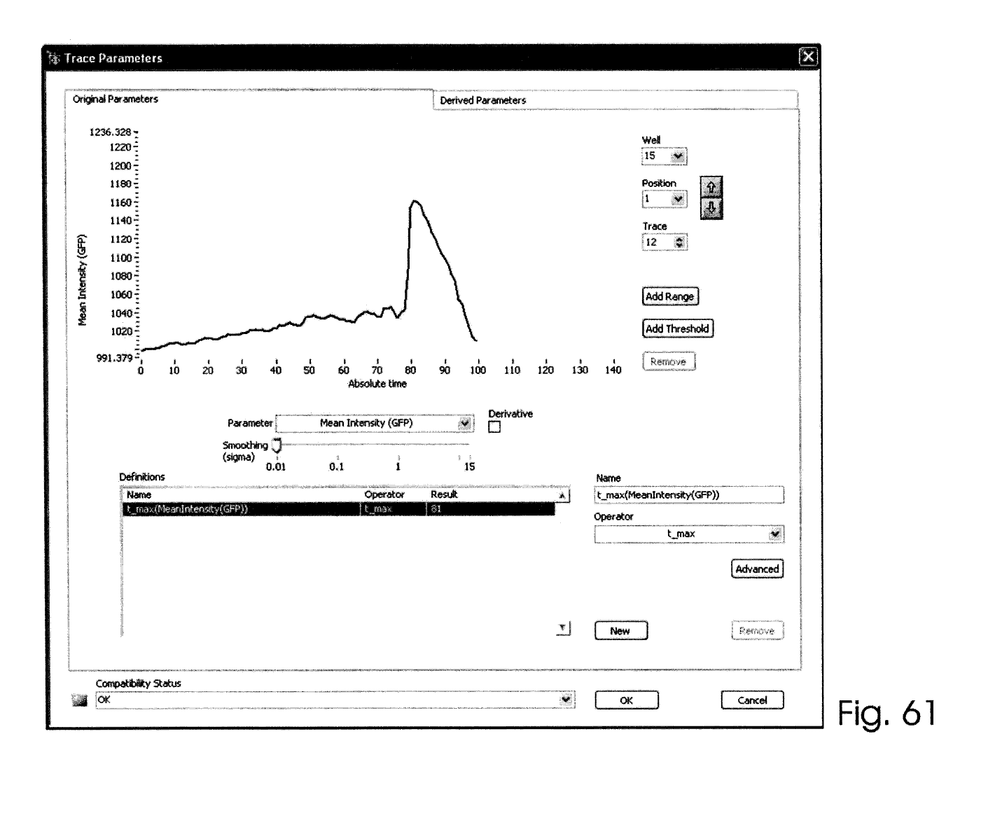

FIG. 61 illustrates the definition of the curve maximum (peak) time as a reference time.

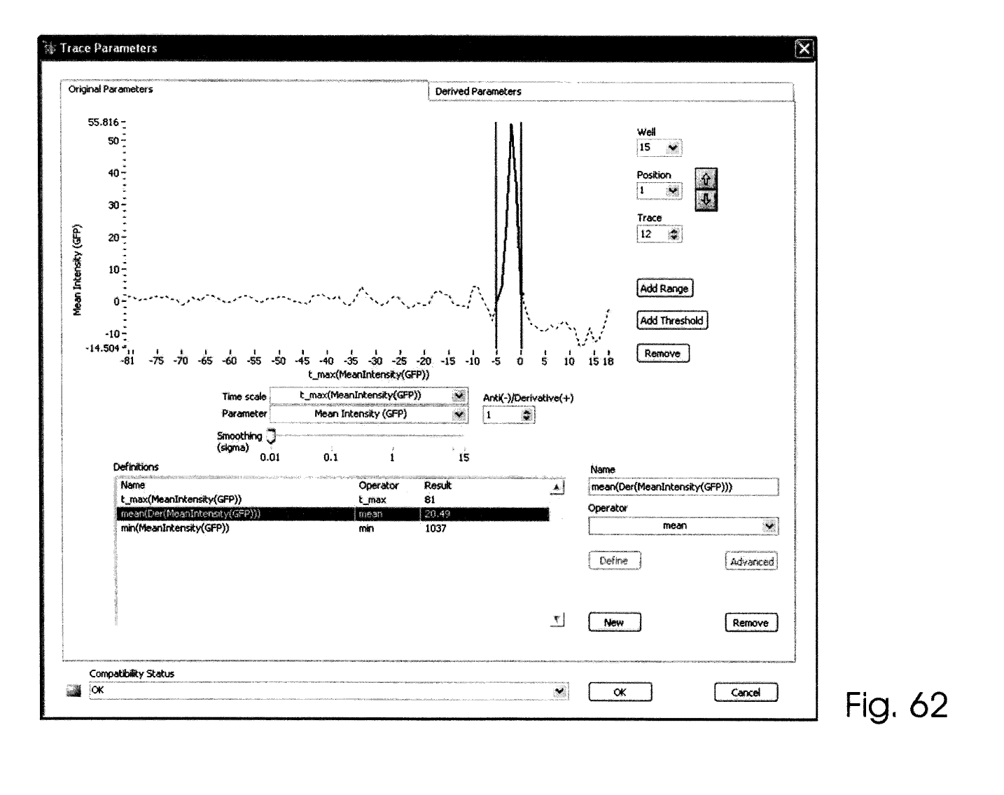

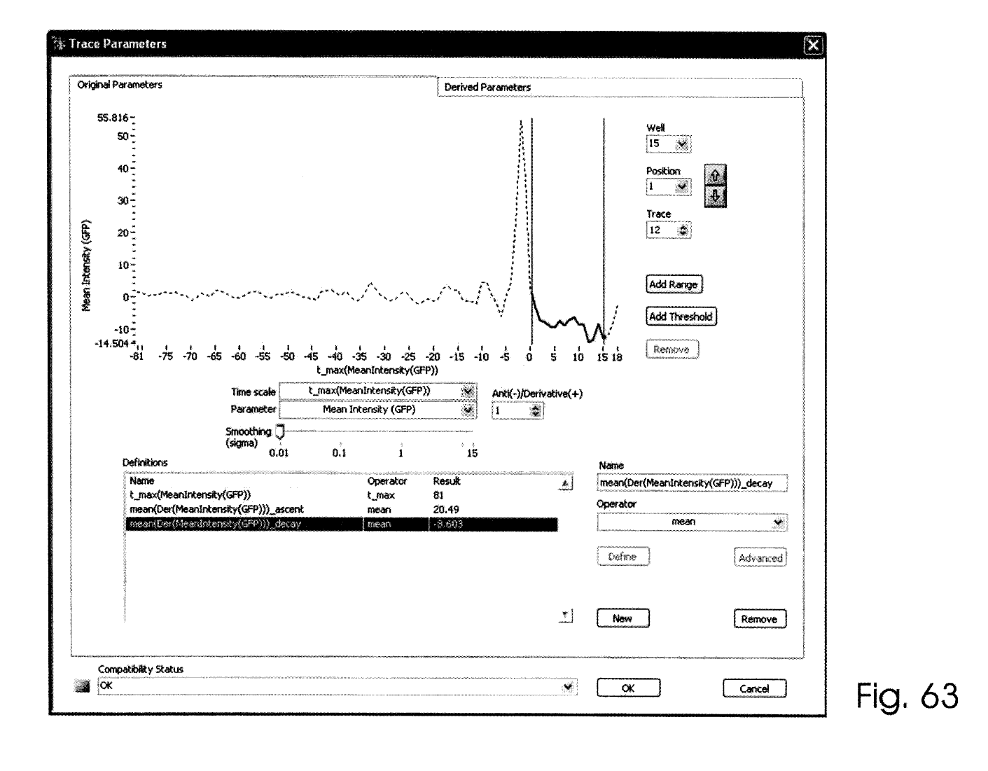

FIGS. 62 and 63 illustrate the establishment of the mean gradient before and after the peak of a particular curve in the time periods previously defined.

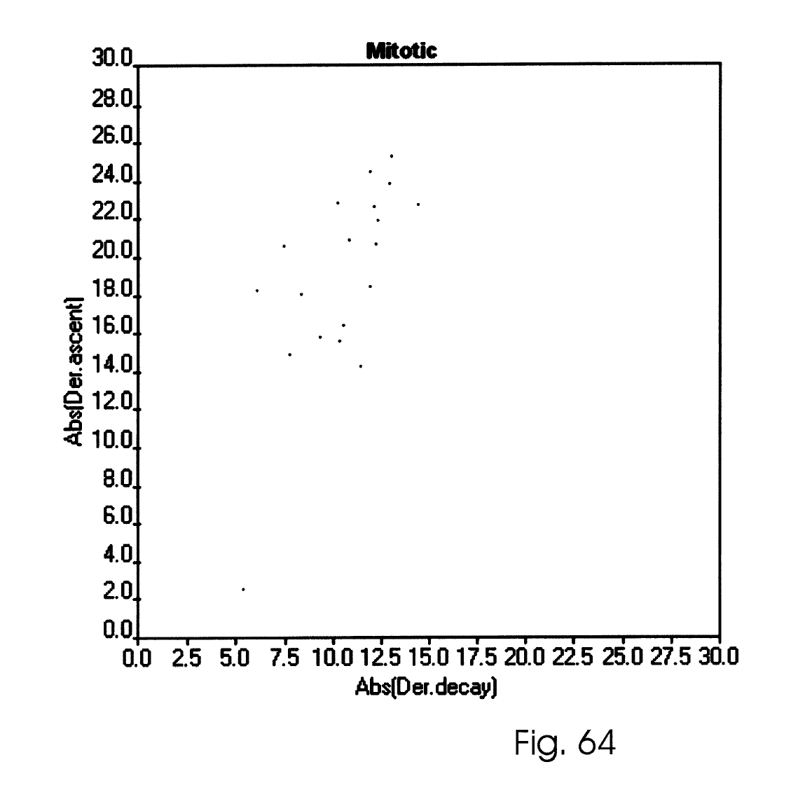

FIG. 64 shows an example of a corresponding evaluation result carried out on the basis of the curve gradients and in which populations (clusters) of interest may be displayed in the case of a large number of individual cases.

Without limiting the general nature of the invention, it may be used particularly advantageously for applications in the fields of biological and medical basic and applied research, toxicology and pharmacology, diagnostics and diagnostic research, drug screening, compound screening, small molecule screening and generally in the field of life sciences, the technology and assays (experiments) used, without limiting the general nature of the invention, being microscopy, both light microscopy and fluorescence microscopy, imaging (predominantly but not necessarily fluorescence imaging) and cell-based assays using live cells. Without limiting the general nature of the invention, applications which could be described by the term “kinetic cytometry” are intended.

The analysis and classification method according to the invention is of particular relevance when there are large volumes of data to be evaluated. Large volumes of data are obtained for example by partly or fully automated systems. However, it is also possible to obtain large volumes of data to be evaluated using systems with a low level of automation. In this respect, a particularly relevant example for the application of the invention is what are known as time-lapse experiments, in particular image-based time-lapse experiments.

Examples of available partly automated and fully automated systems which produce measurement and detection data, for which the method according to the invention can advantageously be used, and on the basis of which systems an analysis and classification system according to the invention can be provided are for example different products provided by OLYMPUS.

a) cell̂*

Systems in the “cell” range, in particular for example the Olympus products cell̂P, cell̂M and cell̂R, are examples of partly automated systems.

Components of cell̂* systems are typically as follows:
microscope: upright (objective above), or “inverted” (objective below), different degrees of motorisation
fluorescence-suitable sensitive digital camera (CCD)
fluorescent light source
incubator (optional) (climatic chamber for live cell observation)
PC
software
motorised specimen stage (optional)
various optional components: lasers, shutters, filter changers, etc.

Partly automated systems of this type may, in principle, be used for time-lapse experiments very similar to those carried out in fully automated systems. In contrast to fully automated systems, the respective experiments are generally only carried out at a small number of locations and for a small number of cells. Culture dishes are generally used instead of microtitre plates so the data volumes are correspondingly lower. Before now, the pictures obtained with these systems were evaluated in a semi-manual manner by the user interactively marking regions of interest (ROI) in the cells on the PC using the mouse, in which regions of interest the change over time is to be measured. When partly automated systems of this type are used or generally when the data volume is low, the method according to the invention may advantageously be implemented for evaluation and analysis since this enables analysis results to be obtained in a more rapid, more reliable and more objective manner and a substantially greater number of parameters can be determined or analysed.

### b) Scan^{R}

The scan̂R and dotSlide systems are examples of fully automated systems provided by OLYMPUS.

FIG. 1 is a typical system diagram of a scan̂R system. A microscope 1, a CCD camera 2, a fluorescent light source 3, a climatic chamber 4, a personal computer 5 having software 6, a motorised specimen stage 7 and a sample 10 are shown.

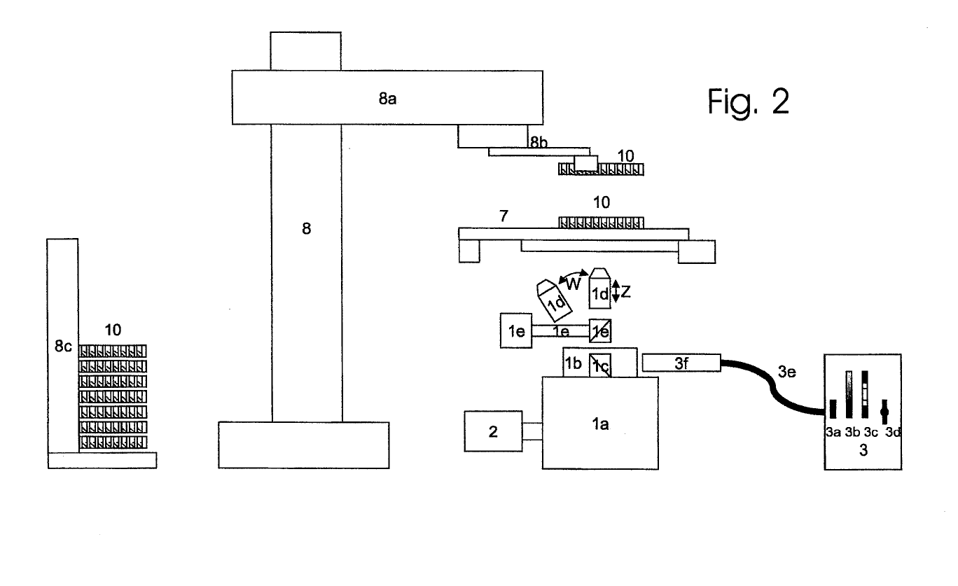

FIG. 2 is a system diagram of the scan̂R system having a sample loading robot. A microscope 1, a CCD camera 2, a fluorescent light source 3, a motorised specimen stage 7, a sample loading robot 8 and a sample 10 are shown.

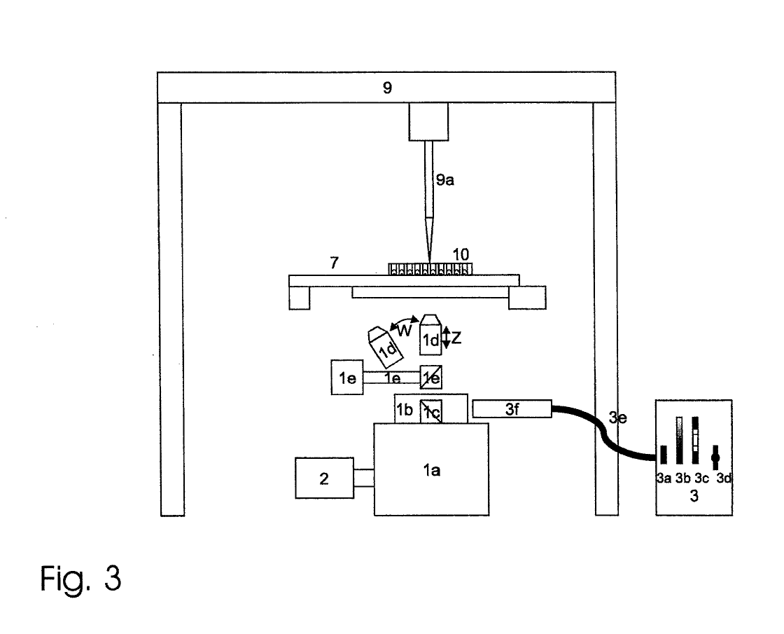

FIG. 3 is a system diagram of the scan̂R system having a pipetting robot. A microscope 1, a CCD camera 2, a fluorescent light source 3, a motorised specimen stage 7, a pipetting robot 9 and a sample 10 are shown.

Typical components and sub-components of the scan̂R system are as follows:
microscope 1: generally an “inverted” microscope (objective below), fully motorised as
   standard
   1a microscope housing
   1b motorised fluorescence filter wheel
   1c fluorescence filter
   1d objective on a motorised objective turret (W) and with a motorised z-focus drive (Z)
   1e hardware autofocus (optional)
fluorescence-suitable sensitive digital camera (2) (CCD)
fluorescent light source 3
   shown in the drawing as a fibre-coupled light source but may also be directly coupled.
   3a motorised closure mechanism (shutter)
   3b motorised attenuator
   3c motorised filter wheel (rapid switching of fluorescent excitation light)
   3d fluorescent light source (Xe-, Hg-, or XeHg burners)
   3e optical fibre
   3f coupling means
incubator 4 (optional) (climatic chamber for live cell observation)
PC 5
software 6
motorised specimen stage 7 (as standard)
various optional components: shutters, filter changers, etc.
sample loading robot 8 (optional) (loading/unloading system for microtitre plates for example)
   8a loading arm
   8b holder
   8c sample container (plate stacking means)
pipetting robot 9 (system for supplying liquids with which the cells can be stimulated in an automatically controlled manner).
   9a liquid application system for supplying and/or suctioning off liquids
biological samples 10, generally microtitre plates or specimen slides

scan̂R is a fully automatic fluorescence microscope which records and analyses images in an automated manner. The image recording and analysis modes are generally configured and set up by experts. The experiments (assays) may subsequently also be carried out by technical staff. The systems operate for hours, and in some cases days, without user interaction. The experiments carried out on systems of this type are largely standardised (what are known as assays). There are many reasons to pursue standardisation and automation which are highly relevant in both basic research and applied research in the pharmaceutical and biotech industries. Some of these reasons will become evident from the following fields of application, but this does not represent an exhaustive list.

Examples of fields of application of particular interest for the scan̂R system and other fully automated systems are as follows:

### “Quantification”:

Biological processes should no longer be described “descriptively” but should be quantified exactly. Since biological systems (cells) exhibit a very high degree of inherent variability, a large number of individual experiments is required to obtain statistically significant quantitative data.

FIG. 4 is a black and white/grey-scale representation of a three-channel image of cells dyed with a first fluorescent nucleus-specific labelling dye (blue), a second labelling dye (green) specific to a cytoplasmic gene and a third labelling dye (red) specific to a further cytoplasmic gene. Further to the RGB overlay in FIG. 4, FIG. 5a shows the blue channel (B), FIG. 5b shows the green channel (G) and FIG. 5c shows the red channel (R). Arrows with the abbreviations R and G representing the colours red and green indicate corresponding colour components in the RGB overlay image. FIG. 5a shows that the majority of the identifiable objects in FIG. 4 are blue cells without any labelling dyes of a different colour.

The cytoplasmic labelling dyes are fluorescent proteins which are coupled specifically to cellular proteins of interest by genetic engineering methods. All the cells in the image are genetically identical and have been subjected to exactly the same treatment. In this context, it could be expected that all cells would have the same optical appearance. In reality, there are a lot of cells which do not exhibit a green signal (G) and only a few of the cells with a green signal also exhibit a red signal (R+G). Furthermore, the intensity of the green and red signals varies considerably. In order to draw meaningful quantitative and statistically significant conclusions despite this biologically-induced variability, it is necessary to perform a large number of measurements with objective and comparable criteria. The invention also aims to be able to evaluate time-dependent measurements of this type under objective and comparable criteria, specifically also in the case of very large data volumes which can be produced by fully automated systems.

### “Screening”:

In modern research, it is often necessary to carry out an enormous number of experiments. For this reason, processes have been automated for many years in many fields of biomedical research. The process of sequencing the human genome (approximately 20,000 genes comprising from tens to hundreds of thousands of bases per gene, and 99% gene-free DNA sequences) by Celera within two years was only possible as it was fully automated. In comparison with “genomics” and “proteomics”, there is still a very low degree of automation in microscopy. Automated microscopes have only been commercially available for a few years and are not widespread.

Examples of microscope-based screening:

Despite the fact that the human genome has been sequenced, the function of the majority of genes is still unknown. Scientists who have specialised in the fields of specific biological processes and are very familiar with these processes, for example transport processes in cells, are now able to search for unknown genes involved in these transport processes. Fluorescence microscopy is the method of choice, in particular for queries in which location information is important. At least approximately 60,000 individual experiments are required for a typical genome-wide screen, and this number can quickly grow to a total of more than 200,000 experiments when replicate measurements are carried out. In substance and drug screening, substance libraries containing a few thousand up to a few hundred thousand substances are used. This could not be achieved manually. The invention aims to enable evaluations of this type to be carried out for time-dependent measurements, specifically also in the case of very large data volumes which can be produced by a fully automated system.

### “Objective Evaluation and Standardisation”:

By automating processes, responsibility for measurement and evaluation is transferred to the “machine”. This ensures that both the image recording process and the image analysis process is carried out under identical conditions for all experiments and cells, and errors caused by the manual interaction of individual users is largely ruled out. The invention aims to enable this type of optimising and standardising evaluation process to be carried out also for time-dependent image data, specifically also in the case of very large data volumes which can be produced by fully automated systems.

c) dotSlide

dotSlide is a fully automated system for scanning specimen slides with histological or pathological fixed specimens and is used in particular in the medical or clinical fields. This system is conventionally used primarily to record images of fixed specimens dyed with absorptive dyes. However it is also possible to use slide scanning systems of this type to carry out time-resolved measurements on live specimens (for example tissue sections) with absorptive dyes (for example colour change reaction or fluorescent dyes) to detect specific molecules for example. For applications of this type, the data evaluation process could advantageously be carried out by applying the analysis and classification method according to the invention.

Typical components of the dotSlide system are as follows:
microscope: generally upright (objective above), fully motorised as standard
colour digital camera (CCD)
transillumination light source
fluorescent light source (optional)
PC
software
motorised specimen stage (as standard)
sample loading robot (optional) (loading/unloading system for specimen slides)

The technical background of the proposals of the invention is described below and methods of the prior art which are more or less close to the invention and are of relevance thereto are described briefly for a clearer understanding of the proposals of the invention.

### 1. Microscopy

### 1.1 Time-Lapse Experiments in Microscopy (Time-Lapse Microscopy)

Time-lapse experiments have been carried out for many years in the field of microscopy. In these experiments, the change in particular properties (parameters) of objects (generally cells or cell components) is observed over time (cf. for example U.S. Pat. No. 5,332,905). The time periods and the time resolution required for these experiments vary widely, since there are very rapid processes, such as the electric activation of nerve cells which are carried out in one to a few milliseconds (= 1/1,000 seconds), as well as very slow processes observed over hours and days, such as cell division or gene expression and gene regulation.

The properties observed as they change over time also vary widely:
a) Movement of the cell: Has the location of the cell changed? Is this movement intentional or random? Speed? Path? Acceleration? Is the movement constant or variable?
b) Movement of cell components within the cell, for example cell vesicles (speed, acceleration, etc.)
c) Change in the intensity of an indicator signal in the cell: cellular processes cannot generally be measured directly but are displayed using suitable indicators. In microscopy, these indicators are preferably specific dyes. It is possible, in particular by means of fluorescence microscopy, to dye cells in a highly specific manner and with a very favourable signal/background ratio.

### EXAMPLE 1

### Fluorescent Proteins

Fluorescent proteins occur naturally in seawater jellyfish. The gene sequences thereof are known so these gene sequences can be introduced into cells and coupled to the gene sequences of cellular proteins of interest using established gene manipulation methods. In this way, these proteins in the cell are made visible by fluorescence if they are expressed in the cell (=the gene sequence is read and translated into a protein). The amount of the protein in the cell can be determined by the intensity of the fluorescent signal. It is possible to determine whether and how the amount of the protein in the cell changes by measuring the change in fluorescence over time. The protein content may be a function of a large number of factors which can now all be tested quantitatively: age and state of the cell: is the protein content controlled by cell-specific genetic factors? Can the protein content be influenced by external factors, for example drugs, chemicals, cell signal substances?

### EXAMPLE 2

### Indicators of the Ion Balance (=Charged Molecules) in the Cell

The ion balance is of vital importance for living cells. The regulation of the concentration and composition of ions inside and outside the organism is essential for life to regulate the water content thereof. Many metabolic diseases are caused by ion regulation malfunctions (for example cystic fibrosis). An equally important and more widely known example is the electrical conduction and processing of signals in nerve cells which take place via very rapid changes in the ion concentration. One of the most important ions for cellular communication, not only in nerve cells, but in all cells, is the calcium ion Ca⁺⁺. The calcium concentration in cells and cell components can be measured very well using fluorescent dyes, the signal intensity of which is a direct function of the calcium concentration (typical calcium dyes are, for example, FURA, Fluo3, Fluo4, chameleon). It is particularly important for the method presented in this document that the calcium signals in the different signal pathways do not frequently differ in terms of intensity but in terms of the characteristic chronological development profile thereof.

### d) Change in the Location of an Indicator Signal in the Cell

Many processes in cells involve changes in the location of proteins.

### EXAMPLE 1

### Intracellular Transport

Membrane-associated and secretory proteins are synthesised in the endoplasmic reticulum and transported therefrom via the Golgi apparatus and a network of vesicles (trans-Golgi network) to their target membranes, or are discharged from the cell. During this transport process, the proteins are specifically modified. A complicated and not yet fully understood network of signal sequences and transport proteins ensures that the proteins reach their target locations. Many storage diseases are caused by defects in this transport chain.

### EXAMPLE 2

### Translocation

There are particular receptor molecules on the cell surface responsible for cell-to-cell communication (for example hormone receptors). When specific signal molecules, ligands, bind to these receptors, internal signalling cascades are triggered within the cells, and these cascades frequently cause proteins, in the cytosol for example, to migrate into the nucleus and activate specific genes. Particular types of tumour can be traced back to disruptions of this signal pathway. Furthermore, many drugs have an effect on the activation and deactivation of cellular signal pathways mediated by cell surface receptors. These signal pathways are therefore of great interest for pharmaceutical research.

### e) Change in Cell Shape

The morphology of cells is highly variable and cells are able to change in a short space of time (a few minutes). These changes enable conclusions to be drawn on the state of the cell.

### f) Changes in the Shape of Cell Components

Similarly to an entire cell, the morphology of cell components can also change. It is therefore possible to conclude whether the cell is necrotic (cell death caused by external influences) or apoptotic (cell death caused by an internally triggered signalling cascade—“cellular suicide”) from the type of change in the cell nucleus.

The cytoskeleton of cells can be destroyed by particular drugs (cytochalasin). This causes changes in both internal and external cell morphology.

### 1.2 Technological Prior Art for Analysing Time-Lapse Experiments in the Field of Biology

Time series of images are typically recorded by at least semi-automated image capture systems. It is necessary for the process to be automated, since this is the only way to ensure that the images are recorded at constant, or known, time intervals. It is possible to analyse these data in different ways. In this document, only largely automated methods are described.

### 1.2.1 Segmentation

For automated time-lapse analysis, it is first necessary to identify the objects of interest in all the images. The object identification process may take place in two separate steps: 1. Segmentation (=identification of objects in contrast to non-objects); 2. Classification: identification of objects of interest via characteristic properties, in contrast to segmented objects which are no longer of interest for further analysis. Example: all the cells in the image shown in FIG. 4 or FIGS. 5a to 5c can be identified by the blue signal (cell nucleus) and segmented. However, only cells also exhibiting a green and a red signal are of interest for further analysis. It is alternatively possible to carry out the segmentation and classification processes in one step using more complex algorithms.

The segmentation process is carried out in the same way over the entire image data set. The chronological sequence of the images is not taken into account.

Examples of a number of possible ways in which the objects in the images can be identified are given below. The images are said to be “segmented”, in the language of this specialist field, in order to identify objects.

In a first step illustrated in FIG. 6a, a threshold is applied. All image regions lighter than this threshold are defined as objects. All regions darker than the threshold are assigned to the background. Some objects which can be recognised by the eye as independent objects are not separated since they do not fall short of the threshold.

For this reason, joined objects are separated in a second step, as shown in FIG. 6b, using a second suitable algorithm (for example what is known as a “watershed algorithm”). In a third step, light image regions surrounded fully by the background or separated by the watershed algorithm are then defined as independent objects and a binary image of the individual objects is produced, the objects being marked, for example numbered consecutively and colour-coded, as shown in the grey-scale image in FIG. 6c. This binarised image can then be used as a mask for the measurement and detection processes in the original image.

### 1.2.2 “Tracking”

Following the segmentation process, the objects are identified in the successive images and associated using known methods (for example via the proximity thereof), thus enabling changes in these objects over time to be measured.

Referring to the schematic diagram in FIG. 7, one of several possibilities for identifying objects in time-lapse images will now be described. Objects are initially detected independently in the time-lapse images t0 to t4. There is not yet any information available on the association between the individual objects or object representations and a particular object over time. The center of gravity of the detected objects is determined (other properties are also suitable for this process) and an acceptance region is defined. When the center of gravity of the object in one image is located within the projected acceptance region in the directly preceding image, the object is associated with a single object. This chronological association process is required to measure changes in properties of the object over time.

FIG. 8a shows the motion track of a cell determined by a tracking process of this type. FIG. 8b is a gallery of the individual associated images, the cell being arranged in the centre of each of the relevant image details. Each individual image in the gallery was recorded at a different time and in a different location due to the motion of the cell. Referring to the example in FIG. 4, it is possible for example to measure the intensity ratio of the red and green dyes in the cell over time with a tracking process of this type and to display it in the form of a corresponding measurement curve, thus enabling further evaluation processes to be performed.

### 1.2.3 Kinetic Analysis

Dynamic data are often collected and analysed in the general sciences. Measurements are usually taken at time intervals. It is possible to produce curves from these measurements and, using mathematical methods (“fitting”, “curve sketching”, etc.), to derive from these curves values which characterise the dynamic processes. Mathematical methods of this type have hitherto been used only in some specialist biological fields and are not used for cell- and image-based screening experiments.

Examples of values which can be derived in this way are decay constants, frequency in the case of cyclical signals, rise time constants, times of maximum or minimum intensity, extension, speed, etc.

In this case, it should be noted that it is possible to derive characteristic individual values from measurement curves which are formed from a large number of measured points and originate from individual, dynamically changing objects.

### 1.2.4 Live-Cell High-Content Screening

Fully automated microscope-based imaging systems capable of carrying out time-lapse measurement on live cells are known and form part of the prior art.

### 1.2.5 Time-Lapse High-Content Screening

Automated tracking methods, as described in 1.2.2, are used in live-cell high-content screening systems, as described in 1.2.4, to obtain kinetic data on individual cell levels. These kinetic data are generally displayed in the form of curves. Using the diagram, it is only possible to differentiate between groups of curves with different curve shapes if these curves differ clearly with respect to one parameter and the chronological development thereof. This is generally not the case for many queries or for the typically highly dispersed results of biological experiments. In particular, there is no way of precisely and quantifiably measuring differences which exist only in the curve shape or of selecting curves on the basis of the curve shape using objectifiable, quantitative criteria. This type of analysis is also not possible when there is a very high number of curves or when the curve shapes differ greatly, causing them to be superimposed in an unclear manner.

It is sometimes possible for a trained eye to be able to differentiate between curve shapes of different types in a resulting curve family consisting of a very large number of curves. There are also specific cases in which different sub-families of curves can be clearly and qualitatively differentiated from one another on the basis of a simple signal threshold (cf. FIG. 9) or a simple time threshold (cf. FIG. 10). If sub-families of curves which can be differentiated by using simple thresholds are expected, it is also possible to carry out corresponding differentiation processes in an automated or automatic manner. However, separating curve families on the basis of thresholds requires that the curves already differ from one another by a single parameter.

However, when separation by means of clearly differentiated singular and primary curve parameters is not possible due to the inherent variability of biological samples, it is not possible to carry out the data processing procedures of differentiation and classification either using a trained human eye or conventional approaches.

FIG. 11 shows a selection of different curves of the chronological development of a dye intensity ratio from a data set of more than 5,000 curves. It is not possible to identify sub-populations of interest from measurement data of this type either by using a trained human eye or by conventional evaluation approaches, even if the curves are displayed in different colours in a colour diagram. It should be noted that between several tens of thousands and several hundreds of thousands curves are conventionally produced in typical cell- and image-based screening experiments.

However, by applying the analysis and classification method according to the invention, it is possible to identify clearly populations in a curve family of this type and to assign them to classes which differ significantly in terms of their kinetic behaviour. In this way, it is possible for example to identify cells with an intensity signal having characteristic chronological development profiles which are clearly different to those of other cells.

### 2. Prior Art in the Field of Cytometry

### 2.1 Origins in Flow Cytometry

The methodology of cytometric data analysis was originally developed for the field of flow cytometry (cf. for example U.S. Pat. No. 4,021,117, U.S. Pat. No. 4,661,913 and U.S. Pat. No. 4,845,653).

In flow cytometry, cells in a fluid phase are analysed individually by guiding them in a focussed manner by means of a sheath flow through a lighting means which triggers an optical signal (including fluorescence) which is recorded by detectors. Each detector i transmits a one-dimensional signal a_i(x) to the data processing means, x representing the location of the cell in the flow chamber used.

This basically corresponds to a one-dimensional scanning process which cannot be repeated for individual cells since it is no longer possible to allocate the signals to the cells in a second pass on account of the fluid guide means. It is therefore not possible to measure any direct chronological developments in individual cell signals.

The signals a_i(x) obtained are then characterised by the appearance of peaks which are measured by suitable methods so that measurement parameters (for example surface area, height, width) are produced for each cell from each of the detectors connected.

A trigger signal (typically a transillumination signal: SSC, FSC) is frequently used to determine the beginning and end of the cell to increase measurement precision.

A problem generally encountered when using the method is how to make the very large data volumes produced usable, since the typical cell throughput per sample is in the range of between several 10³ and 10⁷.

A further drawback is that different cell types and foreign particles may occur in the fluid, complicating the association of data points to the different groups. If a sorter is not attached, the properties of the analysed particles cannot be investigated further since it is not possible to assign individual particles to cell types at a later stage.

In summary, the technical conditions of flow cytometry result in the following drawbacks in cell analysis:
Manageable handling and use of large data volumes
A priori unknown assignment characteristics for classes (on account of the variability of biological systems)
Assignment of individual particle results to classes for measurement and counting

### 2.2 Methodology of Cytometric Cell Analysis

The aforementioned problems have largely been solved by the introduction of cytometric data analysis.

In this process, projections of the multi-dimensional property or parameter space in one, two or occasionally three dimensions in density distribution diagrams, for example histograms or scatter plots, are used in order to define the data on the basis of these classifiers which are linked by logical operators. Histograms differ from scatter plots in that they are diagrams of density distribution whereas scatter plots are pure data point diagrams which are not effective at very high data densities. Alternative density distribution diagrams are, for example, contour plots with lines of the same density.

In general, a higher data volume means that the measurements (for example percentages or mean values for the classes) are more precise. However, the higher data density in the feature space also enables the object types to be classified in a substantially simpler manner. A selected projection for a two-dimensional diagram is also significant for cytometric analysis. A large number of data points generally makes it possible to allocate said data into classes in an expedient and accurate manner without requiring information a priori on the source of the data (blind classification). Projection to only two dimensions increases the data density. The density can in this case be coloured in a graphical diagram.

Linking the classifiers produced in low-dimensional projections of the feature space via logical operators therefore enables undesirable objects to be removed from the statistical evaluation process and allows further analysis on sub-classes to be carried out.

### 2.3 Imaging Cytometry

Cytometric analysis methods have been used for the image-based analysis of fluorescent dyed cells for a considerable length of time but are not widely used.

In terms of products, cytometric image analyses are carried out in particular in the Compucyte iCyte laser scanner (http://www.compucyte.com/icyte.htm) or in the flow-based ImageStream from Amnis (http://www.amins.com/). In terms of the technology used, these systems are only suitable for time-lapse analysis to a limited extent or are not suitable at all and do not carry out cytometric time-lapse analysis.

The main difference to flow data is the dimensionality of the original data. The original data is one-dimensional in flow cytometry, and is typically two-dimensional in imaging cytometry, but imaging cytometry may also include time or the third spatial dimension since it is possible in principle to associate identical cells from different images.

For a better understanding, a simple example of a cytometric image analysis of this type according to the prior art of two-dimensional image data on tests performed using the scan̂R system is described below with all the major steps thereof. The analysis and classification software of the scan̂R system is used.

In this case only the generation of classifiers and the evaluation thereof to produce sample results will be described. It is of course possible to apply analysis rules generated in this way to a large number of samples without manual intervention in a manner analogous to the automated analysis process.

### Step 1: Object Detection

Example: Image data have already been obtained using the scan̂R system, specifically from a microtitre plate comprising a plurality of sample wells (see FIG. 12 illustrating the selection of wells and positions in a particular well on a plate).

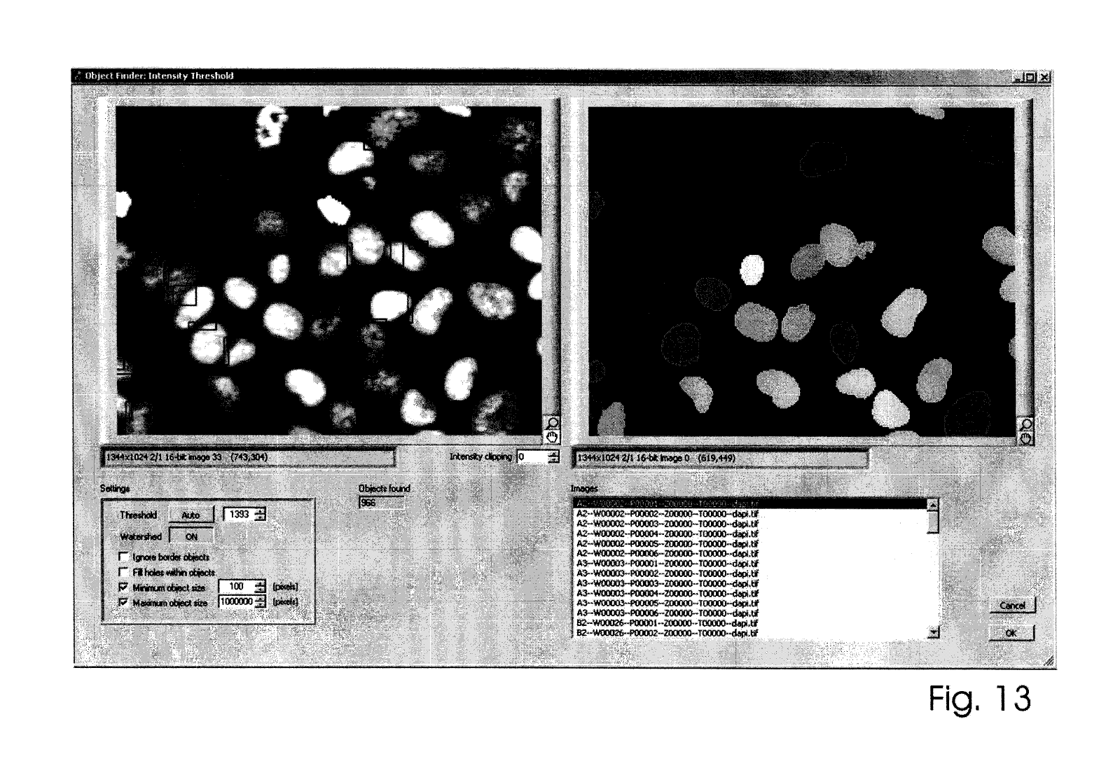

If necessary, mask detection is adjusted (FIG. 13, which illustrates object detection and segmentation processes, for example by applying thresholds). Sub-objects which are found on or in the masks of the main objects may optionally be defined.

### Step 2: Definition of the Two-Dimensional Feature Data

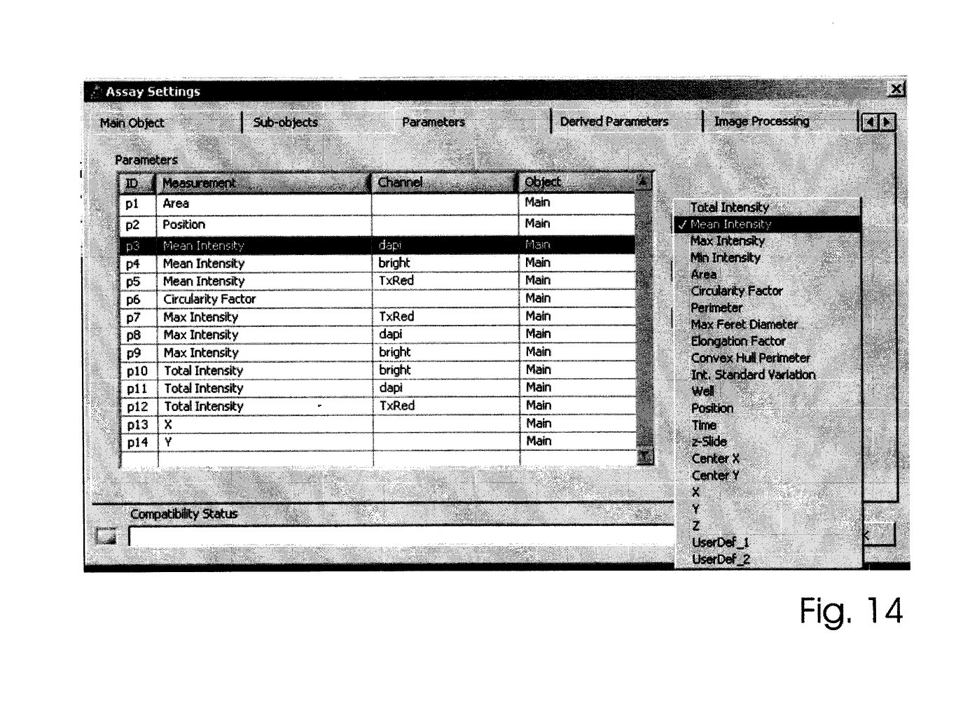

The feature data (parameters) to be obtained from the mask are defined (FIG. 14).

It is also possible to obtain feature data on the sub-objects, and this feature data can be used to generate feature data of the sub-objects on the main objects via statistical operators.

FIG. 14 shows the user interface for defining the parameters (features) which are to be measured on the mask. For example, features from a list containing a total of approximately 100 different features may be selected.

### Step 3: Carry Out Analysis and Cytometric Classification Processes

It is now possible to carry out the image analysis process. This is a time-consuming step since the images as a whole are used as a basis for data, specifically for the segmentation (object detection) process and it is also necessary to include the surroundings of the pixels in the segmentation step.

In this case, the images are typically formed from ˜10⁶ pixels (for example 1344×1024), so that, for a plate having 96 wells and 4 images per well for example, a total of ˜0.5×10⁹ data points and the surroundings are included in the algorithms calculations.

In contrast, the following definition of cytometric classification can be carried out interactively since the feature space has a comparatively low number of data points (˜a few million) and the cytometric classification process requires less computing time.

Regions linked by Boolean operators are used for classification.

The regions may be defined by quadrants, ranges, polygons or other one-dimensional or two-dimensional classifiers.

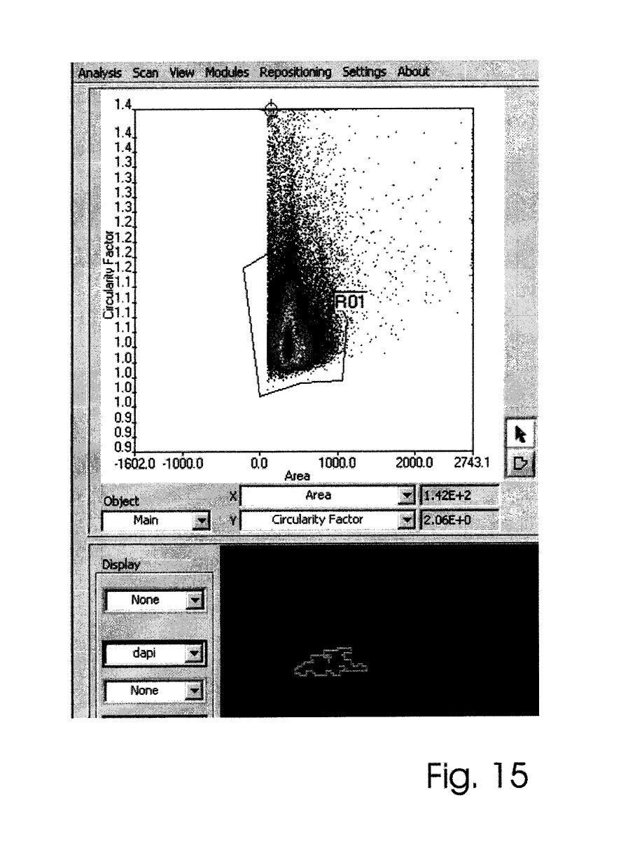

In the screenshot shown in FIG. 15, a typical pre-selected group of well-segmented cell nucleii are shown. In the area/circularity projection, these nucleii form a cluster from which it is possible to define a classifier with a polygon R01. This classification step enables cell nucleii which are insufficiently segmented to be defined and thus removed.

In the example shown in FIG. 15, a poorly segmented cell nucleus selected by a crosshair cursor lies outside the region R01 defined in the projection of the feature space representing the area and circularity parameters.

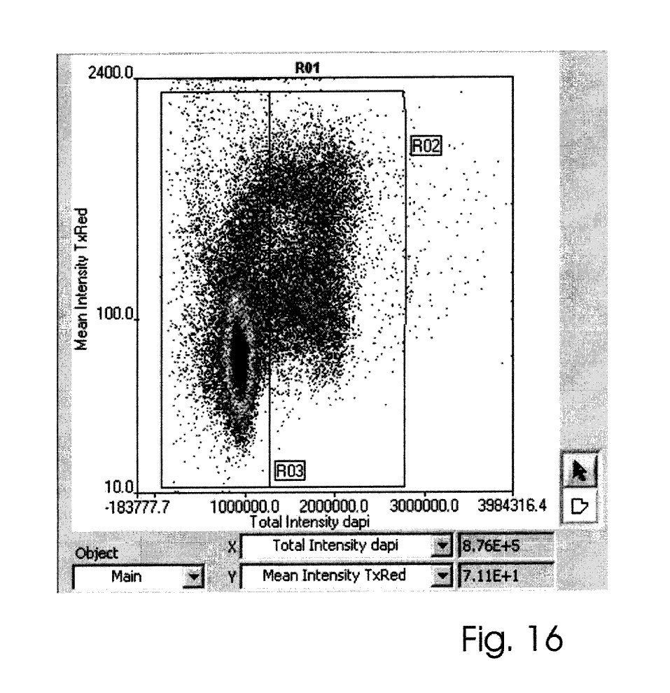

In a second step, it is now possible to display the cell nucleii selected in this way in a further projection of the feature space, specifying in this case the intensities in a first channel (dapi channel, blue) and in a channel (repair marker channel, red) (FIG. 16).

FIG. 16 shows a projection of the dapi/repair marker feature space for defining the regions R01 and R03 on the basis of the class of well segmented cell nucleii (R01).

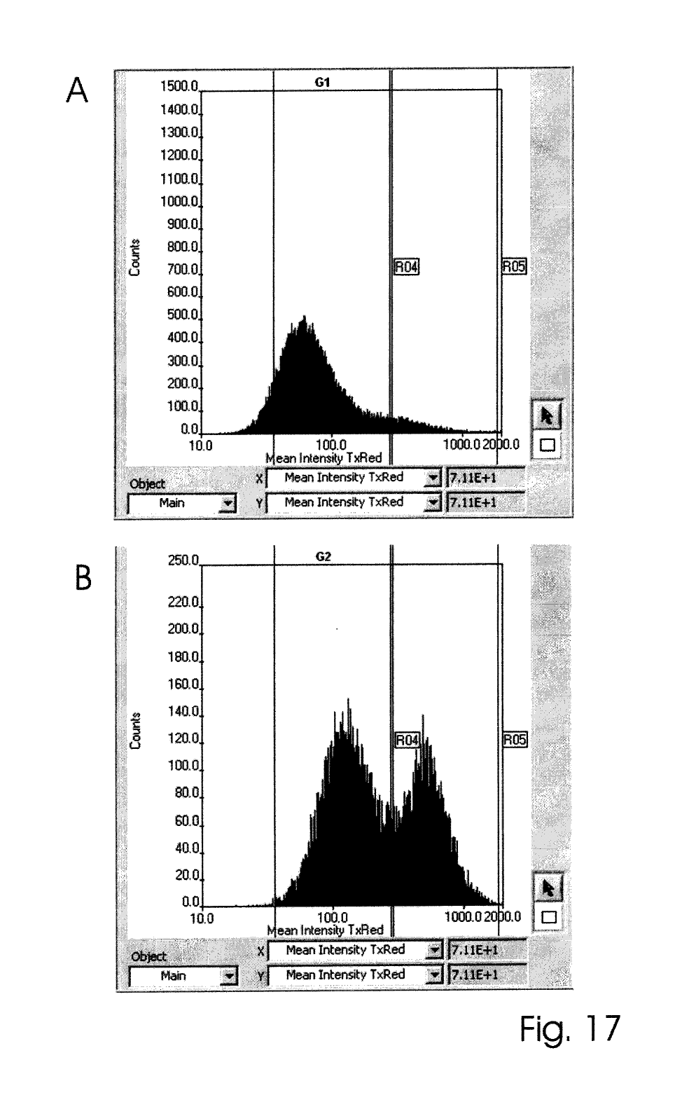

The regions can be linked to other classifiers. In the screenshot shown in FIG. 17, the class (gate) G1 defines for example the cell nucleii with a single set of DNA, whereas G2 exhibits a double set of DNA, as is typical for the cell cycle phase prior to mitosis. FIG. 17 illustrates the definition of the active and passive cells on the basis of repair markers, and specifically shows the definition in relation to class G1 in sub-FIG. A and the definition according to class G2 in sub-FIG. B.

Furthermore, the regions R04 and R05 identified in the histograms in FIG. 17 define sub-classes of cells which are associated with repair mechanism activities. In this way, it is possible to group the regions into meaningful classes via logical operators, as shown by way of example in FIG. 18.

In the example shown, class R01 was defined for correctly segmented cell nucleii, G1 was defined for the first phase of the cell cycle (FIG. 17A), G2 was defined for the second phase of the cell cycle (FIG. 17B) and the repair-active and repair-passive cells were defined by R04 and R05.

### Step 4: Obtaining the Sample Results on the Basis of the Classification Process

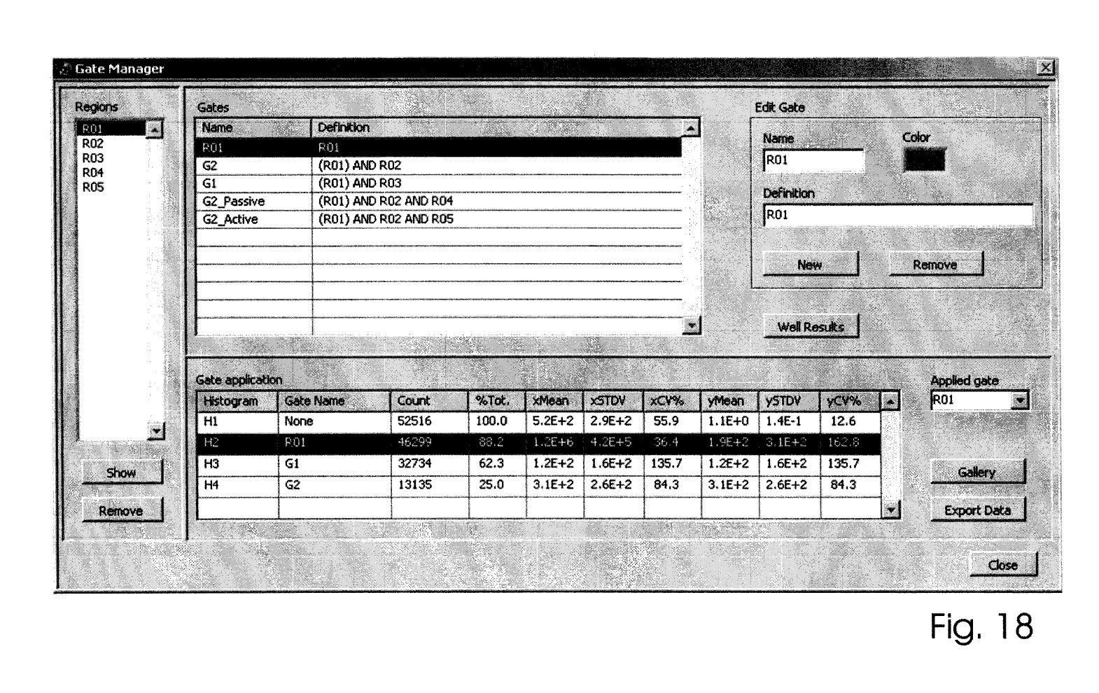

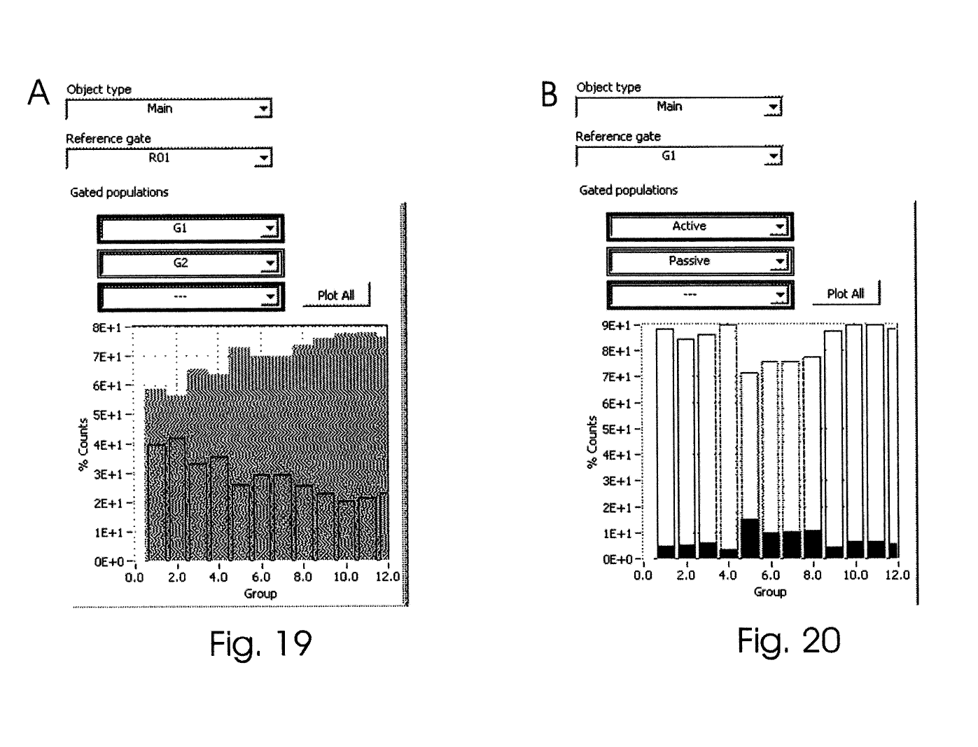

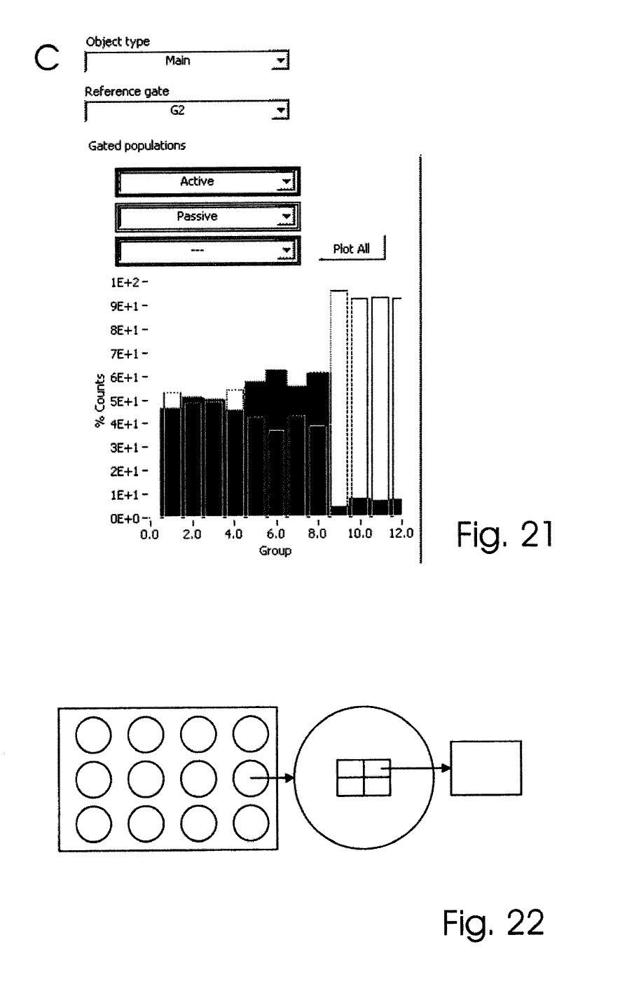

Once the classes (gates) are defined (cf. FIG. 14), the results for the individual samples (wells on the plate) can be extracted. In this example it is evident that the samples with higher well numbers exhibit a slightly reduced degree of division activity (less G2 in FIG. 19), that the active cells are largely found in the G2 phase (FIGS. 20 and 21) and that some samples (9 to 12) exhibit considerably less activation (FIG. 21). It is obviously also possible to extract mean values for features of individual classes for the respective samples.

The figures discussed all show screenshots of a user interface of the analysis and classification software. FIG. 12 shows the well region and positions in the well on a microtitre plate. FIG. 13 shows screenshots of object detection and segmentation, for example by applying thresholds. There are still nucleii present which are not well segmented.

FIG. 14 shows the user interface for defining parameters (features) which are measured on the mask obtained via segmentation. A large number of different features (approximately 100 different features) can be determined.

Referring to FIG. 15, it is possible to define a region R01 corresponding to a classifier in an interactive manner in the projection of the feature space on two coordinate axes representing area and circularity.

FIG. 16 shows an example of the projection of the dapi/repair marker feature space for defining regions R02 and R02 on the basis of the class of well segmented cell nucleii (R01). FIG. 17 shows the definition of active cell and passive cell classes on the basis of the repair marker (A: repair marker in G1, B: repair marker in G2). FIG. 18 shows the screen interface for defining classes using logical operators.

FIGS. 19 to 21 show the results of the classification process and thus the results of the analysis performed in this way. Specifically, FIG. 19 shows the percentages of the G1 and G2 classes in relation to class R01 in its entirety, FIG. 20 shows the percentages of active and passive classes in relation to class G1 in its entirety and FIG. 21 shows the percentages of active and passive classes in relation to class G2 in its entirety.

### 3. Cytometric Time-Lapse Analysis as Example for an Analysis and Classification Method According to the Invention

As in static microscopy, it is necessary in time-lapse analysis to obtain object information from image data. In this case, microscopy, particularly fluorescence microscopy, differs in principle from video tracking by the density of the image information (a comparatively large amount of non-specific background) and the generally lower frame-rate. It is thus possible to generate images of slow biological processes by repeating the experiment over an entire specimen plate or an individual well or images of rapid processes within a single position in a well (see FIG. 22).

### 3.1 Time-Lapse Analysis: Population Analysis

Even without associating the image data, it is possible to carry out a cytometric analysis on the basis of a population analysis, as it is known. As in the static process, the analysed objects are in this case obtained only from individual image frames and are then classified, as in static microscopy. The results of this classification process at each moment in time thus generate curve development profiles for each analysed sample and these curve development profiles can be subjected to a curve sketching process.

In this way, it is also possible to answer a large number of queries of interest. However the analysis is only a summary analysis of a total group of objects, without any consideration of the chronological development of individual objects, since there is no association of objects identified in images of the time-lapse series as representations of the same object. In contrast, the subject-matter of the invention is a time-lapse analysis process, as described below, carried out on the basis of associating object representations, identified in individual images of the time series by segmentation, of the same particular object, i.e. a tracking process, carried out in any manner, is required.

### 3.2 Time-Lapse Analysis: Tracking

In the tracking process, curve development profiles of features are generated for each individual object. The object representations, identified in the individual images of the time series by segmentation, are therefore associated with one another as representations of the same particular object. This enables a much larger amount of information to be obtained, since it enables individual objects to be analysed on a chronological basis. In this case, it is possible to use very simple methods. For example, it is sufficient in the case of geometrically static cells to obtain a mask from the first timeframe and to use this mask on all further timeframes. However, it is frequently also necessary to use algorithms which are more complex but known per se.

Tracking in the field of microscopy requires the use of some methods different to those used for video tracking, since information is only available in some parts of the image and it is thus more difficult to detect objects from the changes in said images (cf. for example EP 1 348 124 B1).

A distinction is generally made between two approaches:
1. Use of all the image information to obtain object data
2. Object detection carried out separately for individual frames with subsequent association in the feature space

Whatever the type of method used, a mask is obtained for each moment in time and each object, and this mask can be used, as in the static method, to determine features at that moment.

However, this can lead to gaps in the tracking process. If the conditions for object detection change over time, the tracking algorithm may not be able to correctly associate the object. It is also possible for objects to appear, disappear or merge or separate over time. In both cases, the tracking process creates partial object tracks which do not extend over the entire observation period. Information on the interrelationships between partial tracks of this type may be of particular interest and can be derived in principle from the tracking data.

### 3.3 Cytometric Time-Lapse Analysis of Tracking Data

The analysis of time-lapse data can be simplified considerably by applying cytometric analysis processes to the tracking data. In this case, the approach benefits from being able to identify classes without additional information and to remove undesired data points via the projections and by logically linking the regions. This also applies to static analysis.

In this case, individual object features are extracted in a first step from the curves obtained from the tracking process.

All the static features and temporary features obtained from the individual images may serve as a basis for the curve progressions (for example intensity, geometry, position) but dynamic features such as speed and direction of motion may also be used.

It is then possible to smooth or derive curves before the feature extraction process, or time periods can be applied (see FIG. 23 as an example of the definition of curve features). The final feature extraction process is then carried out on the basis of operators such as:

track length
mean
maximum/minimum
standard deviation
initial/final value
time of maximum/minimum
begin/end time
number of zero passages
number of local maxima/minima
or via the parameters of a curve fitting process.

Furthermore, it is possible to use regions defined from trigger points of the addition of liquid or other external events as features (cf. U.S. Pat. No. 5,332,905).

As in conventional imaging cytometry not carried out on the basis of chronological changes, it is subsequently possible to evaluate features in relation to one another.

Once the feature data have been obtained, they can be classified in the cytometric analysis process. This means that each track obtained via tracking forms a multidimensional data point in the feature space, on the projections of which regions are defined for the purposes of classification. If changing temporary features which can be taken in each case from individual images are also taken into account, the tracking produces a multidimensional track in the feature space on the basis of these features. In addition to being able to classify particularly meaningful dynamic features, it is also possible to classify static features and temporary features at a particular moment in time. It is therefore also possible to carry out a classification process, corresponding to conventional imaging cytometry, in relation to static features and/or changing temporary features at a particular moment in time.

### 4. Examples of Applications in the Field of Biology for the Cytometric Time-Lapse Analysis Process According to the Invention

General examples from the field of biology in which the proposed analysis and classification method may be applied in a particularly expedient manner are presented below.

The examples described below are taken from standard works of specialist biological literature. The examples given are known and described phenomena, some of which are explained at a molecular level. In typical screening tests, experiments of this type with good characterising capabilities are frequently used to search for unknown genes or substances which have an effect on the known process.

### 4.1 Example 1

### Ion Channels

Ion channels are essential for the life of all cells as they regulate the water balance and the interior cell environment. Furthermore, they play a central role in the conduction and processing of impulses in the nervous system. Defects in ion channels have a correspondingly dramatic effect on the organism and there are many diseases which can be traced back to defective ion channels. In this case, the “shaker” mutant in Drosophila fruit flies will be discussed instead of a human disease as it has been more comprehensively described and is better understood. These mutants exhibit highly uncoordinated movements. It has been found that this can be traced back to a defect in the potassium channel in nerve cells which causes the action potentials to exhibit a modified chronological progression profile. In this example, the fact that defective channels and healthy channels differ only in terms of the shape of the kinetic profile thereof is of particular relevance to the method presented in this document. There is hardly any difference in the maximum value or the duration of the action potential. The measurement shown in this case was carried out by electrophysiological methods. It was also possible to carry out measurements of this type using image-generating methods by means of suitable voltage-sensitive dyes and very fast cameras. Experiments of this type are of interest for screening applications, since it is possible, for example, to use mass batches to search for substances with which the abnormal change can be eliminated.

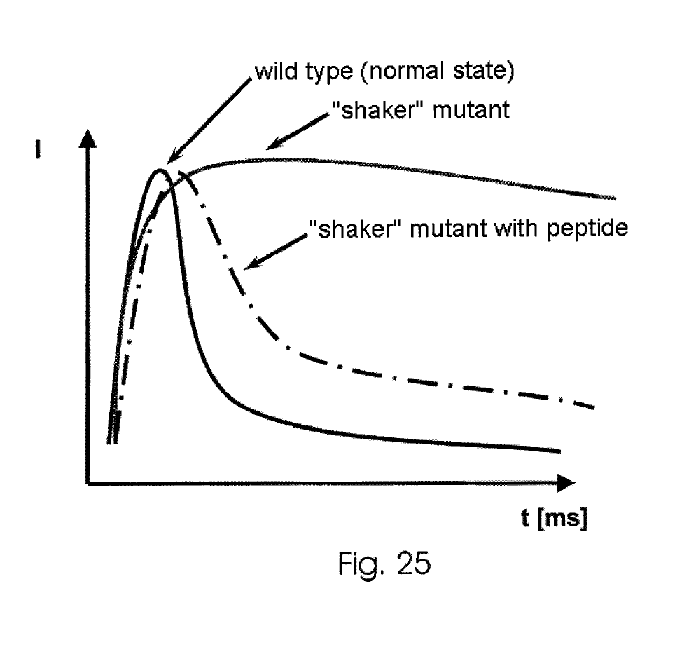

FIG. 24 shows the typical chronological development profile (kinetics) of the action potential in healthy fruit flies (“wild type”) and in the “shaker” mutants. The difference manifests itself almost exclusively in the curve shape rather than in the maximum value or the duration. The voltage measurement via the cell membrane using electrodes is used as a basis for the schematic measurement results, i.e. an image-generating method was not used. As shown in FIG. 25, the change in the channel characteristics of the mutant can be reversed to some extent by administering a synthetic peptide. An image-generating method was also not used for these measurements and instead the “patch-clamp method” was used, in which the current is measured via the membrane rather than the voltage. However, it is possible to carry out measurements corresponding to those shown in FIGS. 24 and 25 with image-generating methods, as discussed above. This would enable the corresponding measurements to be carried out simultaneously on a large number of nerve cells. On account of the variability of measurements in the field of biology, this would result in very unclear groups of samples in each case from a large number of individual curves which would be difficult to evaluate meaningfully with conventional methods. On the other hand, it would be possible to carry out a classification and analysis process on the time-lapse measurement results on the basis of the cytometric time-lapse analysis process according to the invention in order to answer queries of interest.

### 4.2 Example 2

### Calcium Signals in Muscle Cells

In this example, the calcium concentration in cultured muscle cells was measured using the fluorescent dye “fura-2” in image-generating methods. The dye “fura-2” changes its fluorescence properties as a function of the calcium concentration in the cell. Since the absolute signal intensity in these measurements is a function of the dye content of the cell and the cell volume and therefore varies extremely widely, the absolute intensity cannot be used for direct comparison. In the example, the change in the calcium concentration is demonstrated in two directly adjacent muscle cells and the reaction occurs completely differently in each case. One cell exhibits fast, rhythmic concentration changes of decreasing intensity, whereas the other cell exhibits a strong initial signal which decreases rapidly at first and subsequently decreases slowly. Any intermediate forms and further characteristic cell reactions may occur. The method presented in this document enables differences of this type in the curve development profile to be identified and classified rapidly, easily and clearly for any number of images. In this case, the following queries may be processed:

How many different reaction types are there?
How do they differ?
Which substances (drugs→drug screening) trigger which reactions?
Which substances are able to suppress the reactions?

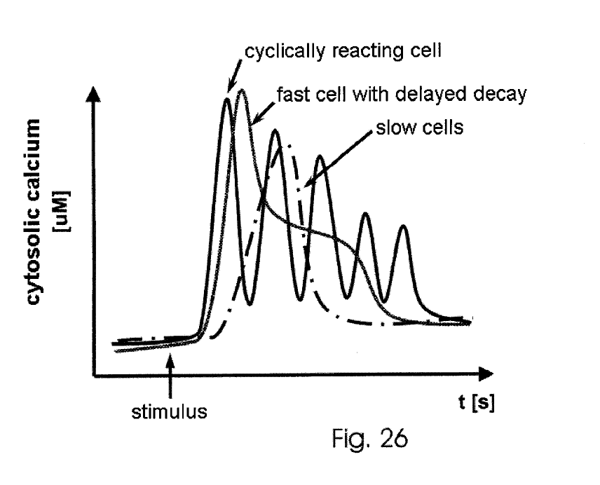

FIG. 26 shows the results of a calcium imaging process in muscle cells. This figure shows the schematic chronological development profile (kinetics) of the calcium signal in different muscle cells, measured using a fluorescent dye which changes its fluorescent properties as a function of the calcium concentration of the cell. The cells are morphologically identical. The total population contains cells with greatly differing reaction patterns. The difference manifests itself primarily in the curve shape rather than in the maximum value or duration. It is highly difficult to detect differences of this type meaningfully, and in particular quantitatively, with conventional evaluation methods. In contrast, the cytometric time-lapse analysis method according to the invention offers the possibility of detecting differences of this type not only qualitatively but also quantitatively and analysing said differences by multiple classification processes.

### 4.3 Example 3

### Protein Expression Pattern

The production (expression) of cellular proteins is highly regulated. In particular, proteins which are involved in cell division processes exhibit spatially and temporarily defined expression patterns. Changes in the expression patterns may indicate pathological processes, for example cancer. It is therefore extremely important to determine the emergence or presence of particular proteins in cells and also to identify the exact chronological development profile of the synthesis and decay processes.

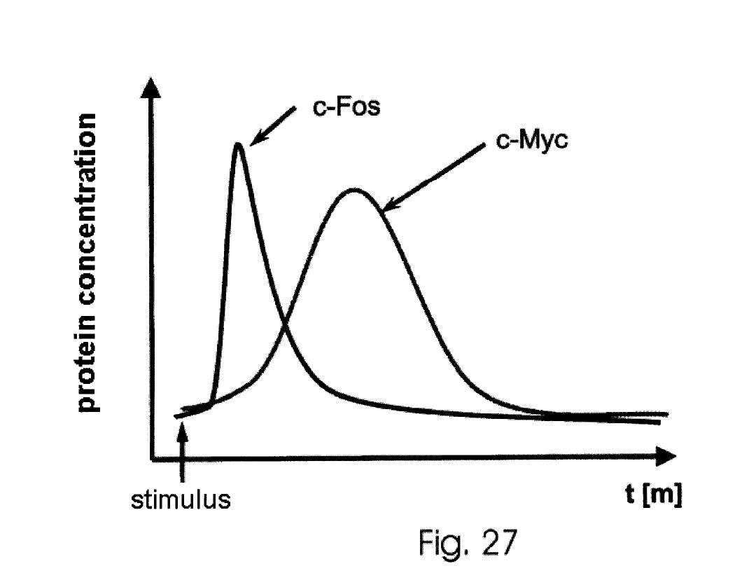

Corresponding protein expression patterns are shown schematically in FIG. 27. The figure shows the chronological development profile (kinetics) of the expression pattern of two regulatory proteins (proto-oncogenes) which are involved in the cell division process. The first gene product c-Fos is known as a viral oncogene (carcinogenic). In its cancer-associated form, c-Fos is no longer temporally regulated and does not exhibit the typical curve profile. If measurements of this type are carried out on a large number of cells, for example as part of a screening process, the cytometric time-lapse analysis process according to the invention enables kinetics of this type to be evaluated not only quantitatively, but also qualitatively, and also enables sub-populations of interest to be identified.

### 5. Specific Application Examples for the Cytometric Time-Lapse Analysis Method According to the Invention

Examples of application for the cytometric-time-lapse analysis method are explained in detail below. The examples of application were carried out using a scan̂R prototype.

### 5.1 Live-Cell Mitosis Analysis

Live cells exhibiting division activity are used in live-cell matrix analysis. Both a fluorescent cell marker (TxRed) and a pure cytoplasmic marker (GFP) are present. The cells exhibit strong division activity which makes the process of associating objects more difficult.

Pictures A and B in FIG. 28 show the same image detail and thus show the division activity of cells at different moments in time. The cell count and the position of cells differ greatly. This is typical of time-lapse experiments and places high demands on the processes of object detection and tracking over time.

1. Segmentation

The objects are segmented in a first step. This is carried out in the more powerful channel (TxRed) (see FIG. 29). Simple threshold detection is used in this example which illustrates segmentation in a single timeframe. The object detection process is still incomplete and can be improved by additional image processing procedures.

2. Identifying the Stationary and Temporary Features as Examples of “First Features”

In the next step, the features to be measured on each timeframe and for each object are identified. A list of the features to be measured in each image of the time series (static/stationary features or temporary features) is shown in FIG. 30, which is a corresponding screenshot of the user interface.

In this way, a data point is produced for each object and each moment in time in the feature space after analysis of all the images. FIGS. 31 to 36 show different views of said feature space.

The process of analysing all the images is thus a time-consuming step since it is necessary to perform calculations based on the considerable amount of image data.

The different views of the feature space of the stationary or temporary features, i.e. all the features which can be derived directly or indirectly from an individual image, show the following: FIG. 31 shows a gallery of passive cells and FIG. 32 shows a gallery of active cells and each of the two figures shows one of two point clouds which can already be differentiated in a colour representation of the histogram in FIG. 34 despite relatively small differences in intensity, namely GFP-active cells (FIG. 32) and GFP-passive cells (FIG. 31). The histogram in FIG. 34 shows mean intensity against area and it is possible to distinguish between the two aforementioned clusters (active and passive; point cloud of passive cells on the left in FIG. 34 and point cloud of active cells on the right in FIG. 34) in the screenshots shown in FIG. 34.

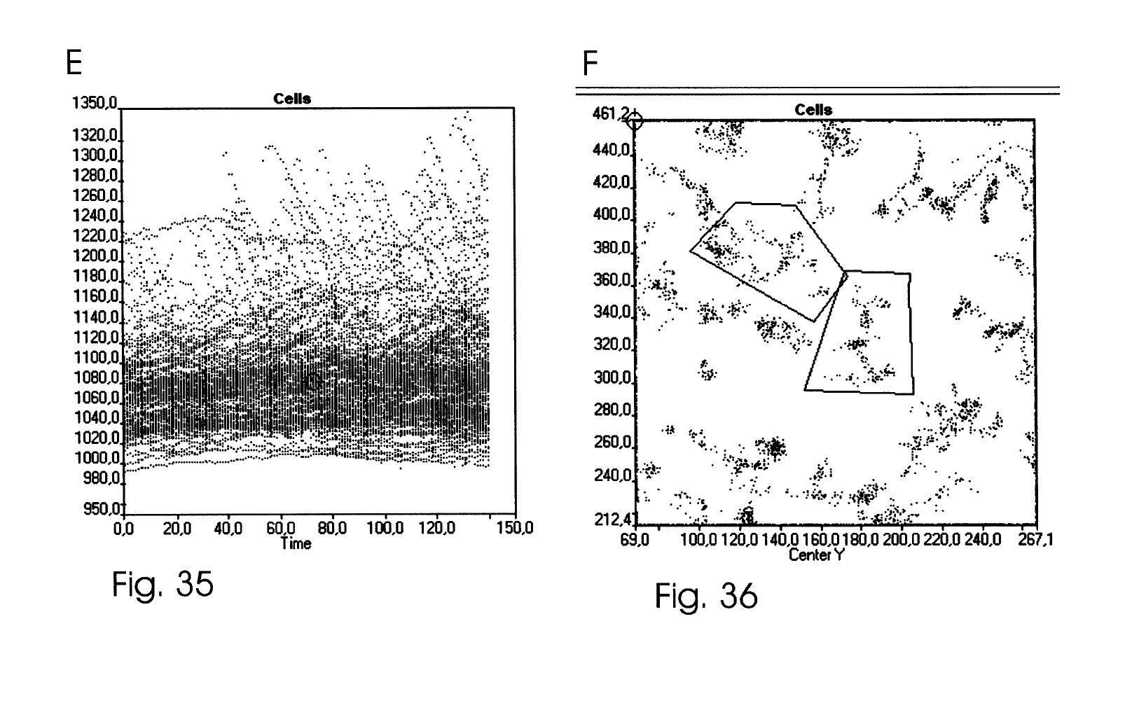

FIG. 33 shows a possible classification of correctly segmented cells by circularity and area. FIG. 35 shows time against mean GFP intensity in the population analysis. The X, Y image position of detected objects is shown in FIG. 36.

3. Identification of Kinetic Features as Examples of “Second Features”

It is now possible to define the tracking (associating objects) and extraction of kinetic features. The actual association process for producing curves is in this case carried out automatically by an algorithm which uses the proximity of the locations as a basis for association. FIGS. 37 and 38 show an example of a cell and its motion track. FIG. 37 shows a histogram which plots the length of the curve course (lifetime) against a parameter quantifying the deviation in area in the curve profile. A crosshair cursor marks the object just selected in the feature space which is displayed, with the segmentation thereof, in FIG. 38. This is an image belonging to the last point in the curve. In a colour diagram, the course of movement of the object over the entire time period recorded, i.e. the spatial track (location track) of the cell, is shown in addition to the selected cell, as a colour-coded line on the object.

FIG. 39 shows the user interface for selecting the kinetic features extracted from curves. In this way, the kinetic feature space is defined. Some of these features are not used for the final results but serve only to enable the assay to develop in an improved manner and to see whether certain feature combinations form clusters enabling conclusions to be drawn on the biology or function of the algorithms.

The following should be noted in regard to the definition interface shown in FIG. 39 for kinetic features and thus in regard to the kinetic feature space.

The kinetic features hidden by the scroll bar are: Min(MeanIntensity(GFP)) and Max(MeanIntensity(GFP)), which relate to the minimum and maximum GFP intensities in the course of the curve.

Examples of features which may be selected are as follows:

| | |
|---|---|
| First(MeanIntensity(GFP)) | First GFP intensity value in the course of the curve |
| mean(MeanIntensity(GFP)) | Mean GFP intensity value over the entire course of the curve |
| mean(Area) | Mean object area value over the entire course of the curve |
| Min(speedofmotionX) | Minimum speed in X-direction over the entire course of the curve |
| Max(speedofmotionX) | Maximum speed in the X-direction over the entire course of the curve |
| t_max(MeanIntensity(GFP)) | Time of maximum GFP intensity over the course of the curve |
| lifetime | Entire length of a curve. This is affected by the power of the |
| | tracking algorithm or by biological reasons (disappearance of |
| | the object) |
| Max(Der(Area)) | Maximum derivative value of the course of the curve. The curve is |
| | typically smoothed before the derivative is calculated. |
| Max(Area) | Maximum area value over the entire course of the curve |
| Min(Area) | Minimum area value over the entire course of the curve |
| Min(MeanIntensity(GFP)) | Minimum GFP intensities over the course of the curve |
| Max(MeanIntensity(GFP)) | Maximum GFP intensities over the course of the curve |

It is also possible to define derived kinetic features (derived “second features”) which are not obtained from a particular curve but are instead obtained from other kinetic features. FIG. 40 shows the corresponding user interface. The parameters for these features are not obtained from a curve but result for example from other kinetic features on the basis of a mathematical formula. One example of this is the kinetic feature MaxMinAreaRatio. This is a derived feature which is obtained via parameter numbers P8 and P9 and corresponds to the ratio of the maximum area (Max(Area)) and the minimum area (Min(Area)), i.e. MaxMinAreaRatio=P8/P9=Max(Area)/Min(Area). A derived kinetic feature of this type may be used for example as a kinetic parameter for the extent of the derivatives of the area over the course of the curve. A value of 1 for this feature would represent no change and would increase for greater derivatives of the area.

4. Cytometric Classification.

It is now possible to classify the kinetic feature data thus obtained in a plurality of steps. A crucial step in this case is the process of sorting objects into a usable class since both the segmentation and cell tracking processes are prone to errors on account of the high cell density and division activity.

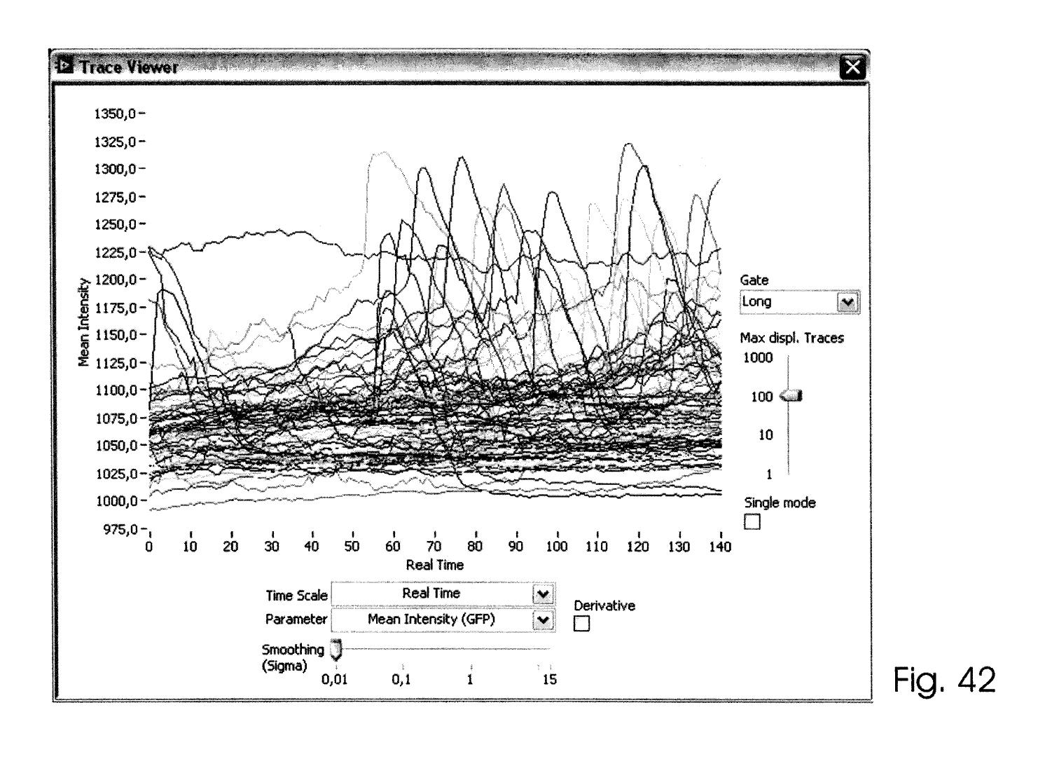

In this example application, the cells monitored over a sufficient time period are initially defined, using the feature “lifetime” which indicates the length of a particular track. FIG. 41 shows the definition of the “long” class which corresponds to cells with a long track representing a long lifetime of the time period R01. This region is defined as the one-sided interval [R01. The family of longer curves or this class of cells tracked for a longer period of time is defined by this region R01 as a “long” gate in a “gate manager”, as it is known, in the one-dimensional histogram shown in FIG. 41. FIG. 42 shows a sub-set of the curves corresponding to this “long” class=R01 by imaging the curve profile of the GFP intensity over time. The figure shows curves exhibiting the characteristic mitosis peak as well as curves without a peak of this type.

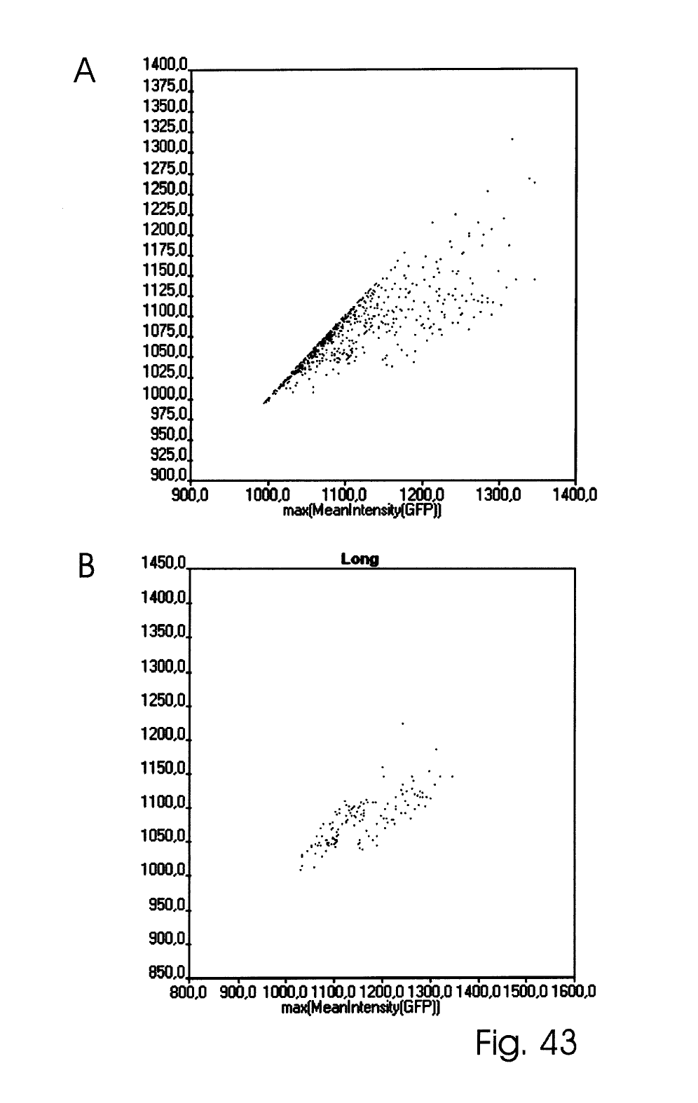

By defining this class, it is now possible to identify clusters clearly on a further histogram. Diagram A of FIG. 43 is a histogram showing the mean intensity (y) against the maximum intensity (x) for all the objects and diagram B is a histogram showing the mean intensity (y) against the maximum intensity (x) only for objects belonging to the “long” class.

In this case, it is only possible to identify a clear separation of the objects into two clusters in the long class. This can be used in turn to define two regions which separate mitotic (dividing) cells from non-mitotic cells.

Since both clusters are distributed obliquely in the projection diagram, it is clear that one of the two kinetic features used for classification was not sufficient.

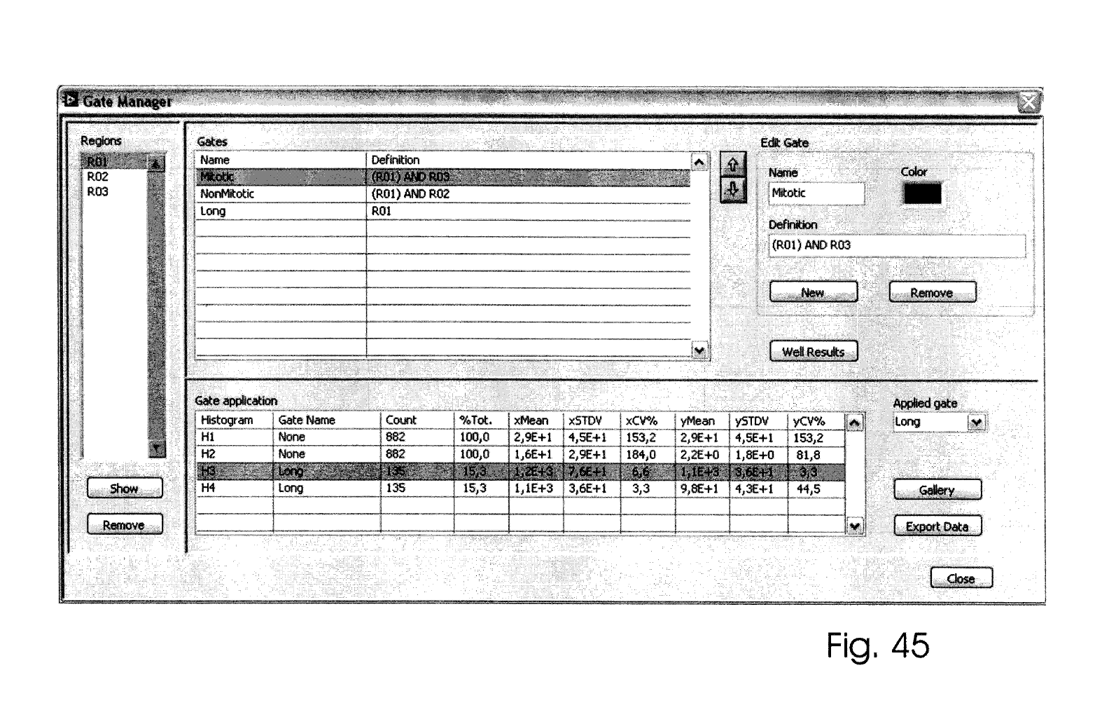

In diagram B of FIG. 43, it is thus possible to define the classes R02 and R03 which correspond to the class of mitotic (dividing) cells and the class of non-mitotic cells, cf. FIG. 44. FIG. 45 shows the definition of these classes from the regions in the gate manager (classifier manager). The two classes mentioned are each defined with the “long” class by logically linking (“AND”) the regions (R02, R03) shown in the diagram of FIG. 44.

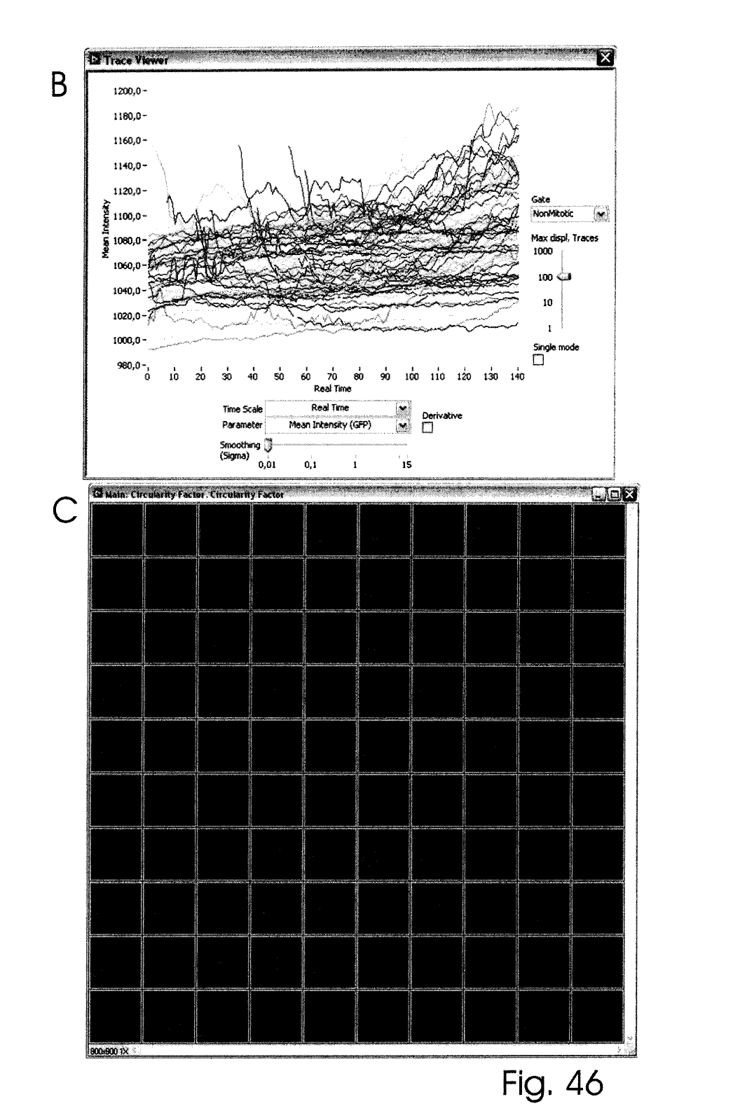

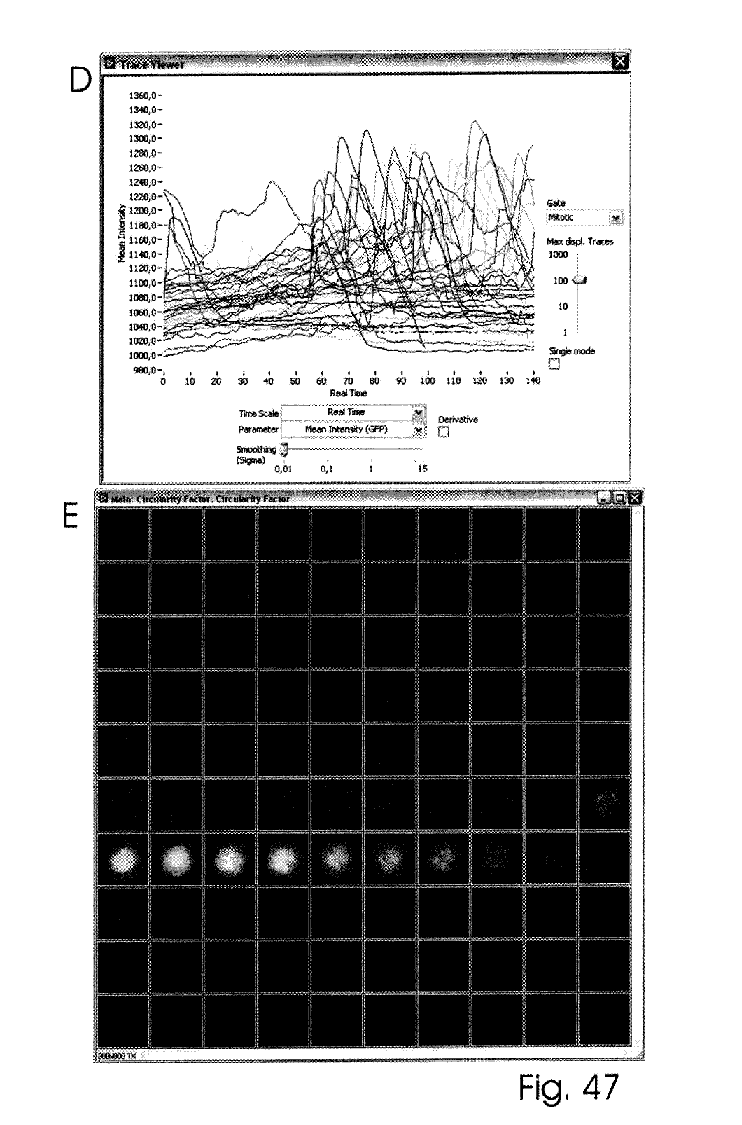

The intensity profiles and the gallery of cell images for the class of non-mitotic cells are shown in FIG. 46 and the intensity profiles and gallery of cell images for the class of mitotic cells are shown in FIG. 47. An increase in GFP intensity which occurs during mitosis is shown clearly in the intensity profile and also in the cell images of the mitotic cells.

This therefore shows an example of the process of classifying cells into mitotic and non-mitotic classes. The figures show how two clusters in a sub-space of the feature space can be identified by using a gate or classifier (“long”). FIG. 44 shows how the definition process can be carried out by dividing the feature space of the maximum against the minimum GFP intensity into regions. Diagram B of FIG. 46 shows, in relation to the classifier R02, a family of curves belonging to R02 in the “long” class, and the image gallery C of FIG. 46 shows time-lapse images of a cell from this family. Since there are no characteristic mitosis peaks, this cell is a non-mitotic cell. In contrast, the class of mitotic cells is shown in the family of curves in diagram of D of FIG. 47 and one cell from this class is shown in the image gallery E of FIG. 47. The mitosis peaks are evident not only in the family of curves, but also in the images of the cell.

In other situations, it is also possible to logically link the data to form different classes in order to subdivide the cells further.

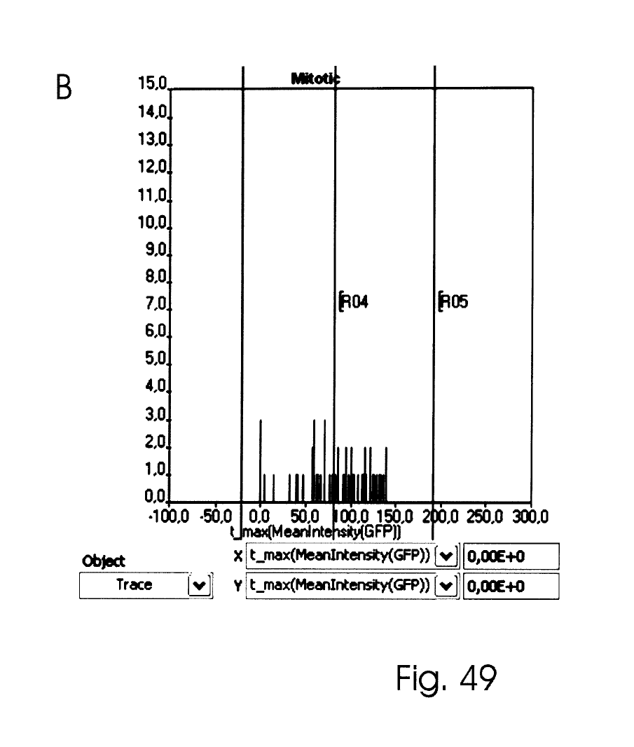

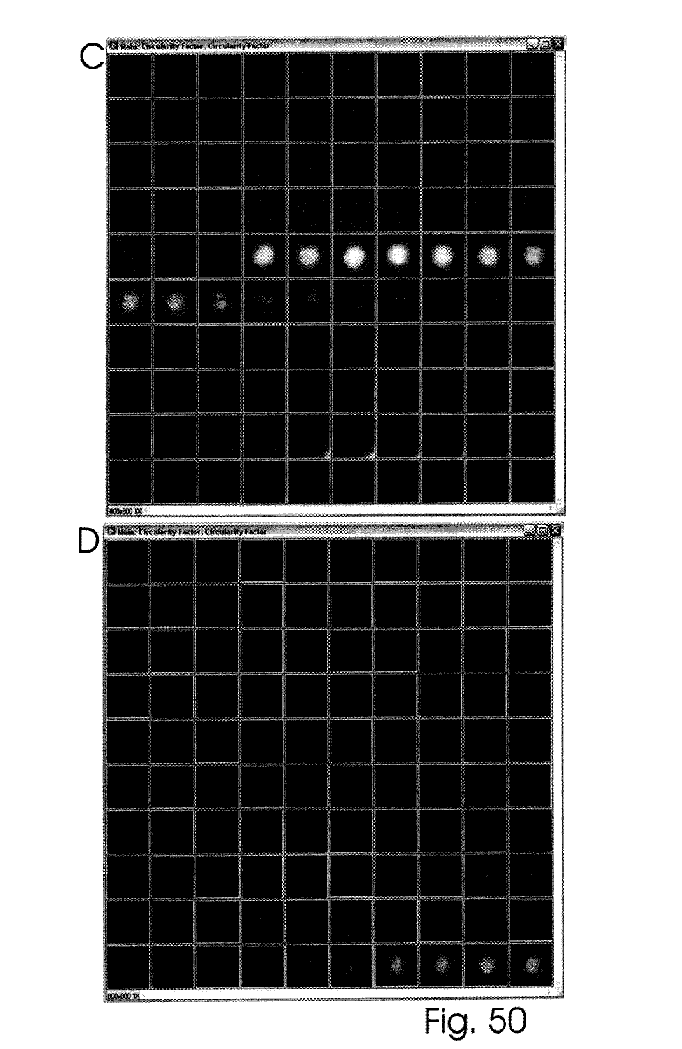

A further possibility for classifying the data is classification into early and late mitosis classes (see FIGS. 48 to 50). The mitosis class is divided into early and late mitosis by using the time of maximum intensity. These sub-classes (cells exhibiting early mitosis and cells exhibiting late mitosis) are defined in the gate manager shown in FIG. 48 by linking the regions R04 and R05 shown in the histogram in FIG. 49. The histogram shows the object frequency for the times of maximum GFP intensity for the class of mitotic cells. The image gallery C in FIG. 50 shows series of images over time for early mitosis (region R04) and image gallery D shows series of images for late mitosis (region R05) for a particular example cell from each of the additionally defined classes.

5. Results

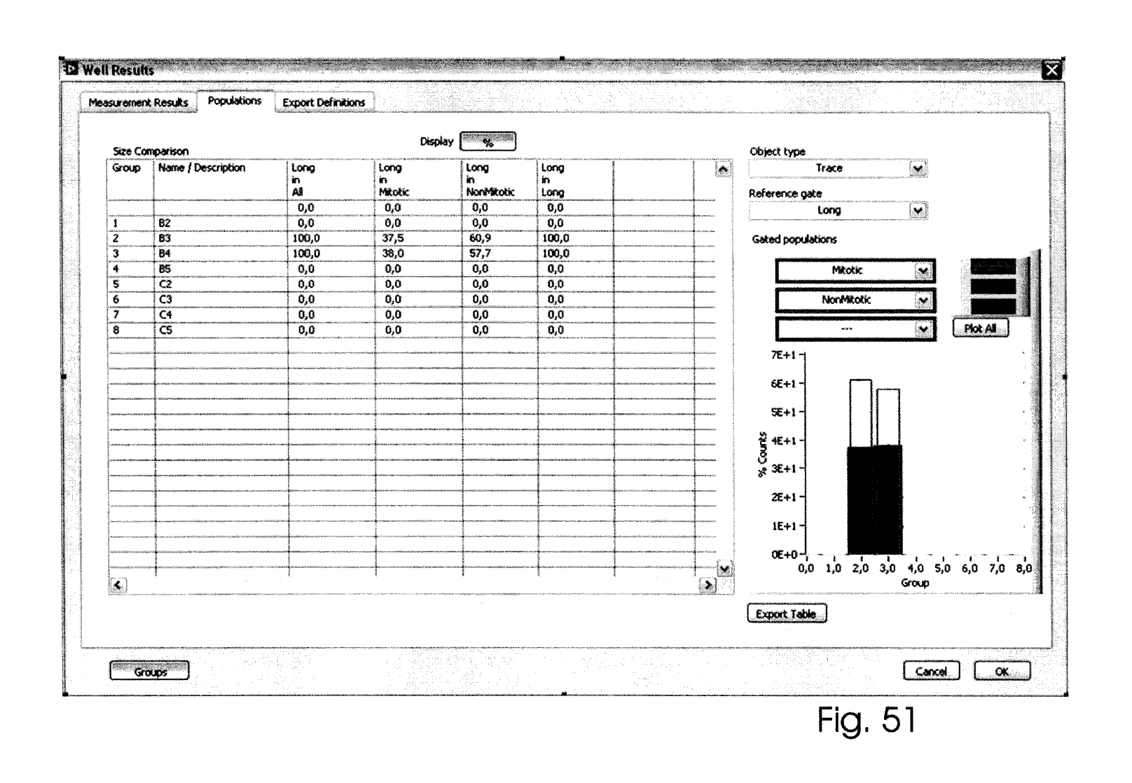

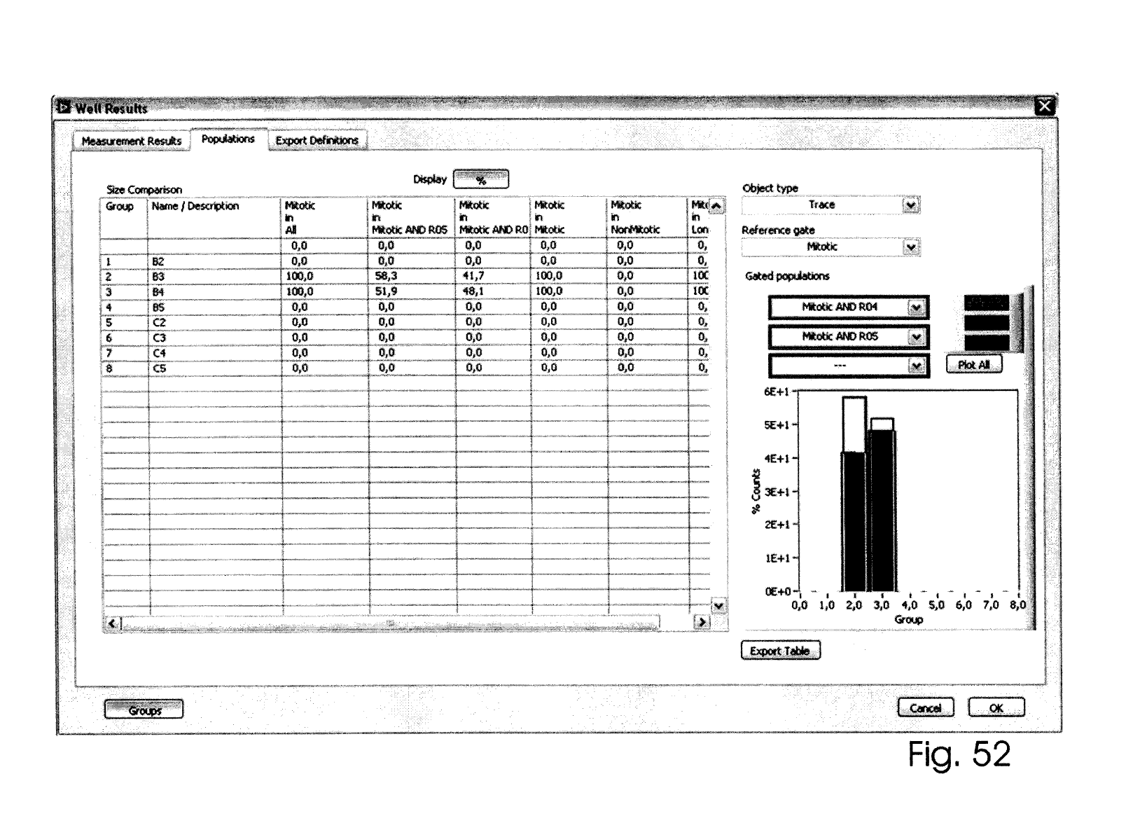

By defining the classes, it is now possible to produce percentages for particular kinetic classes (see FIGS. 51 and 52). For this purpose, the statistical basic class must be specified (for example mitotic or long).

It is now also possible to determine statistics (for example, mean values) of kinetic features of the respective classes.

FIG. 51 shows the user interface for outputting sample results to obtain the percentage of mitotic/non-mitotic cells in the two samples B3 and B4. The percentages of the classes are displayed for each sample in relation to the statistical basic set “long”. Cells were only actually found in two wells (B3 and B4), corresponding to groups 2 and 3. The ratio of late and early mitosis in the two samples is shown in the user interface in FIG. 52. The percentage of classes in relation to the statistical basic set “mitotic” is shown as the sample result for each sample. Cells were only actually found in the two wells B3 and B4 (corresponding to groups 2 and 3).

### 5.2 Further Example Scenarios

In some tests, a process of interest can be quantified by determining the change in a quotient of the fluorescent intensity of two fluorophores. For example, fluorophores activated by a flash of UV light may be used, images of a time-series being recorded following the flash. The advantage of evaluation carried out on the basis of an intensity quotient of this type is that it is possible to perform measurements on cells moving in three dimensions and in different positions relative to a focal plane, for which absolute intensity does not represent a meaningful measurement parameter to determine a process of interest.

It is also possible to use a curve fitting process when analysing the kinetics, for example fitting the data to a linear or exponential or other curve profile. It is possible to use kinetic features which are more abstract than the actual kinetics as kinetic features serving as a basis for the curve fitting process, namely for example the fitting parameters and the fitting errors, for example mean standard errors (MSE) of the curve fit, so that classification can be carried out for example on the basis of a linear curve profile on the one hand and an exponential curve profile on the other and also that further classification could also be carried out on the basis of different fitting error classes.

It is therefore also possible to carry out classification on the basis of fitting errors (for example MSE), for example to select cells or curves characterised by a small fitting error in relation to the underlying fitting function. It is also possible, for example, for different classes to be found in one or more fitting parameters. For example, a class of individual cases which differ from other individual cases by a considerably greater exponential factor may be found in the case of exponential curve fitting.

In the case of the aforementioned quotients of fluorescence intensity, it is possible for two groups to be found upon classification, one of these groups being characterised by a strong decrease in the quotient and the other being characterised by a slight decrease in the quotient.

It would be necessary to check whether all of these cells were photoactivated to the same extent. An error could result from the fact that not all of the cells were located within the focus region of the objective, via which photoactivation can expediently take place, at the time of photoactivation. In order to rule out these errors, classification could additionally be carried out on the basis of the intensity of one of the fluorophores at the time of photoactivation (t=0) so as to include only the cells which were photoactivated in the same manner. It is thus possible to form a class of cells which can serve as a basis for “clean” quantification of the process of interest. For example, mean values for the linear regression of the intensity quotient can be determined on the basis of a class of this type to determine the activity of interest, for example protein degradation, as a function of specific environmental factors.

These are only a few ideas for possible experiments and possible expedient evaluation applications on the basis of the proposals of the invention carried out by classification processes performed in multiple stages, specifically on the basis of kinetic features, including abstract kinetic features such as fitting parameters and fitting error variables. The person skilled in the art will be able to conceive of many other experiments with cells for which the analysis and classification method according to the invention can expediently be used.

### 6. Time-Lapse Analysis Limiting Curve Sketching to Key Regions

In the example given in section 5.1 above, the entire length of the curves resulting from the chronological development of cell features was used for the purposes of analysis and feature extraction. This is expedient when the curve as a whole is examined and the global characteristics thereof are to be determined. An example of this was also given in section 5.2, in which classification according to linear or exponential curves was mentioned by way of example.

However, the entire curve is not always of interest and frequently only a partial time period thereof is of interest, during which for example a process is externally triggered (for example pipetting) or the examined object exhibits specific behaviour.

The function described below represents a highly beneficial development of the analysis options, since this function enables the curve analysis to be limited to particular regions of interest on said curve.

For this purpose, the entire curve is initially subjected to curve analysis and then a characteristic point on the curve is determined. A time window is subsequently determined and the actual curve analysis process is carried out within said time window around the aforementioned point.

The advantages of this approach are evident from the following:

A typical biological curve is shown in FIG. 53.

“Nothing” of interest takes place in regions A and C, which only show background noise, and an effect is only observed in region B. The time t-max is generally highly variable in biological samples and it is therefore not possible to set a fixed time to carry out a local curve analysis. It is necessary to carry out the local curve analysis process relative to the absolute timescale, since each curve has a different t-max time, which is not shown in FIG. 53 for the purposes of simplification. If the entire curve is evaluated, for example for the decay constant thereof, an incorrect result is obtained (f(lin−global) (linear fit to the entire curve profile from the maximum point thereof), f(exp−global)) (exponential fit to the entire curve profile from the maximum point thereof). A more accurate value (f(exp−local)) (exponential fit to the limited curve profile from the maximum point thereof) is only obtained when the analysis region is limited (tmax−B/C boundary) to the actual region of interest.

### 6.1 Definition of the Partial Time Periods

FIG. 54 shows an example of the process of limiting the analysis to the curve between t=50 and t=100. The partial time period or region of interest (ROI) thus defined may relate either to an absolute moment in time or be defined relative to the particular curve.

6.1.1 ROI with an Absolute Timescale

When using the absolute timescale, the ROIs relate to an absolute moment in time, for example the time the first image was recorded or the time of an external event (for example pipetting). For the analysis process, all the curves are cut in accordance with the ROI, and only the part falling within the ROI is analysed.

FIG. 55 shows an example of the process of limiting the analysis to the course of the curve after t=40 on the absolute timescale.

### 6.1.2 Relative Timescales

If there are events in the course of the curve which are to be analysed and they occur at different times in each cell (for example mitosis, see above), a relative ROI is defined which relates to a time specific to the particular curve. In this way, parts of the curve profile can be analysed in isolation, even when the analysed event occurs at different times.

FIG. 56 shows the intensity curve for different mitotic cells on an absolute timescale. In contrast, FIG. 57 shows the intensity curve over time for mitotic cells on a relative timescale, in which the time t=0 corresponds to the time the intensity curve reaches its maximum.

FIG. 58 shows the user interface with which a relative, curve-specific time, in this case the time of the maximum, can be defined. With a relative time t=0 of this type, it is then possible to define a relative region of interest ROI which comprises for example, as shown in FIG. 59, the last five time-steps before the peak, i.e. the last five time-steps before the time t=0 of the curve peak, as defined above. In contrast, FIG. 60 shows the definition of a relative ROI comprising the first fifteen time-steps after the peak, i.e. after the time t=0, the time the curve reaches its maximum point.

### 6.2 Example Application: Live Cell Mitosis Analysis

On account of the DNA duplication taking place, cell division produces a characteristic peak in the GFP intensity measured. In this case, the mean gradient in the ascent to the peak and the mean gradient in the decay from the peak is to be determined using relative ROIs.

FIG. 61 shows the definition of the intensity curve maximum (peak) as the reference time t=0. As shown in FIG. 62, a kinetic feature in the form of the mean gradient in a region of, for example, five time-steps in length, before the peak at t=0 is defined and has a specific value for the curve in question. It is possible to define a corresponding operator which can be applied to all the relevant curves and produces the relevant gradient. In a corresponding manner, it is possible to determine the mean gradient in a region of, for example, fifteen time-steps in length after the maximum point of the curve, i.e. the peak at t=0, and to define a corresponding operator which specifies the particular gradient for a respective curve, as shown in FIG. 63. FIG. 64 is a histogram showing the mean gradient of the ascent to the peak against the mean gradient of the fall from the peak. Due to the lack of a large number of individual cases represented by a point, it is not yet possible to clearly identify sub-populations (clusters). If a very large number of individual cases or intensity curves of mitotic cells were classified, it would be possible to identify different clusters in a histogram of this type and it would also be possible to define classifiers in relation to these clusters in order to refine the analysis further.

### 7. Closing Comments

In the text above, non-limiting examples for the implementation of the proposals according to the invention have been given and some possible applications of the multi-stage classification process according to the invention or the classification and analysis process according to the invention have been identified as non-limiting example applications. Classification systems or classification and analysis systems according to the invention can be provided on the basis of object examination devices known in the prior art, for example the systems provided by Olympus discussed above. The invention may in particular be embodied in the form of evaluation software which for example turns a conventional system into a system according to the invention.

Among the proposals provided is a method for the analysis and classification of objects of interest, for example biological or biochemical objects, on the basis of time-lapse images, for example for use in time-lapse or time-series analysis in image-base cytometry. Images of the objects of interest, for example cells, are recorded at different moments in time and these images are subjected to a segmentation process to identify image elements as object representations or sub-object representations of objects or sub-objects of interest of objects of interest. Identified object representations or sub-object representations are then associated with one another in images of the time series and are identified as representations of the same object or sub-object or as the result of an object or sub-object. First features manifesting themselves in individual images are detected and second features manifesting themselves in a plurality of images recorded at different times are detected. The individual objects or sub-objects identified in the digital images of the series are classified on the basis of at least one classifier relating to at least one second feature, and this classification process is used as the basis for or part of a further analysis process in relation to at least one query of interest. The further analysis process or the aforementioned classification process together with the further analysis process may be carried out by simultaneously or successively applying a plurality of classifiers, at least one of which relates to at least one second feature. It is primarily intended that a simultaneous or successive classification process is carried out using a plurality of classifiers relating directly or indirectly to at least one second feature. However, at least one classifier which relates to at least one first feature may also expediently be used. The proposals of the invention enable a cytometric time-lapse or time-series analysis to be carried out in relation to the behaviour over time of a plurality of objects.

A connection with, and simultaneously, a distinction from the cytometric time-lapse or time-series analysis achieved on the basis of the proposal of the invention from conventional cytometric analysis or classification results from the fact that cytometric classification only functions with individual values which can be represented as a point in a parameter space or feature space. However, a time-lapse experiment does not produce individual values but a table of values which can be represented as a curve. It is not possible to carry out conventional cytometric analysis on curves of this type. In order to make it possible for cytometric analysis to be carried out on time measurements, it is necessary to reduce curves of this type to individual characteristic values or to represent curves of this type with individual characteristic values. This has been made possible within the scope or by the proposals of the invention. Sets of individual parameters are extracted from the curves and these individual parameters characterise the curves. It is possible to apply cytometric methods known per se to these individual values to search for populations and sub-populations which differ from another in terms of kinetic parameters (properties) and which can be classified according to the invention. This has been made possible for the first time on the basis of the teaching according to the invention.

1. Method for analysing and classifying objects of interest, for example biological or biochemical objects, on the basis of time-lapse images of at least one group of objects of interest, for example for use for cytometric cell analysis, specifically time-lapse or time-series analysis, in image-based cytometry, comprising:
A) optically and electronically recording and electronically storing a plurality of digital images of the group of objects of interest located in an object region of an optical object examination device, the plurality of digital images comprising at least one series of digital images of the group of objects of interest recorded at different moments in time;
B) subjecting at least the series of digital images, recorded at different moments in time, of the plurality of digital images to a digital image processing process for the purposes of segmentation comprising at least one of i) identifying image elements as object representations of individual objects of interest of the group of objects of interest and ii) identifying image elements as sub-object representations of individual sub-objects of the particular objects of interest of the group of objects of interest, and electronically storing segmentation data representing these segmentation and identification processes;
C) at least on the basis of the segmentation data:
associating identified object representations or sub-object representations in digital images of the series recorded at chronologically successive moments for identifying, as a representation, the same object or sub-object or for identifying, as representations, objects or sub-objects in a source-result relationship, and electronically storing these association data representing this association process and thus the identification process;
D) at least on the basis of the segmentation data or the segmentation data and the association data and/or image content data, identified via the segmentation data or the segmentation data and the association data, from the digital images of the series:
detecting first features, manifesting themselves directly or indirectly in an individual digital image of the series, of individual objects or sub-objects identified in the digital images of the series by segmentation or by segmentation and association, at least for a plurality of digital images of the series recorded at different moments in time, and electronically storing at least one first feature data set representing these features;
E) at least on the basis of the association data or the association data and segmentation data and/or image content data, identified via the association data or the association data and the segmentation data, of the digital images of the series and/or first feature data of the first feature data set:
detecting second features, manifesting themselves directly or indirectly as differences between a plurality of the digital images of the series, of individual objects or sub-objects identified in the digital images of the series by segmentation and association, at least for a plurality of digital images of the series recorded at different moments in time, and electronically storing at least one second feature data set representing these second features;
F) defining at least one second classifier which relates to at least one second feature and can be applied to second feature data of the second feature data set in such a way that an individual object or sub-object, identified in the digital images of the series by association, belongs to a second class associated with the classifier if the second feature data, associated with said object or sub-object, of the second data set satisfy at least one second classification condition representing classification in relation to the at least one second feature, and electronically storing second classifier data representing the second classifier with the second classification condition;
G) classification by applying at least one defined second classifier to the second feature data set for determining individual objects or sub-objects which are identified in the digital images of the series by association and which belong to the second class associated with the second classifier applied or belong to a plurality of second classes each associated with one of the second classifiers applied; and
H) analysing the data, associated with the objects or sub-objects belonging to the second class or classes after said classification process, from at least one of i) the association data, ii) the segmentation data, iii) the image content data, identified via at least one of the association data and segmentation data, of the digital images of the series, iv) first feature data of the first feature data set and v) second feature data of the second feature data set in relation to at least one query of interest.

2. Analysis and classification method according to claim 1, comprising, prior to the association process according to step C):
D1) at least on the basis of the segmentation data and/or image content data, identified via the segmentation data, from the digital images of the series:
detecting first features, manifesting themselves directly or indirectly in an individual digital image of the series, of individual objects or sub-objects identified in the digital images of the series by segmentation, at least for a plurality of digital images of the series recorded at different moments in time, and electronically storing at least one first feature data set representing these features.

3. Analysis and classification method according to claim 1, comprising:
F1) defining at least one first classifier which relates to at least one first feature and can be applied to first feature data of the first feature data set in such a way that an individual object or sub-object, identified in the digital images of the series by segmentation or by segmentation and association, belongs to a first class associated with the classifier if the first feature data, associated with said object or sub-object, of the first feature data set satisfy at least one first classification condition representing classification in relation to the at least one first feature, and electronically storing first classifier data representing the first classifier with the first classification condition; and
G1) classification by applying at least one defined first classifier to the first feature data set for determining individual objects or sub-objects which are identified in the digital images of the series by segmentation or by segmentation and association and which belong to the first class associated with the first classifier applied or belong to a plurality of first classes, each associated with one of the first classifiers applied.

4. Analysis and classification method according to claim 3, comprising:
H1) analysing the data, associated with the objects or sub-objects belonging to the first class or classes after at least one classification process according to step G1), from at least one of i) the association data, ii) the segmentation data, iii) the image content data, identified via at least one of the association data and segmentation data, of the digital images of the series, iv) first feature data of the first feature data set and v) second feature data of the second feature data set in relation to at least one query of interest.

5. Analysis and classification method according to claim 3, comprising:
G2) classification by applying at least one defined first classifier to the first feature data set and at least one defined second classifier to the second feature data set for determining individual objects or sub-objects which are identified in the digital images of the series by association and which belong to the classes associated with the classifiers applied.

6. Analysis and classification method according to claim 5, comprising:
H2) analysing the data, associated with the objects or sub-objects belonging to the at least one first class and the at least one second class after at least one classification process according to step G2), from at least one of i) the association data, ii) the segmentation data, iii) the image content data, identified via at least one of the association data and segmentation data, of the digital images of the series, iv) first feature data of the first feature data set and v) second feature data of the second feature data set in relation to at least one query of interest.

7. Analysis and classification method according to claim 1 6, characterised in that the analysis process according to step H) or step H1) or step H2) comprises at least one further classification process according to step G) or step G1) or step G2).

8. Method according to claim 7, characterised in that the classification process according to step G) and the at least one further classification process according to step G) or step G1) or step G2) performed in the analysis process according to step H) are carried out simultaneously as a multiple classification process.

9. Analysis and classification method according to claim 7, characterised in that, for the purposes of analysis or classification and analysis, a sequence of classification processes according to step G) and/or step G1) and/or G2) is carried out simultaneously or in a chain in order to identify the objects or sub-objects which, according to the first or second feature data thereof which are detected in relation to the first and/or second features thereof and are understood to be coordinates in a multidimensional feature space spanned by the first and second features, lie in a particular feature space region selected by the first or second classifiers applied.

10. Analysis and classification method according to claim 1, characterised in that, in relation to at least one chronological development of at least one first feature, at least one time period of interest, corresponding to a sub-series of the series of images, is selected semi-automatically or fully automatically or interactively, and at least one second feature is detected on the basis of the chronological development in the time period and/or images of interest in the sub-series, and is stored as the second feature of the second feature data set.

11. Analysis and classification method according to claim 10, characterised in that at least one time period is determined or selected in such a way that the time period comprises a time interval following the moment in time when an action was performed on the objects.

12. Analysis and classification method according to claim 10, characterised in that at least one time period is determined or selected in such a way that the time period comprises a time interval following the moment in time when an event occurs for a particular object or for the objects.

13. Analysis and classification method according to claim 10, characterised in that at least one time period of interest is determined or selected in relation to a plurality or all of the individual objects or sub-objects identified in the digital images of the series by association on an absolute timescale associated with all of said objects.

14. Analysis and classification method according to claim 10, characterised in that at least one time period of interest is determined or selected in relation to at least one individual object or sub-object identified in the digital images of this series by association on a relative timescale associated with this individual object.

15. Analysis and classification method according to claim 10, characterised in that at least one second classifier, which relates to at least one second feature detected on the basis of the chronological development in the time period of interest and/or the images of interest in the sub-series, is defined and applied for classification.

16. Analysis and classification method according to claim 1, characterised in that the second features may comprise kinetics or dynamic behaviour or a change between the recording times of the digital images in relation to direct object kinetics features which characterise a particular object or sub-object directly and are determined directly or indirectly from differences between the plurality of digital images of the series or from data reflecting these differences from the association data or from the segmentation data or from image content data, identified via at least one of the association data and segmentation data, of the digital images of the series or from the first feature data, at least one classifier preferably relating to a direct object kinetics feature being defined and applied for the purposes of classification.

17. Analysis and classification method according to claim 1, characterised in that the second features comprise kinetics or dynamic behaviour or a change between the recording times of the digital images in relation to indirect object kinetics features which characterise a particular object or sub-object indirectly and which can be determined indirectly on the basis of a predetermined or predeterminable model chronological development profile from differences between a plurality of the digital images of the series or from data reflecting these differences from the association data or from the segmentation data or from image content data, identified via at least one of the association data and the segmentation data, of the digital images of the series or from the first feature data.

18. Analysis and classification method according to claim 17, characterised in that the indirect object kinetics features comprise at least one matching parameter of at least one function describing the chronological development profile.

19. Analysis and classification method according to claim 17, characterised in that the indirect object kinetics features comprise at least one deviation variable or agreement variable quantifying the deviation or agreement between the kinetics or the dynamic behaviour or the change in the digital images between different recording times in relation to a particular object or sub-object on the one hand and the model chronological development profile on the other.

20. Analysis and classification method according to claim 17, characterised in that at least one classifier relating to an indirect object kinetics feature, in particular a matching parameter or a deviation variable or agreement variable, is defined and applied for the purposes of classification.

21. Analysis and classification method according to claim 1, characterised in that it is carried out to find at least one population or sub-population of objects of interest which differs from other objects in terms of their reaction to at least one purposeful action, reflected in first and/or second features, and/or by at least one particular characteristic, reflected in first and/or second features, and/or by at least one particular behaviour, reflected in first and/or second features.

22. Analysis and classification method according to claim 21, characterised in that the objects are subjected to a chemical and/or biochemical and/or biological or physical action before being supplied to the object region and/or in the object region before the digital images are recorded and/or while the series of digital images is recorded.

23. Analysis and classification method according to claim 22, characterised in that at least one reagent is added to induce the chemical and/or biochemical and/or biological action.

24. Analysis and classification method according to claim 1, characterised in that the digital images are recorded on the basis of the physical, in particular optical, excitation of the objects or sub-objects or substances contained in the objects or sub-objects to cause them to emit the optical radiation to be recorded according to step A).

25. Analysis and classification method according to claim 1, characterised in that the digital images are recorded on the basis of the epi-illumination and/or transillumination of the objects.

26. Analysis and classification method according to claim 1, characterised in that the objects of interest comprise biological objects, for example live or dead cells or connected groups of cells or cell fragments or tissue samples or biochemical objects.

27. Analysis and classification method according to claim 1, characterised in that the objects of interest comprise microscopic objects and the object examination device is configured as a microscopy object examination device or fluorescence microscopy object examination device.

28. Analysis and classification system for carrying out the analysis and classification method according to claim 1, comprising:
an optical object examination device having a recording device for recording digital images of objects of interest located in an object region of the object examination device and an electronic storage means for storing the digital data and further data,
a digital electronic processor device which is configured or programmed to carry out, from the analysis and classification method according to claim 1, at least the segmentation process according to step B), the association process according to step C), the detection process according to step E) and the classification process according to step G) and optionally the analysis process according to step H).

29. Program for analysing and classifying objects of interest on the basis of time-lapse images, comprising a program code which, when the analysis and classification method according to claim 1 is executed by a programmable processor device, carries out at least the segmentation process according to step B), the association process according to step C), the detection process according to step E) and the classification process according to step G) and optionally the analysis process according to step H).

30. Program product in the form of a data carrier carrying an executable program code or in the form of an executable program code which is held available on a network server, can be downloaded via a network and, when the analysis and classification method according to claim 1 is executed by a programmable processor device, carries out at least the segmentation process according to step B), the association process according to step C), the detection process according to step E) and the classification process according to step G) and optionally the analysis process according to step H).
